(19) United States
(12) Patent Application Publication
(10) Pub. No.: US 2025/0328560 A1
(43) Pub. Date: Oct. 23, 2025

(54) Security Methods and Systems for Multi-Agent Generative AI Applications

(71) Applicant: Vijay Madisetti, Alpharetta, GA (US)

(72) Inventors: Vijay Madisetti, Alpharetta, GA (US); Arshdeep Bahga, Chandigarh (IN)

(73) Assignee: Vijay Madisetti, Alpharetta, GA (US)

(21) Appl. No.: 19/256,469

(22) Filed: Jul. 1, 2025

Related U.S. Application Data
(63) Continuation-in-part of application No. 18/921,852, filed on Oct. 21, 2024.
Application No. 18/921,852 is a continuation-in-part of application No. 18/812,707, filed on Aug. 22, 2024, now Pat. No. 12,405,977.
Application No. 18/812,707 is a continuation-in-part of application No. 18/470,487, filed on Sep. 20, 2023, now Pat. No. 12,147,461.
Application No. 18/470,487 is a continuation of application No. 18/348,692, filed on Jul. 7, 2023, now Pat. No. 12,001,462.
(60) Provisional application No. 63/463,913, filed on May 4, 2023.
(60) Provisional application No. 63/469,571, filed on May 30, 2023.
(60) Provisional application No. 63/529,177, filed on Jul. 27, 2023.
(60) Provisional application No. 63/534,974, filed on Aug. 28, 2023.
(60) Provisional application No. 63/535,118, filed on Aug. 29, 2023.
(60) Provisional application No. 63/607,112, filed on Dec. 7, 2023.
(60) Provisional application No. 63/607,647, filed on Dec. 8, 2023.
(60) Provisional application No. 63/647,092, filed on May 14, 2024.
(60) Provisional application No. 63/693,351, filed on Sep. 11, 2024.
(60) Provisional application No. 63/820,776, filed on Jun. 10, 2025.

(51) Int. Cl. G06F 16/3329; G06F 40/284

(52) U.S. Cl. CPC G06F 16/3329; G06F 40/284

(57) ABSTRACT

A system and method for securing inter-process communications (IPCs) between generative AI and external tool servers, including intercepting IPCs having a requested operation, performing a security analysis on the IPCs for security threats, performing a permission validation for permissions for the requested operation of each IPC, and either approving or blocking the requested operation of each IPC based on the security analysis and the permission validation.

### RELATED APPLICATIONS

This application claims priority under 35 U.S.C. § 119 (e) of U.S. Provisional Patent Application Ser. No. 63/820,776 (Attorney Docket No. 3026.00230) filed on Jun. 10, 2025, and titled MCPGuard for Secure and Private Multi-Agent Generative AI Systems. This application also is a continuation-in-part application of and claims priority under 35 U.S.C. § 120 of U.S. patent application Ser. No. 18/921,852 (Attorney Docket No. 3026.00195) filed on Oct. 21, 2024 and titled Fault Tolerant Multi-Agent Generative AI Applications, which in turn claims priority under 35 U.S.C. § 119 (e) of U.S. Provisional Patent Application Ser. No. 63/693,351 (Attorney Docket No. 3026.00193) filed on Sep. 11, 2024, and titled Fault Tolerant MultiAgent Generative AI Applications, and is a continuation-in-part application of and claims priority under 35 U.S.C. § 120 of U.S. patent application Ser. No. 18/812,707 (Attorney Docket No. 3026.00189) filed on Aug. 22, 2024 and titled Method and Systems for Optimizing User of Retrieval Augmented Generation Pipelines in Generative Artificial Intelligence Applications, which in turn is a continuation-in-part application of and claims priority under 35 U.S.C. § 120 of U.S. patent application Ser. No. 18/470,487, now U.S. Pat. No. 12,147,461, issued Nov. 19, 2024 (Attorney Docket No. 3026.00149) filed on Sep. 20, 2023 and titled Method and System for Multi-Level Artificial Intelligence Supercomputer Design, which in turn is a continuation application of and claims priority under 35 U.S.C. § 120 of U.S. patent application Ser. No. 18/348,692, now U.S. Pat. No. 12,001,462, issued Jun. 4, 2024 (Attorney Docket No. 3026.00143) filed on Jul. 7, 2023 and titled Method and System for Multi-Level Artificial Intelligence Supercomputer Design, which in turn claims priority under 35 U.S.C. § 119(e) of U.S. Provisional Patent Application Ser. No. 63/463,913 (Attorney Docket No. 3026.00138) filed on May 4, 2023 and titled New Tools for Document Analysis in CatchUp, and U.S. Provisional Patent Application Ser. No. 63/469,571 (Attorney Docket No. 3026.00141) filed on May 30, 2023 and titled Multilevel AI PSupercomputer Design. The '707 application also claims priority under 35 U.S.C. § 119 (e) of U.S. Provisional Patent Application Ser. No. 63/535,118 (Attorney Docket No. 3026.00152), filed on Aug. 29, 2023, and titled Networked LLMs and Focused LLMs, U.S. Provisional Patent Application Ser. No. 63/529,177 (Attorney Docket No. 3026.00147), filed on Jul. 27, 2023, and titled Using LLMs to Create Projects and Tasks in an Optimized Way, U.S. Provisional Patent Application Ser. No. 63/534,974 (Attorney Docket No. 3026.00151), filed on Aug. 28, 2023, and titled Using Prompts to Generate Search Queries for Context Generation in LLMs, U.S. Provisional Patent Application Ser. No. 63/647,092 (Attorney Docket No. 3026.00178), filed on May 14, 2024, and titled Using LLMs to Influence Users and Organizations, U.S. Provisional Patent Application Ser. No. 63/607,112 (Attorney Docket No. 3026.00162), filed on Dec. 7, 2023, and titled Long Document Attention Span Enhancement for LLMs, and U.S. Provisional Patent Application Ser. No. 63/607,647 (Attorney Docket No. 3026.00163), filed on Dec. 8, 2023, and titled High-Level UI for Prompt Generation for LLMs. The contents of these applications are incorporated in their entirety herein by reference.

### FIELD OF THE INVENTION

The present invention primarily relates to artificial intelligence and large language models (LLMs) for generative AI applications.

### BACKGROUND

Large Language Models (LLMs) are generative Artificial Intelligence (AI) models which are trained on limited amounts of data and can perform language processing tasks (with multimodal inputs-text, and more recently, image inputs as in Microsoft's Kosmos-1) and generate human-like text (and associated multimedia material, like images, video and advertisements). LLMs have many parameters (from millions to billions). LLMs can capture complex patterns in language and produce text that closely resembles human language.

The high-level goal of an LLM is to predict the text (and other multimedia material) that is likely to come next in a sequence. The applicants recognize that LLMs are a type of generative AI that is in usually different from traditional machine learning and AI applications. LLM also stands for Learning with Limited Memory and implies that LLM's are closely tied to their training data and make decisions based on the limited amount of data. Both generative AI and LLM generate content, but LLM does it in a manner that improves computational and memory efficiency.

Traditional machine learning type algorithms focus on analysis, such as statistical regression or clustering, and are usually again different from Generative AI and LLMs, which focus on generating content. LLMs have immediate practical implication in generation of new content that matches associated or preceding/future content in an optimized manner, such as legal briefs or computer code, based on training with a limited amount of data, such as existing briefs or code, both from private and public sources. In this invention, we focus on LLM models as the primary focus of these improvements, though we do not disclaim other AI models, unless expressly done as part of the claims.

LLMs are created with complex architectures such as transformers, encoders and decoders. LLMs, typically, use a technique of natural language processing called Tokenization that involves splitting the input text (and images) and output texts into smaller units called tokens. Tokens can be words, characters, sub-words, or symbols, depending on the type and the size of the model. Tokenization helps to reduce the complexity of text data, making it easier for LLMs to process and understand data thus reducing the computational and memory costs. Another important component of an LLM is Embedding, which is a vector representation of the tokens. The Encoder, within the Transformer architecture, processes the input text and converts it into a sequence of vectors, called embeddings, that represent the meaning and context of each word. The Decoder, within the Transformer architecture, generates the output text by predicting the next word in the sequence, based on the embeddings and the previous words. LLMs use Attention mechanisms that allow the models to focus selectively on the most relevant parts of the input and output texts, depending on the context of the task at hand, thus capturing the long-range dependencies and relationships between words.

LLMs are designed to learn the complexity of the language by being pre-trained on vast amounts of text (and multimedia) data from sources such as Wikipedia, books, articles on the web, social media data and other sources. The training procedure can be decomposed into two stages:
1. Pre-training on a large amount of unlabeled plain text; and
2. Supervised fine-tuning

Through training on limited amounts of data, the models are able to learn the statistical relationships between words, phrases, and sentences and other multimedia content. The trained models can then be used for generative AI applications such as Question Answering, Instruction Following, Inferencing, for instance, where an input is given to the model in the form of a prompt and the model is able to generate coherent and contextually relevant responses based on the query in the prompt.

Popular LLM models include GPT (Generative Pre-trained Transformer), BERT (Bidirectional Encoder Representations from Transformers), BART (Bidirectional and Auto-Regressive Transformers) and PaLM (Pathways Language Model). See, for example, public domain websites, such as openai.com or bard.google.com for more information as to how a person of ordinary skill in the art may use these models. Public domain and company-specific LLMs, such as GPT4All, MiniGPT4, RMKV, BERT, MPT-7B, Kosmos-1 (which accepts image and multimodal inputs), YaLM, are also available for wide use, as for example, described in medium.datadriveninvestor.com/list-of-open-source-large-language-models-Ilms-4eac551bda2e.

Current AI generative models and LLMs require super-computing efforts to compute results and an efficient way to improve response times, accuracies, and reduce computational load is required to improve both cost and scalability and expandability of existing AI models and their use.

LLMs have ushered in a new era of AI-based applications, where specialized LLMs act as agents with provided relevant contexts (referred to as “Agents”) that perform (and can also generate) specialized tasks, referred to as “derived tasks,” and interact with users and environments in unprecedented ways as shown by the inventive systems and methods and LLM Generative AI/stacks that we introduce and describe in this specification. However, as these systems grow in complexity and are deployed in critical applications, the need for robust fault tolerance mechanisms increases. Traditional fault tolerance approaches often fall short when applied to the dynamic and complex nature of LLM-based agent systems. These systems face unique challenges such as maintaining consistency across distributed agents, handling the stochastic nature of LLM outputs, and ensuring seamless operation in the face of both soft failures (performance degradation) and hard failures (complete agent malfunction). The lack of comprehensive fault tolerance frameworks specifically designed for LLM-based agent systems poses a significant risk to their reliability, scalability, and adoptability in mission-critical scenarios.

The Model Context Protocol (MCP) has rapidly gained adoption in the artificial intelligence ecosystem as a standardized protocol enabling AI agents to interact with external tools and data sources. MCP operates on a client-server architecture wherein AI agents function as clients that communicate with MCP servers exposing various tools and capabilities, such as database access, file system operations, email services, and third-party API integrations.

While MCP has enabled powerful AI capabilities and workflow automation, its design prioritizes functionality over security, introducing fundamental security vulnerabilities that pose significant risks to enterprise deployments and individual users.

Current approaches to MCP security are inadequate and fail to address the fundamental design flaws in the protocol. Existing solutions typically focus on individual vulnerability categories rather than providing comprehensive protection, lack integration between different security mechanisms, provide insufficient visibility into security events and decisions, and fail to address the protocol's fundamental trust model assumptions.

The MCP protocol fundamentally lacks cryptographic mechanisms to ensure message integrity and authenticity. There are no message authentication codes (MACs) to detect tampering, no digital signatures for tool descriptions to verify authenticity, no certificate pinning for server verification to prevent impersonation, and plaintext metadata transmission that exposes sensitive information.

The key security vulnerabilities in MCP include:
1. Tool Poisoning Attacks (TPAs)—Malicious instructions hidden in tool descriptions using invisible characters or HTML comments that manipulate AI behavior while appearing legitimate to users.
2. Command Injection Vulnerabilities-Improper input sanitization allows attackers to execute arbitrary system commands through MCP servers, leading to complete server compromise.
3. Token Theft and Credential Compromise-Insecure storage of OAuth tokens, API keys, and credentials in configuration files enables attackers to steal authentication data and gain unauthorized access to connected services.
4. Tool Shadowing and Cross-Server Attacks-Malicious MCP servers can override legitimate tools by registering identical names, intercepting and redirecting tool invocations to hijack functionality.
5. MCP Rug Pull Attacks-Initially legitimate servers can be updated with malicious code after gaining user trust, representing a supply chain attack vector that bypasses security reviews.
6. Invisible Unicode and Encoding Attacks-Attackers embed malicious instructions using invisible Unicode characters that are processed by systems but invisible to human reviewers, bypassing visual security inspections.

These vulnerabilities collectively enable data exfiltration, remote code execution, credential theft, and complete system compromise across MCP-connected environments.

The protocol implements a simplistic binary trust model where servers are either trusted or untrusted, without consideration for granular permissions. There is no granular permission system for fine-grained access control, no role-based access control to differentiate user capabilities, no dynamic risk assessment to adjust permissions based on context, and no temporal access controls to limit permission duration.

Current MCP implementations lack comprehensive monitoring and audit capabilities. There are limited logging mechanisms that don't capture sufficient detail, no standardized audit trail format for security analysis, no real-time threat detection capabilities, and no behavioral analysis capabilities to identify anomalous patterns.

Many proposed solutions require extensive modifications to existing MCP implementations, creating deployment friction and reducing adoption. Others provide only superficial protection that can be easily bypassed by sophisticated attackers who understand the underlying protocol weaknesses.

The lack of standardized security frameworks for MCP has resulted in inconsistent security implementations across different vendors and deployments, creating a fragmented security landscape where vulnerabilities in one implementation can affect the broader ecosystem. There is a need for a comprehensive security framework that addresses MCP's fundamental vulnerabilities while maintaining compatibility with existing implementations.

This background information is provided to reveal information believed by the applicant to be of possible relevance to the present invention. No admission is necessarily intended, nor should be construed that any of the preceding information constitutes prior art against the present invention.

### SUMMARY OF THE INVENTION

With the above in mind, embodiments of the present invention are directed to a system and associated methods for multi-level generative AI and large language models (LLM) for generative AI applications, that utilize the following techniques:

Derived Requests: An initial level of generative AI software program, or AI broker or AI agent, evaluates the incoming client request (maybe a conversational query or through an API, such as OpenAI API) and identifies its specific AI “characteristics” that may make it suitable for one or other or both or multiple AI language models and checks its “derived requests” categories to see if the query suits one of the “derived requests” categories and/or it can or should create a new request.

Multiple h-LLMs: If the new request does is not assigned to one or more of the “derived requests) categories, it evaluates the request and selects one or more AI h-LLM model categories for its evaluation. An h-LLM is a family of models, such as GPT-4, that (in addition) have been trained according to a particular training set T1. A family of generative models, LLM1, trained with a data set T1, can be represented as h-LLM1, while a family of models, LLM2, trained with data set T2, can be represented as h-LLM12. Further, a family of models, LLM1, trained with a data set T3, can be represented as h-LLM35. The combination of models and their training sets (T1 could be a subset of T3, for example, or they can be different) may be used in our proposed invention and they are referred to as h-LLMs, throughout. A family of LLMs that operate at a lower arithmetic precision, on computer CPUs or graphical processing units (GPUs, such as Nvidia's H100), may also be called by a different identifier, e.g., h-LLM14, when trained with its corresponding data set.

Choosing h-LLMs with varying levels of accuracy: It further checks the workload of the AI h-LLM models in the one or more categories and its level of training and its accuracy-called its workload scores or its technical accuracy scores, or its business value metrics or a combination of these scores, and then assigns the request (or its derived form) to one or more of the AI h-LLM models within the selected AI h-LLM model categories.

Assigning weights to results: It then receives the results from the AI models in the AI h-LLM models categories and weights them to compute a result that could be returned to the requester program, or it could resend the request back to the AI h-LLM models/categories hierarchy till it reaches a certain level of service level assurance.

Use of Local Database: It also updates a local database with the results of the request's path through its hierarchy and create an index of “derived requests” that may be used in future to select which set of “derived requests” an incoming request may fall into for further processing.

Distributed Architecture: The tasks may be implemented as containers within Kubernetes environment and a service mesh, that we call an agent mesh, similar in some aspects and different in others to service meshes like Istio, may be used to instrument and parameterize the metrics and log collections, but not limited to these cloud models for implementation.

Embodiments of the present invention are directed to a system and associated methods for Fault-Tolerant Generative Agents Frameworks. The invention provides robust mechanisms for ensuring continuous operation and reliability in multi-agent systems powered by LLMs.

In one embodiment, Shadow Generative Agents for Fault Tolerance are described. This embodiment introduces a system where each primary agent is mirrored by a shadow agent. The shadow agent maintains an up-to-date representation of the primary agent's state through periodic checkpointing. In the event of a primary agent failure, the corresponding shadow agent can seamlessly take over, ensuring uninterrupted system operation.

In another embodiment, Checkpointing, State Saving, and Message Pool Management techniques are presented. This embodiment outlines a system where agents regularly save their state to a central checkpoint storage. It also describes a shared message pool with replication, integrity checking, and priority queuing features, ensuring reliable inter-agent communication and facilitating quick recovery in case of failures.

In another embodiment, a Failure Detection Algorithm is detailed. This algorithm describes a systematic approach to monitoring agent health through heartbeats, detecting potential failures, and initiating recovery processes. It includes steps for marking suspects, probing potentially failed agents, and triggering recovery mechanisms when failures are confirmed.

In another embodiment, Flexible Agent Replacement mechanisms are described. This embodiment presents a system capable of replacing failed agents with either similar agents/agents with a relatively lesser degree of similarity to the agent or exact replicas/agents with a relatively greater degree of similarity to the agent, depending on the specific requirements of the application.

In another embodiment, soft failure handling techniques are presented. This embodiment describes a system for managing performance degradation and overload scenarios without complete agent failure. It includes mechanisms for load redistribution, dynamic resource allocation, and agent scaling to address performance issues proactively.

In another embodiment, hard failure handling procedures are detailed. This embodiment presents a comprehensive approach to recovering from severe failures such as process termination or complete loss of communication. It includes steps for failure detection, agent isolation, state recovery, agent relaunching, and system reintegration.

These embodiments, individually and in combination, provide a robust and flexible framework for ensuring fault tolerance in generative agent systems. The invention addresses various failure scenarios, from performance degradation to complete agent failures, thereby significantly enhancing the reliability and resilience of multi-agent systems powered by LLMs.

Embodiments of the present invention are directed to a system and associated methods for providing comprehensive security for Model Context Protocol (MCP) communications between artificial intelligence agents and external tool servers, addressing critical vulnerabilities including tool poisoning attacks, command injection, credential theft, and cross-server interference through a multi-layered security architecture.

In one embodiment, the present invention comprises a system for securing MCP communications through a multi-layer architecture including: a user interface layer providing security dashboard, tool approval system, and audit log viewer; an AI agent integration layer with request interceptor and response validator; a security core layer implementing zero-trust verification engine, AI threat detection, message signing, input sanitization, and permission management; a blockchain infrastructure layer maintaining immutable tool registry and audit trails; network security layer providing encrypted communications and intrusion detection; and monitoring and analytics layer enabling real-time threat detection and incident response.

In another embodiment, the present invention comprises a transparent proxy architecture that intercepts all communications between AI agents and MCP servers without requiring modifications to existing components, wherein a security gateway performs comprehensive validation of requests and responses while maintaining standard MCP protocol compatibility, enabling selective blocking of malicious servers while preserving access to trusted services.

Another embodiment of the invention introduces a sidecar architecture suitable for containerized deployments, wherein security sidecars are deployed alongside both AI agent applications and MCP server applications to provide bidirectional security validation through an multi-step communication flow that maintains zero application changes while implementing comprehensive protection against security threats.

Another embodiment of the invention involves a method for tool registration and verification comprising: automated security analysis using machine learning algorithms to detect malicious patterns; multi-stage validation including human expert review; blockchain registration for immutable tool verification; continuous monitoring of tool behavior; and automated revocation mechanisms for compromised tools, wherein the method ensures only verified, secure tools are available for AI agent utilization.

Another embodiment of the invention provides a mechanism for real-time request processing and authorization comprising: request interception and input sanitization; permission verification and threat analysis; risk-based authorization with automatic approval for low-risk operations, user approval requirements for medium-risk operations, and automatic blocking for high-risk operations; secure execution monitoring within isolated environments; and anomaly detection with immediate termination capabilities for suspicious behavior.

Another embodiment provides a comprehensive incident detection and response system comprising: continuous monitoring using multiple detection mechanisms including signature-based detection, behavioral analysis, and machine learning-based anomaly detection; severity assessment with tiered response procedures; automatic containment for high-severity threats; coordinated investigation and recovery procedures; forensic analysis capabilities; and policy updating mechanisms that incorporate lessons learned to improve future security posture.

Another embodiment of the invention introduces a blockchain-based infrastructure comprising smart contracts for tool registry management, access control enforcement, audit trail maintenance, and reputation scoring, wherein the blockchain network provides immutable verification of tool integrity, tamper-proof audit logs, and decentralized governance mechanisms that ensure transparency and accountability in security decisions.

Another embodiment involves a zero-trust verification engine that implements continuous validation of all entities and communications within the MCP ecosystem, comprising: dynamic risk assessment based on multiple contextual factors; behavioral analysis for detecting anomalous patterns; integration with threat intelligence feeds; and adaptive security policies that automatically adjust protection levels based on detected threat levels and entity reputation scores.

Another embodiment comprises an AI-powered threat detection system specifically trained to identify tool poisoning attacks and other MCP-specific vulnerabilities, utilizing natural language processing models to analyze tool descriptions for hidden malicious instructions, semantic inconsistencies, and obfuscated commands, while maintaining behavioral baselines for detecting deviations that may indicate compromise or malicious activity.

Another embodiment of the invention provides a comprehensive permission engine implementing hierarchical role-based access control, attribute-based access control considering contextual factors, temporal permissions with automatic expiration, and conditional permissions based on specific criteria, wherein the engine dynamically adjusts access rights based on real-time risk assessment and maintains detailed audit trails of all permission decisions.

Another embodiment involves cryptographic message signing and integrity verification mechanisms that ensure all MCP communications are authenticated and tamper-proof through digital signatures, replay attack prevention using timestamps and nonces, and non-repudiation capabilities that provide legal-grade evidence for audit and compliance purposes.

Another embodiment provides input sanitization capabilities specifically designed to counter Unicode-based attacks, invisible character detection, command injection prevention, and other MCP-specific attack vectors, utilizing multi-layer validation processes that are context-aware and maintain high performance while providing comprehensive protection against known and novel attack techniques.

### BRIEF DESCRIPTION OF THE DRAWINGS

FIG. 1 is an illustration of the training process for creating multiple specialized large language models for specific tasks/categories, according to an embodiment of the present invention.

FIG. 2 is an illustration of h-LLMs trained with different training sets, according to an embodiment of the invention.

FIG. 3 is an illustration of the process for generating synthetic data from multiple h-LLMs and using it for model refinement, according to an embodiment of the invention.

FIG. 4 is an illustration of a “bagging” approach where multiple h-LLMs with lower precision and accuracy are merged/fused to create a merged h-LLM with higher precision and accuracy, according to an embodiment of the invention.

FIG. 5 is an illustration of a “boosting” approach where multiple h-LLMs of increasing precision and accuracy are created in a sequential manner and then merged/fused to create a merged h-LLM, according to an embodiment of the invention.

FIG. 6 is an illustration of creating a smaller and more specialized h-LLM through extraction/specialization process from a larger h-LLM, according to an embodiment of the invention.

FIG. 7 is an illustration of combining h-LLMs trained with text, image and audio data to create a merged h-LLM, according to an embodiment of the invention.

FIG. 8 is an exemplary illustration of an application of using AI models for detecting labels in PDF files, according to an embodiment of the invention.

FIG. 9 is an illustration of generating derived prompts for different categories and using them with multiple h-LLMs to generate the best results, according to an embodiment of the present invention.

FIG. 10 is an illustration of using multiple h-LLMs to answer questions from specific input documents, according to an embodiment of the present invention.

FIG. 11 is an illustration of an AI Broker or AI agent for processing results from multiple h-LLMs, according to an embodiment of the present invention.

FIG. 12 is an illustration of the combining h-LLMs in series, according to an embodiment of the present invention.

FIG. 13 is an illustration of combining h-LLMs in parallel, according to an embodiment of the present invention.

FIG. 14 is an illustration of a hybrid approach of combining h-LLMs in series and parallel, according to an embodiment of the present invention.

FIG. 15 is an illustration of the lambda architecture for h-LLMs, according to an embodiment of the present invention.

FIG. 16 is an illustration of batch and real-time processing architecture for h-LLMs, according to an embodiment of the present invention.

FIG. 17 is an illustration of an in-memory processing architecture for h-LLMs, according to an embodiment of the present invention.

FIG. 18 is an illustration of the architecture of PDF label search tool with CatchUp GlassViewer, according to an embodiment of the invention.

FIG. 19 is an exemplary interface of the CatchUp platform showing the document management system, according to an embodiment of the invention.

FIG. 20 is an exemplary interface of the CatchUp platform showing the PDF viewer (GlassViewer), according to an embodiment of the invention.

FIG. 21 is an exemplary interface of the CatchUp platform showing a magnifier tool within the GlassViewer for searching labels, according to an embodiment of the invention.

FIG. 22 is an exemplary interface of the CatchUp platform showing label search results within GlassViewer, according to an embodiment of the invention.

FIG. 23 is an illustration of the process used by organizations to decide the list of tasks for a project, according to an embodiment of the invention.

FIG. 24 is an illustration of the process of training LLMs to generate project, tasks and action items, according to an embodiment of the invention.

FIG. 25 is an illustration of the process of creating a project within CatchUp using a prompt, according to an embodiment of the invention.

FIG. 26 is an illustration of the process of Retrieval Augmented Generation (RAG), according to an embodiment of the invention.

FIG. 27 is an illustration of the process of indexing documents RAG, according to an embodiment of the invention.

FIG. 28 is an illustration of the process of querying documents in RAG, according to an embodiment of the invention.

FIG. 29 is an illustration of the Retrieval Augmented Generation RAG pipeline, according to an embodiment of the invention.

FIG. 30 is an illustration of an approach that uses multiple RAG pipelines with clusters of documents, according to an embodiment of the invention.

FIG. 31 is an illustration of an approach that uses a prompt augmented with a search query, according to an embodiment of the invention.

FIG. 32 is an illustration of an approach that uses a search query to extract relevant context for RAG pipelines, according to an embodiment of the invention.

FIG. 33 is an exemplary interface of the CatchUp platform for RAG, according to an embodiment of the invention.

FIG. 34 is an exemplary interface of the CatchUp platform showing response a RAG pipeline, according to an embodiment of the invention.

FIG. 35A is an illustration of a prior art embodiments of using a single LLM.

FIG. 35B is an illustration of using a network of LLMs, according to an embodiment of the invention.

FIGS. 36A-C is a comparison of the current (36A) and proposed (36B, 36C) approaches of a long-document attention span enhancement through refinement (LASER) system and a scored context-optimized retrieval enhancement for retrieval augmented generation (SCORE-RAG) system according to an embodiment of the invention.

FIG. 37 is an illustration of the high-level architecture of a LASER system according to an embodiment of the invention.

FIG. 38 is a flow chart illustrating a method performed by a LASER system by which long documents are processed and refined to enhance the attention span of LLMs according to an embodiment of the invention.

FIG. 39 is a flow chart illustrating a method of adapting a MapReduce model for the LASER system according to an embodiment of the invention.

FIG. 40 is an illustration of the architecture of a SCORE-RAG system according to an embodiment of the invention.

FIG. 41 is a flow chart illustrating a method of a SCORE-RAG system according to an embodiment of the invention.

FIG. 42 is an illustration of an implementation of a SCORE-RAG system according to an embodiment of the invention for multi-modal RAG.

FIG. 43 is an illustration of an implementation of a LASER system and a SCORE-RAG system according to an embodiment of the invention for multi-modal RAG.

FIG. 44 is an illustration of different meanings of “document” in the context of the present invention.

FIG. 45 is an illustration of different meanings of “chunk” and “block” in the context of the present invention.

FIG. 46 is an illustration of different meanings of “meta-data” in the context of the present invention.

FIG. 47 is an illustration of different meanings of “document processing” or “chunk/block processing” in the context of the present invention.

FIG. 48 is an illustration of an approach of generating derived prompts and using them with RAG or SCORE-RAG systems to generate improved results according to an embodiment of the invention.

FIG. 49 is an illustration of an approach of generating derived prompts and using LASER and RAG or SCORE-RAG systems to generate improved results according to an embodiment of the invention.

FIG. 50 is an illustration of an exemplary set of APIs of a LASER system according to an embodiment of the invention.

FIG. 51 is an illustration of an exemplary set of APIs of the SCORE-RAG system, according to an embodiment of the invention.

FIG. 52 is a flowchart illustrating methods of performing prefill and decode phases of an LLM inference process according to an embodiment of the invention.

FIG. 53 is an illustration depicting the formation of a superchunk from several chunks from discrete documents according to an embodiment of the invention.

FIG. 54 is an illustration of different meanings of “superchunk” in the context of the present invention.

FIG. 55 is an illustration of characteristics of superchunks according to an embodiment of the invention.

FIG. 56 is an illustration of the architecture of a Hybrid-RAG system according to an embodiment of the invention.

FIG. 57 is an illustration of an architecture of a NoRAG system according to an embodiment of the invention.

FIG. 58 is an illustration of the use of shadow agents for fault tolerance, according to an embodiment of the invention.

FIG. 59 is an illustration of a checkpointing, state saving, and message pool management for fault tolerance in agents, according to an embodiment of the invention.

FIG. 60 is a flowchart illustrating a method of a failure detection algorithm for fault tolerance in agents, according to an embodiment of the invention.

FIG. 61 is a flow chart illustrating a method of a flexible agent replacement mechanism for fault tolerance in a multi-agent system, according to an embodiment of the invention.

FIG. 62 is an illustration of the soft failure handling mechanism in a fault-tolerant agent system, according to an embodiment of the invention.

FIG. 63 is a flow chart illustrating a method of hard failure handling mechanism in a fault-tolerant agent system, according to an embodiment of the invention.

FIG. 64 is an illustration of Generative AI Agent Stack (AGES), according to an embodiment of the invention.

FIG. 65 is a flow chart illustrating a method of a Language Adaptive AI Processing (LEAP) model, according to an embodiment of the invention.

FIG. 66 is an illustration of the tasks/processes involved at each step of the LEAP model, according to an embodiment of the invention.

FIG. 67 is an illustration of types of LLM and AI Agents, and Agent Frameworks, according to an embodiment of the invention.

FIG. 68 is an illustration a sidecar pattern for agents, according to an embodiment of the invention.

FIG. 69 is an illustration of an ambassador pattern for agent communication, according to an embodiment of the invention.

FIG. 70 is an illustration of an adapter pattern for input/output transformation, according to an embodiment of the invention.

FIG. 71 is an illustration of an architecture for inter-process communication (IPC), according to an embodiment of the invention.

FIG. 72 is an illustration of an IPC proxy architecture, according to an embodiment of the invention.

FIG. 73 is an illustration of an IPC sidecar architecture, according to an embodiment of the invention.

FIG. 74 is a flowchart illustrating a method of IPC tool registration and verification, according to an embodiment of the invention.

FIG. 75 is aflowchart illustrating a method of an IPC request processing and authorization, according to an embodiment of the invention.

FIG. 76 is a flowchart illustrating a method of an IPC incident detection and response, according to an embodiment of the invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled people having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

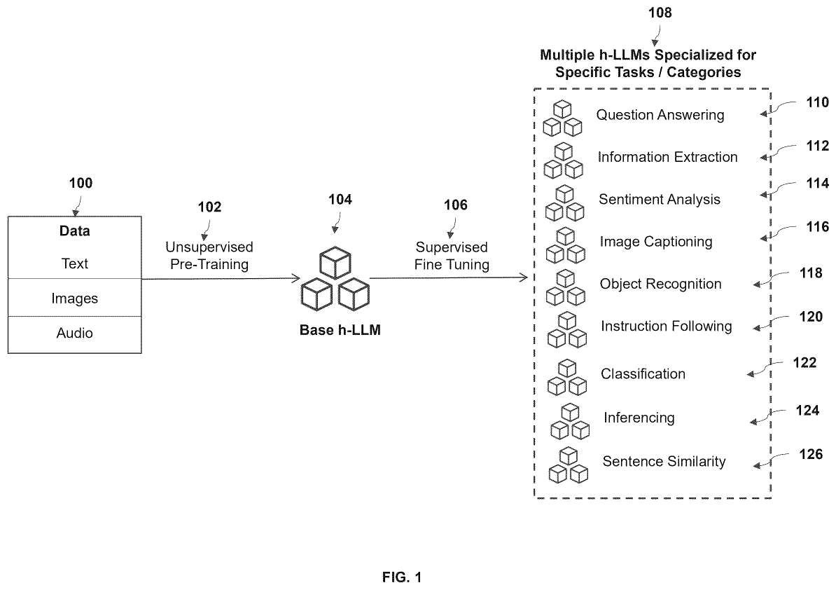

Referring now to FIG. 1 is an illustration of the training process for creating multiple specialized large language models for specific tasks/categories, is described in more detail. Data 100 (such as text, images, and audio) is used to pre-train a model in a process called unsupervised pre-training 102 which generates a base h-LLM model 104. The pre-training process is referred to as unsupervised as unlabeled data is used at this step. The base h-LLM model 104 is then fine-tuned in a process called supervised fine-tuning 106. The fine-tuning process uses smaller labeled data sets. The base h-LLM model 104 is fine-tuned to generate multiple h-LLM models which are specialized to perform specific tasks such as Question Answering, Information Extraction, Sentiment Analysis, Image Captioning, Object Recognition, Instruction Following, Classification, Inferencing, and Sentence Similarity, for instance.

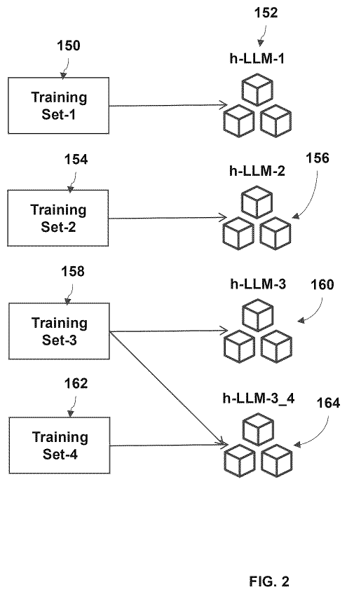

Referring now to FIG. 2 is an illustration of h-LLMs trained with different training sets, is described in more detail. As used in this specification h-LLM usually refers to a family of LLMs, such as those used in Google's Bard or OpenAI's GPT-4, that have been trained on a particular training set T. Therefore, the same family of LLMs (e.g., GPT) if trained on a different training set, T1, as opposed to GPT trained on training set T2 could be differentiated as a separate h-LLM). The training sets can be private within an organization or public datasets.

For example, as shown in FIG. 2, h-LLM-1 152 is trained with training set-1 150, h-LLM-2 156 is trained with training set-2 154, h-LLM-3 160 is trained with training set-3 158, and h-LLM-3_4 164 is trained with training set-3 158 and training set-4 162.

An h-LLM can be described as a combination of LLM families and the training dataset used as follows:
h-LLM=LLM family (X) trained with Training Set (Y)

For example,
h-LLM_1=PaLM-2 may be trained with training set T12
h-LLM_2=PaLM-2 may be trained with training set T12+T45
h-LLM_3=GPT-4 may be trained with Training Set T65
h-LLM_4=GPT-4 may be trained with ANY data set

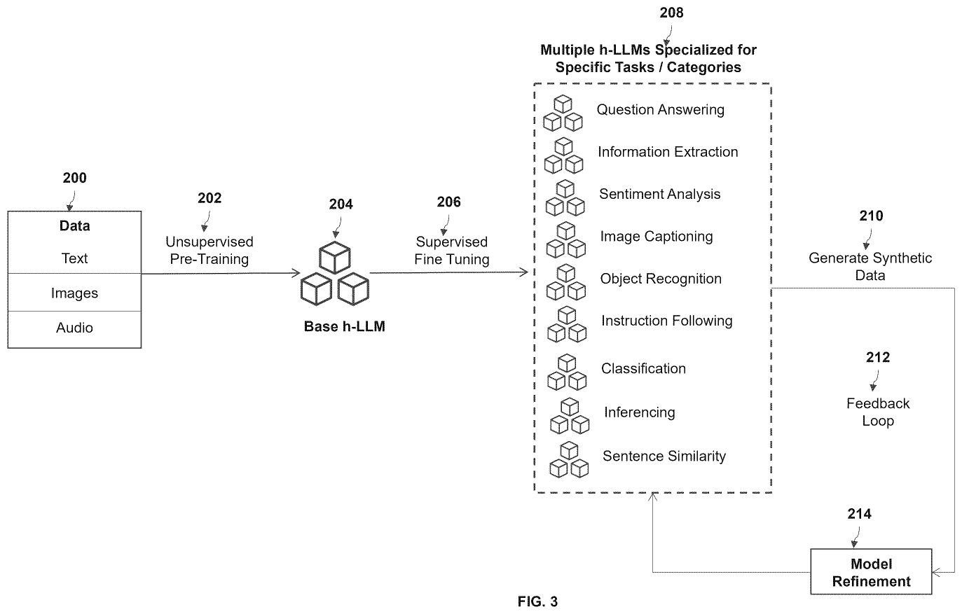

Referring now to FIG. 3, an illustration of the process for generating synthetic data from multiple h-LLMs and using it for model refinement, is described in more detail. Data 200 is used to train a base h-LLM model 204 using unsupervised pre-training 202 which is then fine-tuned in a supervised fine-tuning process 206 to generate multiple h-LLMs 208 specialized for specific tasks or categories. Each of these h-LLMs 208 are used to generate synthetic data 210 which is then fed back to the models in feedback loop 212 through a process called model refinement 214.

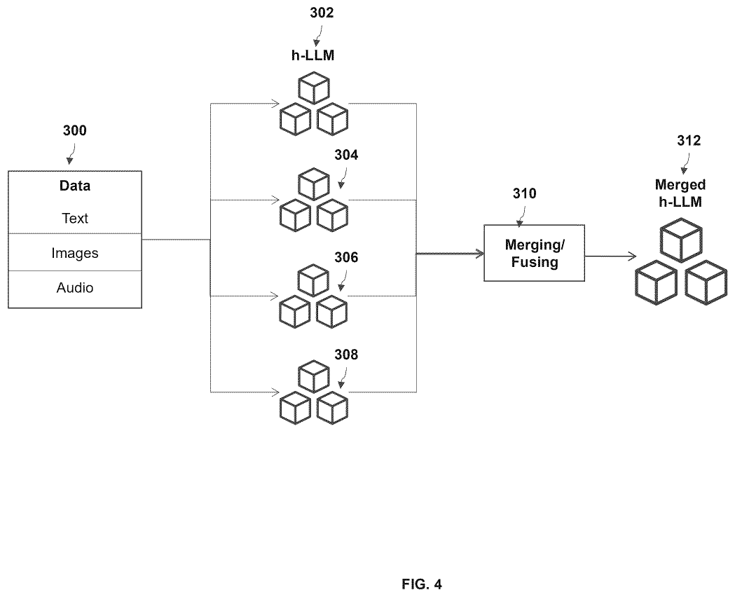

Referring now to FIG. 4 is an illustration of a bagging approach, that has some similarity to what was originally used in the context of machine learning models in a different way (for analytics as opposed to generative AI applications, such as LLMs) that are described in this invention, where multiple h-LLMs with lower precision and accuracy are merged/fused to create a merged h-LLM with higher precision and accuracy, is described in more detail. Bagging is a machine learning technique which improves the stability and accuracy of machine learning models. Using the input data 300, multiple subsets of the data are created which are used to train multiple h-LLMs (302, 304, 306, 308) in parallel. These models are then combined in a process called merging or fusing 310 to create a merged h-LLM 312.

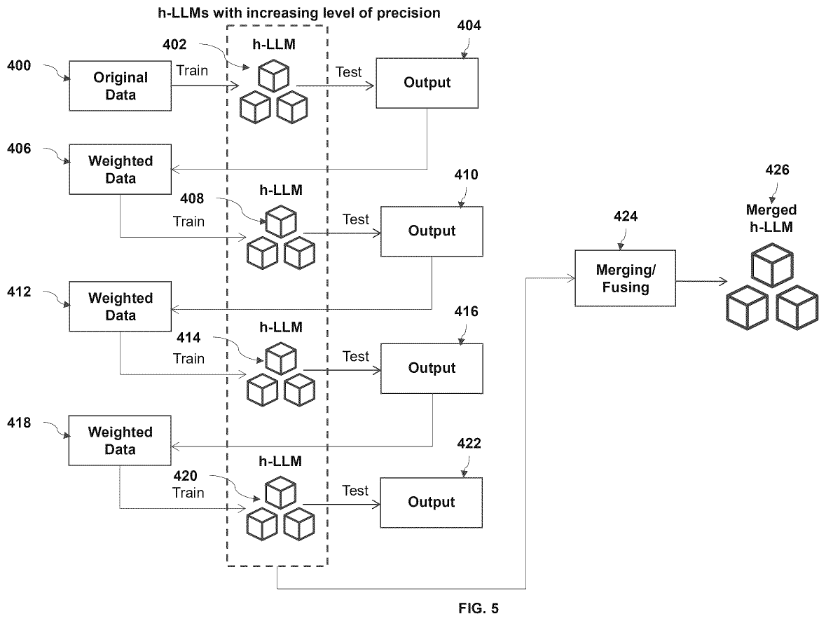

Referring now to FIG. 5 is an illustration a boosting approach, that has some similarities to that originally used in the context of machine learning models in a different way (for analytics as opposed to generative AI applications used in this invention) where multiple h-LLMs of increasing precision and accuracy are created in a sequential manner and then merged/fused to create a merged h-LLM, is described in more detail. Boosting is a machine learning technique that involves creating a stronger and more accurate model from a number of weaker models. The original data 400 is used to train an h-LLM 402. The h-LLM 402 is tested and the output 404 is assigned weights to generate weighted data 406. The weighted data 406 is then used to train h-LLM 408. The same process is then repeated and h-LLMs 414 and 420 are generated in a sequence. The h-LLMs 402, 408, 414 and 420 are then combined in a process called merging or fusing 424 to create a merged h-LLM 426.

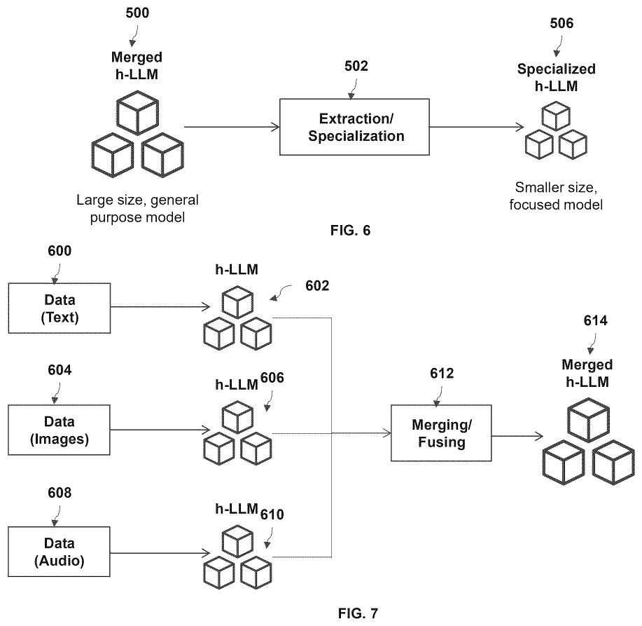

Referring now to FIG. 6 is an illustration of creating a smaller and more specialized h-LLM through extraction/specialization process from a larger h-LLM, is described in more detail. The extraction/specialization process 502 extracts the specific knowledge required for a task from a big, general-purpose model, and creates a smaller h-LLM 506. For example, a specific task can be sentiment analysis of input text, for which a smaller model 506 is more efficient as compared to a large, general-purpose model.

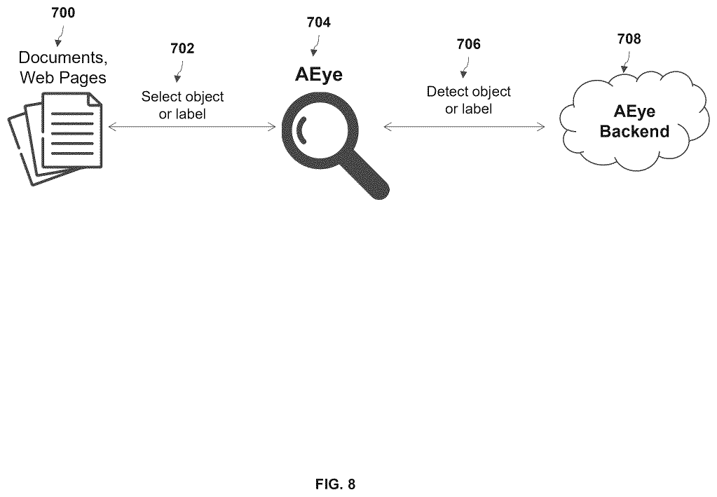

Referring now to FIG. 7 is an illustration of combining h-LLMs trained with text, image and audio data to create a merged h-LLM, is described in more detail. Text data 600 is used to train h-LLM 602, image data 604 is used to train h-LLM 606 and audio data 608 is used to train h-LLM 610. The h-LLMs 602, 606, 610 are combined in a process called merging/fusing to create a merged h-LLM 614.

Model merging and fusing are used to combine multiple models (LLMs or h-LLMs), to create a single, more powerful or specialized model. These processes leverage the strengths of individual models and create a unified model that can perform better or handle a wider range of tasks. Merging, in the context of the present invention, refers to combining models with similar architectures, while fusing refers to integrating models with different architectures or modalities, at a high-level. Merging and/or fusing of models helps in enhancing the overall performance, expanding the model capabilities across different domains or tasks, and reducing computational requirements by creating more efficient models.

As part of our inventive approaches, we identify different approaches to merging and/or fusing generative LLM models include (but not limited to):
1. Weight Averaging: This approach involves taking the average of the weights of multiple models. It can be effective when models have similar architectures and have been trained on similar data.
2. Weight Consolidation: This method aims to merge models while preserving important knowledge from each.
3. Knowledge Distillation: This technique involves training a smaller model (student) to mimic the behavior of a larger model or ensemble of models (teacher). The merged model learns to produce similar outputs as the original models.
4. Layer-wise Merging: In this approach, corresponding layers from different models are combined using various strategies such as averaging, concatenation, or more sophisticated attention mechanisms.
5. Attention-based Fusion: This method uses attention mechanisms to dynamically weight the contributions of different models or components during inference.
6. Cross-stitch Networks: These networks learn to combine multiple task-specific networks by using trainable scalar values to control information flow between different network streams.
7. Progressive Neural Networks: This approach involves adding new columns to an existing network for new tasks while keeping the previously learned features frozen, allowing for transfer learning without forgetting.
8. Mixture of Experts (MoE): In this approach, multiple “expert” models are combined with a gating network that learns to select or blend the outputs of the experts based on the input.
9. Evolutionary Merging: This method uses evolutionary algorithms to optimize the combination of different model components or layers, searching for the most effective merged architecture.
10. Modality-specific Fusion: For multi-modal models like the one described in FIG. 7, specialized techniques are used to fuse representations from different modalities (text, image, audio) effectively. This can involve cross-modal attention mechanisms or joint embedding spaces.

The choice of merging or fusing technique depends on factors such as the similarity of the models being combined, the desired outcome (e.g., performance improvement, task expansion, model compression), and the computational resources available. The merged h-LLM 614 resulting from these processes can potentially handle a wider range of inputs and tasks more effectively than any of the individual models, leveraging the combined strengths of text, image, and audio understanding.

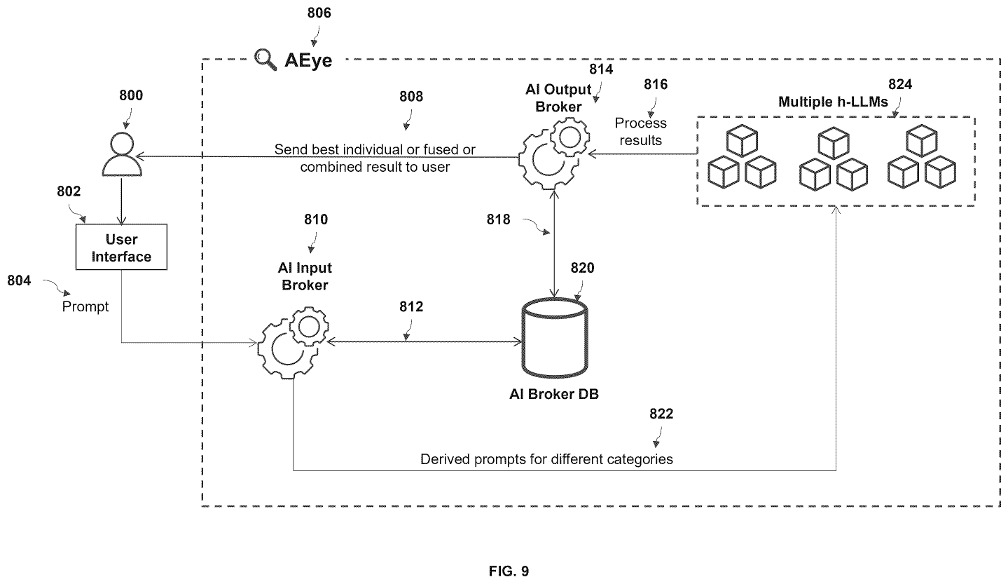

Referring now to FIG. 8 is an exemplary illustration of an application of using AI models for detecting labels in PDF files, is described in more detail. Patent documents (such as PDF files) have figures in which various entities/blocks/items are labeled using numeric labels (for instance 110, 120 and so on). These labels are referenced and described in the patent text specification. When reviewing multiple documents, readers find it difficult to quickly lookup the labels mentioned in the figures (and what they refer to) from the text, as they need to go back and forth between a figure and the text in the specification. A novel PDF Label search solution is offered within CatchUp which allows quick lookup of labels in a figure using an innovative “AI Magnifier” approach. The user can select one or more labels using the Magnifier tool in the CatchUp GlassViewer (a PDF viewer tool within CatchUp that has annotation and other AI features). When one or more labels are selected using the Magnifier tool, the labels are searched within the PDF and the search results are returned. The PDF Label Search tool is built upon a novel AI Magnifier technology (which we refer to as AEye). AEye serves as a gateway to the world of Artificial Intelligence (AI) for documents and web pages. AEye can be used for a wide range of applications such as detecting objects in images, labels in documents, for instance. Documents or web pages 700 can be searched using an AEye application 704 which detects objects or labels utilizing an AEye backend 708.

Referring now to FIG. 9 is an illustration of generating derived prompts for different categories and using them with multiple h-LLMs to generate the best results, is described in more detail. User 800 enters a prompt in user interface 802. The prompt is sent to the AI Input Broker or Agent 810, which may be an agent that generates multiple derived prompts for different categories. The derived prompts 822 are sent to brokers or agents comprising one or multiple h-LLMs 824 which produce the results. The results 816 are sent to the AI Output Broker 814 which processes the results and performs tasks such as filtering, ranking, weighting, assigning priorities, and then sends the best results to the user 800. The h-LLMs 824 can have varying levels of accuracy, and optimized for different tasks such as Question Answering, Information Extraction, Sentiment Analysis, Image Captioning, Object Recognition, Instruction Following, Classification, Inferencing, and Sentence Similarity, for instance. The AI Output Broker 814 computes various scores and assigns weights for ranking the results, in addition to other tasks, such as model fusing and merging. The results may be sent back to the h-LLMs till a certain level of accuracy or service level assurance is reached. The AI Input Broker 810 and Output Broker 814 update a local AI Broker Database 820 with the results of the request's path through its hierarchy and create an index of “derived requests” that may be used in future to select which set of “derived requests” an incoming request may fall into for further processing.

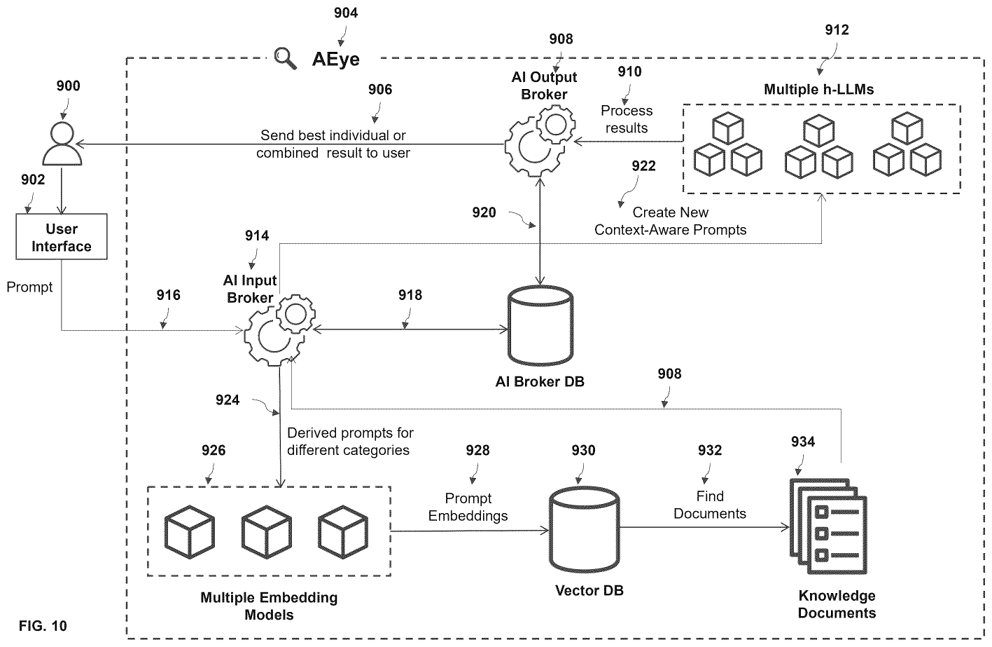

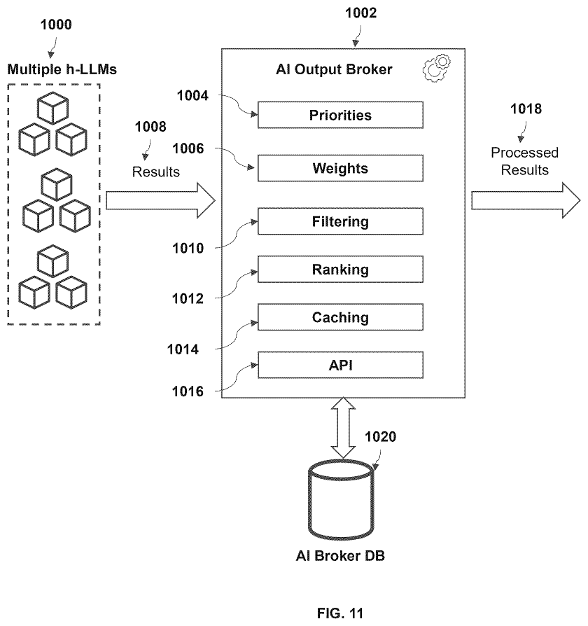

Referring now to FIG. 10 is an illustration of using agents or brokers comprising multiple h-LLMs to answer questions from specific input documents, is described in more detail. User 900 enters a prompt in user interface 902. The prompt is sent to AI Input Broker 810 which generates multiple derived prompts 924 for different categories. The prompts are converted into embeddings using multiple embedding models 926. The prompt embeddings 928 are sent to a vector database 930 which returns a list of knowledge documents 934 that are relevant to the prompt or relevant derived prompts based on the similarity of their embeddings to the user's prompt. The knowledge documents 934 are sent to the AI Input Broker 810 which creates new context-aware prompts based on the user's initial prompt 916, derived prompts 924 and the retrieved knowledge documents 934 as context and sends it to multiple h-LLMs 912. The results produced by multiple h-LLMs are processed by the AI Output Broker 908 and the best result is sent to the user 900 along with citations from the knowledge documents 934.

Referring now to FIG. 11 is an illustration of an AI Broker for processing results from multiple h-LLMs, is described in more detail. Results produced by multiple h-LLMs 1000 are sent to an AI Output Broker 1002 which performs tasks such as assigning priorities 1004 and weights 1006 to the results, filtering 1010, ranking 1012 and caching 1014. The AI Output Broker 1002 provides an API interface 1016 for configuring and managing various aspects of the broker. An AI Broker Database 1020 stores the results along with the meta-data information such as the request path. AI Broker Database 1020 creates an index of “derived requests” that may be used in future to select which set of “derived requests” an incoming request may fall into for further processing.

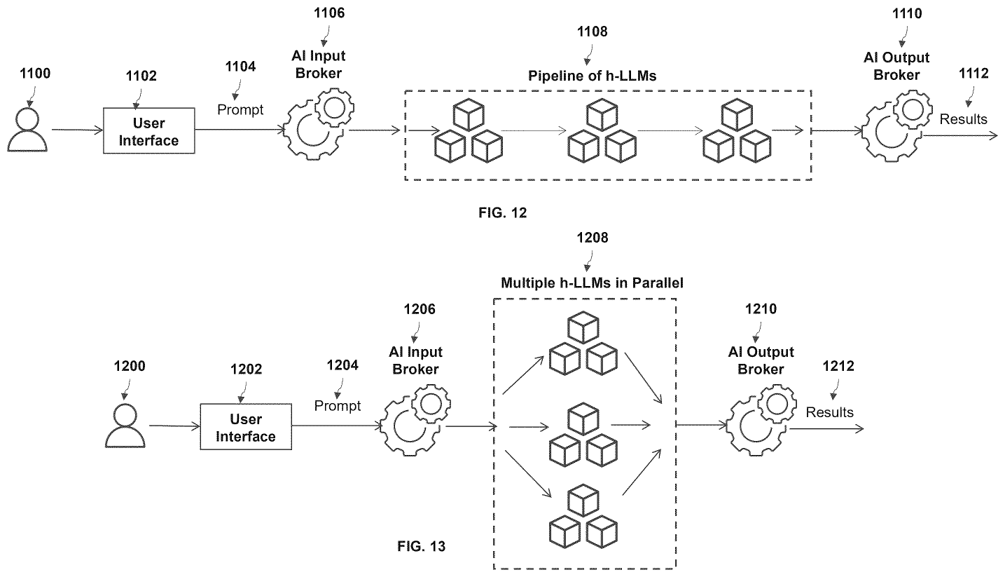

Referring now to FIG. 12 is an illustration of the combining h-LLMs in series, is described in more detail. User 1100 enters a prompt in user interface 1102. The prompt 1104 is sent to an AI Input Broker 1106 which generates derived prompts by adding more contextual information. The derived prompt is sent to multiple h-LLMs 1108 connected in series. The derived prompt goes to the first h-LLM in the sequence which generates results. The results of the first h-LLM are sent to the second h-LLM in the sequence for refinement/enhancement and then to the third h-LLM and so on. The AI Output Broker 1110 processes the results 1112 and sends the processed results to user 1200.

Referring now to FIG. 13 is an illustration of combining h-LLMs in parallel, is described in more detail. User 1200 enters a prompt in user interface 1202. The prompt 1204 is sent to an AI Input Broker 1206 which generates multiple derived prompts by adding more contextual information. The derived prompts are sent to multiple h-LLMs 1208 which process the prompt in parallel generating multiple results. The AI Output Broker 1210 processes the results and sends the processed results 1212 to the user 1200.

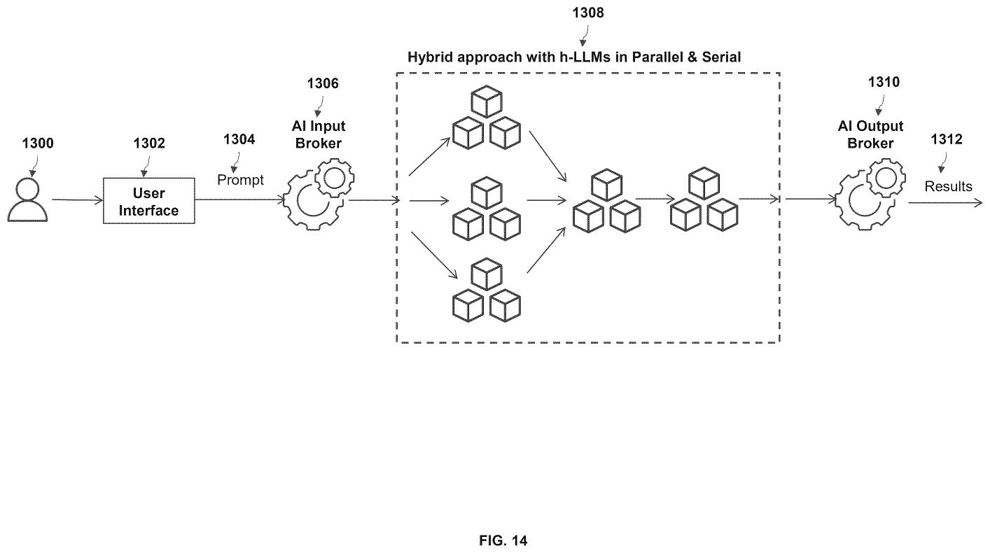

Referring now to FIG. 14 is an illustration of a hybrid approach of combining h-LLM in series and parallel, is described in more detail. User 1300 enters a prompt in user interface 1302. The prompt 1304 is sent to an AI Input Broker 1306 which generates multiple derived prompts by adding more contextual information. The derived prompts are sent to multiple h-LLMs 1308 which processes the prompts generating one or more results. The AI Output Broker 1310 processes the results and sends the processed results 1312 to the user 1300.

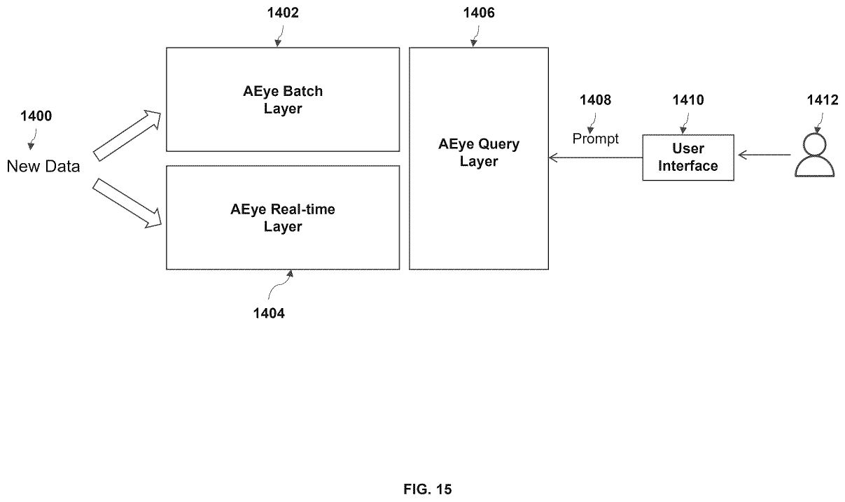

Referring now to FIG. 15 is an illustration of the lambda architecture for h-LLMs, is described in more detail. Lambda architecture is a way of processing massive quantities of data that provides access to batch-processing and stream-processing methods with a hybrid approach, often utilizing in-memory storage instead of disks for speedier processing. Such in-memory processing may be accomplished using a volatile memory device such as random-access memory (RAM) devices, static random-access memory (SRAM) devices, dynamics random-access memory (DRAM) devices, magnetoresistive random-access memory (MRAM) devices, and the like, or a non-volatile random-access memory (NVRAM) device. Such processing may be done partially or entirely in-memory.

This figure illustrates a lambda architecture for h-LLMs comprising batch layer 1402, real-time layer 1404 and a query layer 1406. New input data 1400 comes in continuously and is fed to the batch layer 1402 and real-time layer 1404 simultaneously. The batch layer 1402 maintains one or more h-LLMs which are updated/fine-tuned with the new data on a fixed schedule. Data is aggregated from the new input data 1400 over an aggregation duration that is tied to the fixed schedule. The real-time layer 1404 deals only with recent data which is not processed in the batch layer. The real-time layer 1404 maintains and updates smaller h-LLMs with incremental updates. The real-time layer 1404, also utilizes Map Reduce type analytics and computing and processing (See for example, tutorialspoint.com/map_reduce/map_reduce_introduction.htm) of tokens in the tokenization processes to improve speeds by which tokens are merged or otherwise aggregated in a distributed GPU computing environment, User 1412 sends a prompt 1408 through user interface 1410 to the query layer 1406. The query layer 1406 forwards the original prompt or creates one or more derived prompts which are sent to the batch and real-time layers. The query layer receives the results from the batch and real-time layers and performs tasks such as combining, ranking, filtering, assigning weights and priorities to the results and sends the best results to the user.

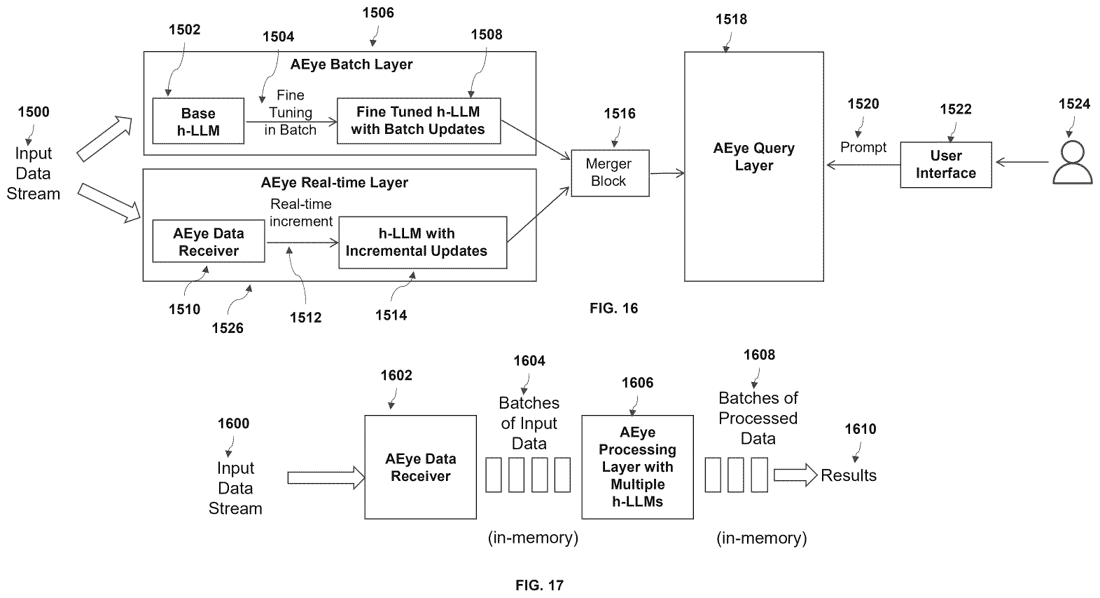

Referring now to FIG. 16 is an illustration of batch and real-time processing architecture for h-LLMs, is described in more detail. The input data stream 1500 is sent to batch layer 1506 and real-time layer 1526. The batch layer 1506 maintains a base h-LLM 1502 which is fine tuned 1504 in batch to generate fine-tuned h-LLM 1508. The real-time layer 1526 generates smaller h-LLMs with incremental updates 1514 in real-time increments 1512. The merger block 1516 combines and merges the h-LLMs from the batch layer and real-time layer to produce a combined h-LLM. The merged h-LLM is used with the query layer 1518 to respond to prompts 1520 sent by user 1524 through the user interface 1522.

Referring now to FIG. 17, an illustration of an in-memory processing architecture for h-LLMs, is described in more detail. The input data stream 1600 is sent to the data receiver 1602 which breaks the data into small batches 1604 which can be processed at least partially, and in some embodiments entirely, in-memory. The processing layer 1606 includes multiple h-LLMs which process the batches on input data and produce the batches of processed data 1608. Such batches may be produced after aggregating data from the input data stream 1600 over an aggregation duration.

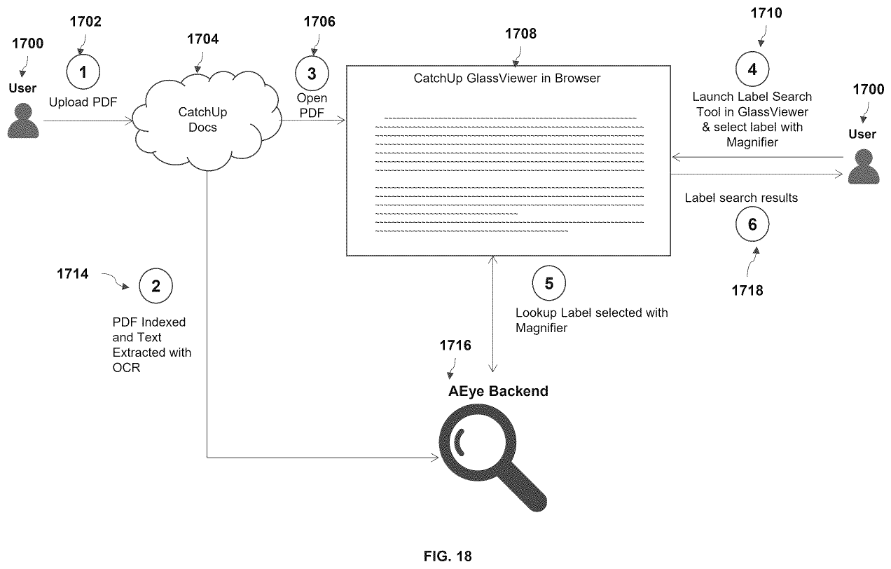

Referring now to FIG. 18 is an illustration of the architecture of PDF label search tool with CatchUp GlassViewer, is described in more detail. User 1700 uploads a PDF document 1702 to the CatchUp document management system 1704. The text of the PDF document is extracted and indexed 1714 in the AEye backend system 1716. Such extraction and indexing may be performed using character recognition analysis, including optical character recognition analysis. The user opens the PDF document 1706 with the CatchUp GlassViewer application 1708 in a browser. User 1700 launches the label search tool 1710 within the CatchUp GlassViewer application 1708 and selects a label using the magnifier tool. The selected label is sent to the AEye backend system 1716 which retrieves and returns 1718 all occurrences of the label.

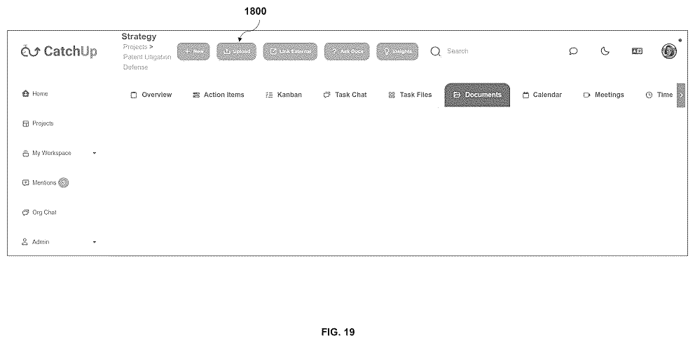

Referring now to FIG. 19 is an exemplary interface 1800 of the CatchUp platform showing the document management system, is described in more detail. Within this interface users can create new documents, upload existing documents, view and edit the documents.

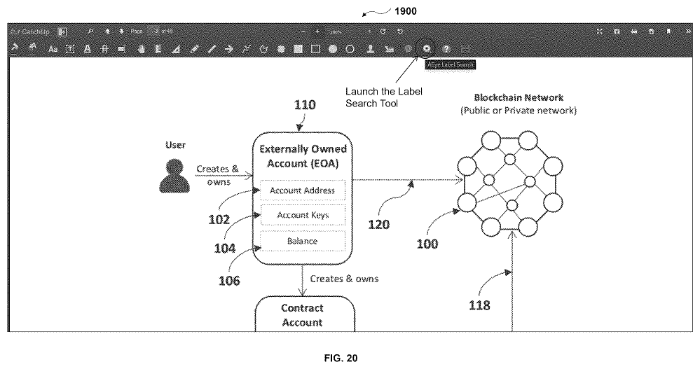

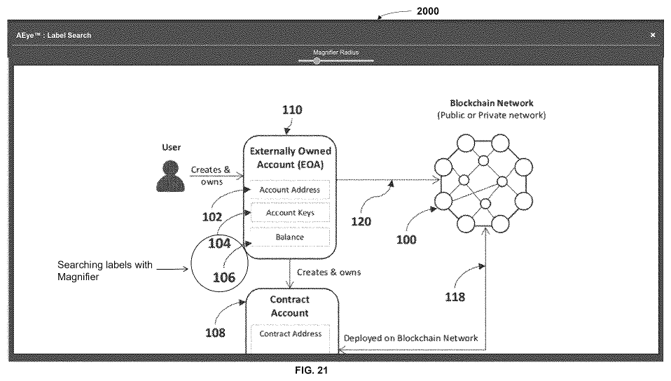

Referring now to FIG. 20 is an exemplary interface 1900 of the CatchUp platform showing the PDF viewer (GlassViewer), is described in more detail. Glass Viewer is a PDF viewer application with CatchUp that allows annotating and commenting PDF files. The annotations and comments are stored in a separate layer which is rendered above the PDF document.

Referring now to FIG. 21 is an exemplary interface 2000 of the CatchUp platform showing a magnifier tool 2002 within the GlassViewer for searching labels, is described in more detail. GlassViewer includes a PDF label searching tool called AEye Label Searcher that allows quickly searching for all occurrences of selected labels within the PDF. AEye Label Searcher uses a magnifier to select specific labels within a region of the PDF which are sent to the AEye backend for processing, and the results are then displayed, which include excerpts from the document where the labels are mentioned. In some embodiments, the AEye backend may lookup labels within multiple documents or return additional information generated from one or more h-LLM models as taught elsewhere in other embodiments of this invention. For example, a legal brief may be first generated using a local (in-house) database of briefs and then supplemented by h-LLMs that are trained on public-domain training sets of legal briefs, and the combination may be merged as needed.

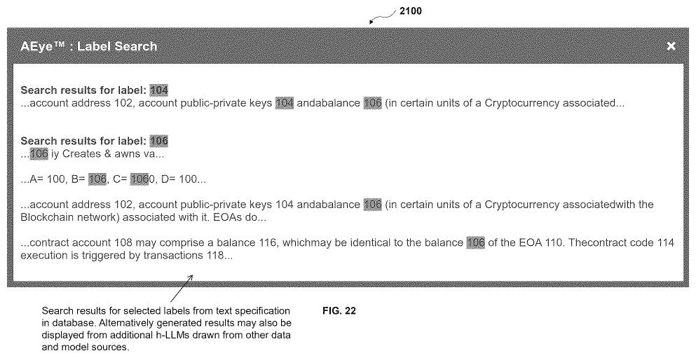

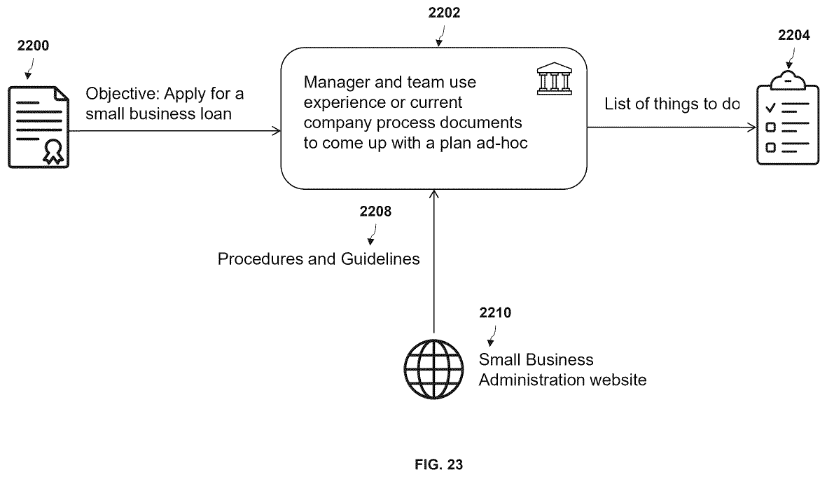

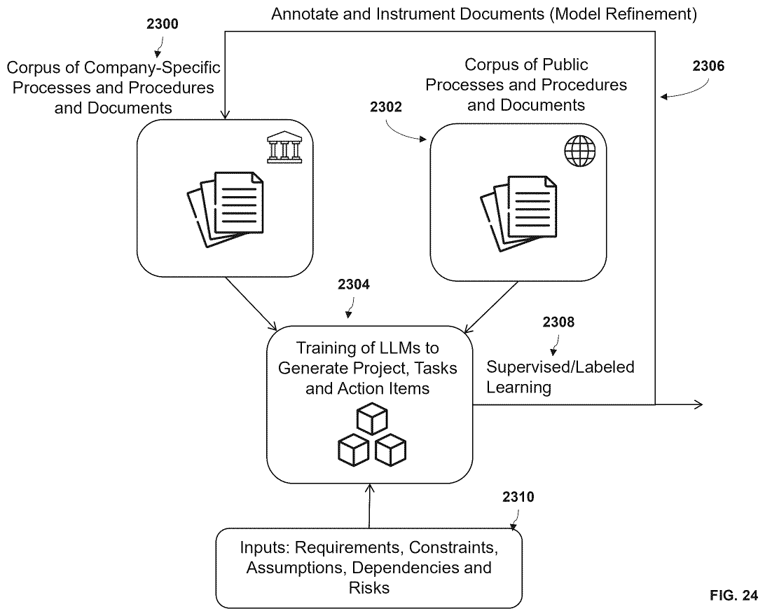

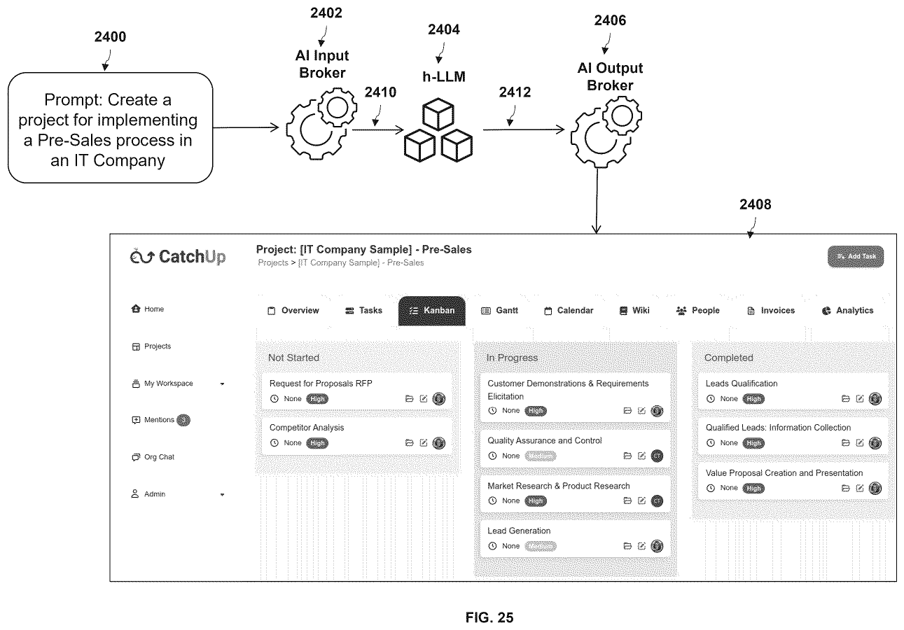

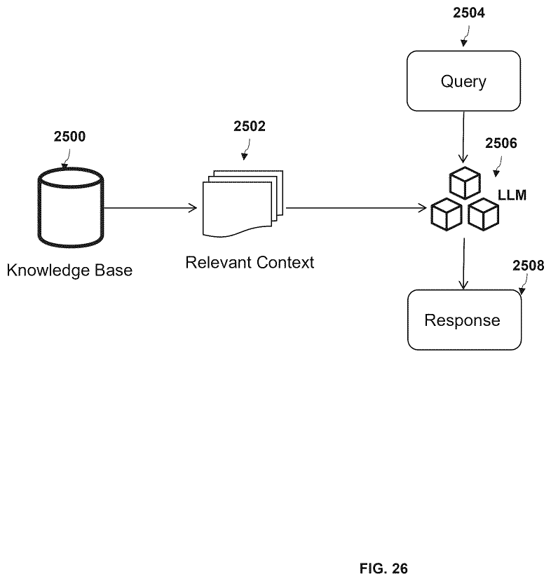

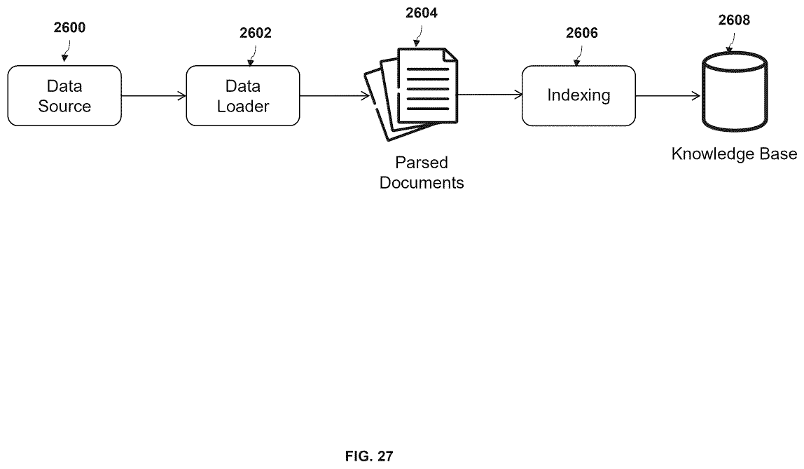

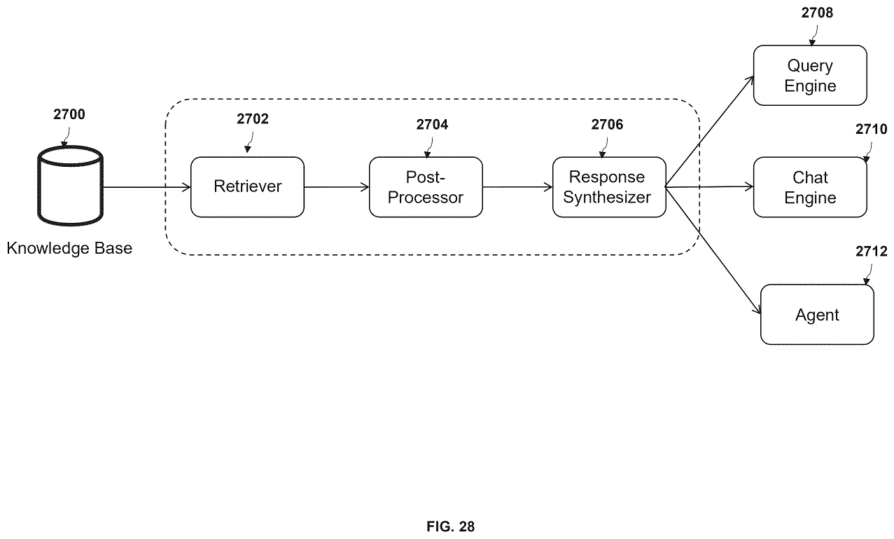

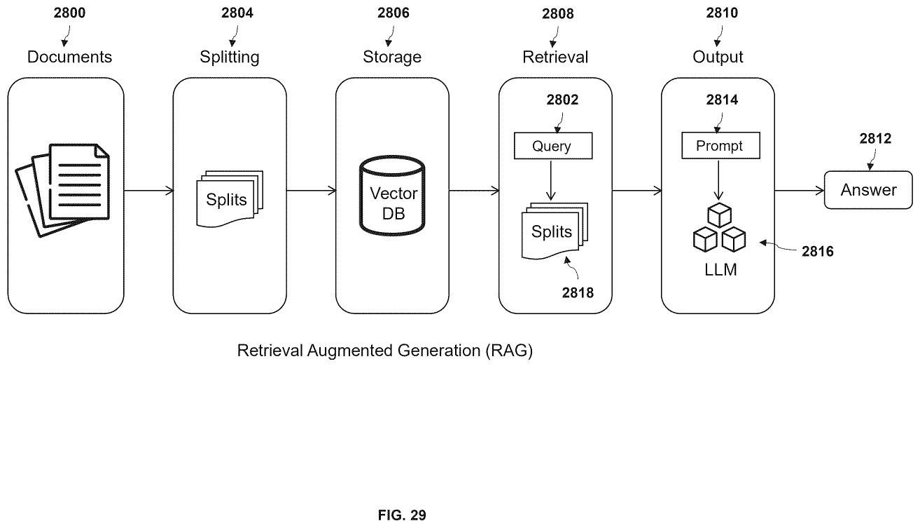

Referring now to FIG. 22 is an exemplary interface of the CatchUp platform showing label search results within GlassViewer, is described in more detail. The labels selected using the magnifier within the AEye Label Searcher are sent to the AEye backend for processing and the results are then displayed as shown in this figure.
a) properties of the information.
b) Content Safety Screening 5340: Content safety screening to prevent the inclusion of explicit, violent, or otherwise inappropriate material.
c) Security Checks 5342: Security checks to detect and remove potential malware, phishing attempts, or other security threats.
d) Fact-Checking 5344: Fact-checking to flag or filter out misinformation or unverified claims.
e) Bias Detection 5346: Bias detection and mitigation to ensure a balanced representation of information.

Superchunks may further comprise monetization characteristics 5308. Superchunks may be associated with advertising content based on their composition or categorization, including (but not limited to).:
a) Content-Based Ads 5348: Inserting relevant advertisements into superchunks based on the topical content. For example, a superchunk about natural farming practices might include or be associated with advertisements from organic fertilizer companies.
b) Category-Linked Ads 5350: Linking advertisements to the category or classification of the superchunk. For instance, a superchunk related to rent control laws in a specific city might be associated with advertisements for local legal services.
c) Ad Bidding System 5352: Implementing a bidding or auction system for advertisers to target specific types or categories of superchunks.
   This advertisement feature can generate advertisements that are relevant to the user query, user interests, user intentions, or user past history of interactions. As part of the derived queries, certain queries may be made by the AI brokers to the user to identify their specific goals and intentions (for example, the AI brokers may ask the user if they are interested in buying a new car in the next six months, given that the user query appears to research and compare various brands of automobiles). The two-way interaction between the AI brokers and the user is seen as another novelty of certain embodiments of the present invention, compared to the one way interaction users currently have with generative AI LLMs.

Superchunks may further comprise processing characteristics 5310 The processing of superchunks may include multiple stages of enhancement and screening, including, but not limited to:
a) Privacy Enhancements 5354: Implementation of privacy enhancements, including, detection and removal of PII, data anonymization or pseudonymization techniques.
b) Ad Integration 5356: Ad generation and integration based on content analysis and categorization.
c) Safety Guardrails 5358: Application of safety and security guardrails to filter or flag potentially harmful or inappropriate content.
d) Tiered Access 5360: The system may employ different strategies for superchunk creation, maintenance, and utilization based on factors such as user authentication level, subscription tier, or specific privacy and security requirements of the use case.
   These variations and implementations of superchunks are not mutually exclusive, and the present invention incorporates systems that may include multiple approaches or allow for dynamic switching between different superchunk paradigms based on context or requirements.

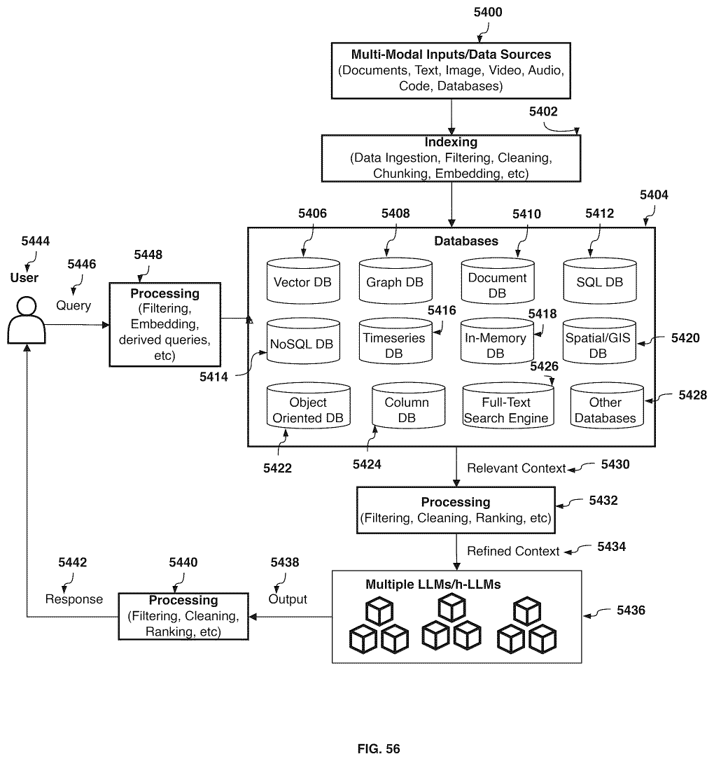

Referring now to FIG. 56, an illustration of an architecture of a Hybrid-RAG system is described in more detail. A Hybrid Retrieval-Augmented Generation (Hybrid-RAG) system is designed to process and generate multi-modal data, including but not limited to text, documents, images, audio, video, and code. The system leverages a combination of various database types and LLMs to overcome the limitations of traditional Vector-RAG or Graph-RAG systems, providing enhanced performance and versatility across diverse data types and query scenarios. The Hybrid-RAG system comprises multiple components designed to efficiently process, store, retrieve, and generate multi-modal data.

To achieve optimal performance for multi-modal data, Hybrid-RAG employs multiple embedding models and specialized databases, each fine-tuned for a specific content type such as text, audio, images, video, or code. This specialized approach ensures that the unique characteristics and nuances of each content modality are accurately captured and indexed. The system begins with the indexing of multi-modal data 5400, which may include text, documents, audio, video, code, and other data types. The indexing process 5402 involves several steps:
1. Data Ingestion: Raw multi-modal data is ingested into the system.
2. Preprocessing: This step includes chunking, filtering, and cleaning of the ingested data.
3. Embedding Generation: Specialized embedding models generate vector representations for each data type.

The processed and embedded data is stored in a variety of database types 5404, including: a Vector Databases 5406 (e.g., Pinecone, Milvus) for efficient similarity search; Graph Databases 5408 (e.g., Neo4j, TigerGraph) for relationship-based queries; Document Databases 5410 (e.g., MongoDB, Couchbase) for unstructured data; Relational Databases 5412 (e.g., PostgreSQL, MySQL) for structured data; Non-Relational Databases 5414 (e.g., DynamoDB) for unstructured or semi-structured data; Time-Series Databases 5416 (e.g., InfluxDB, TimescaleDB) for temporal data; In-Memory Databases 5418 (e.g., Redis, Memcached) for high-speed data access; Spatial/GIS Databases 5420 (e.g., PostGIS) for location-based data; Object-Oriented Databases 5422 (e.g., ObjectDB) for complex object storage; Column-Oriented Databases 5424 (e.g., Apache Cassandra) for wide-column storage; Full-Text Search Engines 5426 (e.g., Elasticsearch, Solr) for keyword-based retrieval; and Other specialized database types 5428 (e.g. NewSQL, multi-modal databases, RDF stores, XML databases, etc).

When a user 5444 submits a query 5446, the system pre-processes the query. Query Preprocessing 5448 involves filtering, embedding generation, and the creation of derived queries. Based on the preprocessed query, the system determines which database(s) are most suitable for retrieval in a query routing process. The system then queries the selected databases to retrieve relevant context 5430. The retrieved context 5430 undergoes processing 5432 including filtering, cleaning, and ranking to generate the refined context 5434. One or more appropriate LLMs or h-LLMs 5436 are then selected based on the query type and refined context 5434. The responses 5438 generated by the LLMs or h-LLMs 5436 undergo filtering, cleaning, and ranking at a post-processing step S440. The final processed response 5442 is then delivered to the user. The previously used contexts may also be stored in-memory (for example, a cache) for faster and more accurate processing times.

For the generation phase, the Hybrid-RAG utilizes an ensemble of LLMs or h-LLMs 5436, each specialized for different tasks. These may include models optimized for question-answering, code generation, image interpretation, audio transcription, and video analysis, among others. This multi-faceted approach allows Hybrid-RAG to not only process a wide range of input types but also to generate appropriate and context-aware multi-modal outputs.

The Hybrid-RAG system addresses limitations of traditional RAG systems by utilizing the most appropriate database(s) for each data type and query scenario. Hybrid-RAG enables multi-modal data processing and generation, thus providing more comprehensive and accurate responses through the integration of multiple data sources and LLMs.

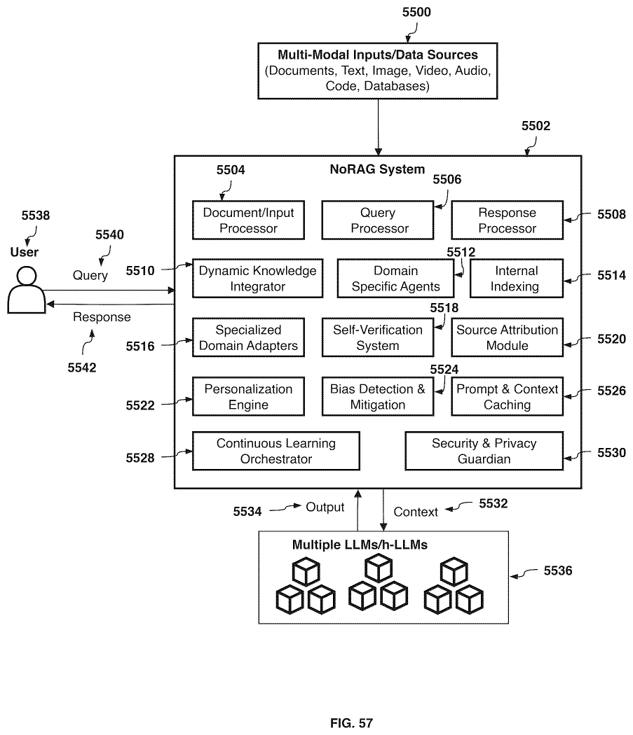

Referring now to FIG. 57, an illustration of an architecture of a NoRAG system according to an embodiment of the invention is described in more detail. LLMs face limitations in accessing current information, maintaining factual accuracy, and providing transparent, attributable responses. RAG systems address these limitations of LLMs. RAG is useful for tasks requiring current or specialized knowledge, as it allows language models to draw upon external, updatable sources of information. However, RAG often introduces complexities in implementation and maintenance. Users may, depending on their design options, have to address complexities of chunking, embedding, indexing documents, maintaining vector databases, for instance. NoRAG system provides an approach to enhance LLMs without the need for RAG systems, hence the name NoRAG. By integrating functionalities directly in a plug-in manner into the LLM architecture, in some embodiments as a license-able plugin to LLMs, NoRAG offers improved performance, reduced complexity, and enhanced user experience compared to traditional RAG systems.

The NoRAG system begins with ingesting multi-modal data 5500, which may include text, documents, images, audio, video, code, and other data types. The NoRAG system 5502 comprises several modules, each designed to perform specific functions in the overall process of enhancing LLM capabilities.

The NoRAG system comprises a Document/Input Processor 5504 module. The Input Processor module 5504 is responsible for processing input documents and data sources. It handles various file formats, extracts relevant information, and prepares the data for integration into the NoRAG system.

The NoRAG system further comprises a Query Processor module 5506: The Query Processor module 5506 handles user queries, performing sophisticated analysis to improve them for the LLM 5536. It breaks down complex queries into manageable parts and generates derived queries when necessary.

The NoRAG system further comprises a Response Processor module 5508. The Response Processor module 5508 performs post-processing on the LLM's 5536 output 5534 before sending it to the user. This module refines the generated content, ensures coherence, and applies any necessary formatting or style adjustments to enhance the quality and relevance of the final response.

The NoRAG system further comprises Dynamic Knowledge Integrator component 5510. The Dynamic Knowledge Integrator component 5510 interfaces directly with the LLM 5536, providing relevant information during the generation process. It acts as a bridge between the LLM's 5536 inherent knowledge and the additional information processed by the NoRAG system, improving integration of external knowledge into the LLM's 5536 responses 5534.

The NoRAG system further comprises a Domain Specific Agents module 5512: The Domain Specific Agents module 5512 comprises several domain specific agents which retrieve appropriate specialized knowledge on the query context (e.g. web search agent, stock market agent, weather data agent, loT data, etc). It enables the NoRAG system to adapt its responses to specific domains, improving accuracy and relevance in specialized fields.

The NoRAG system further comprises an Internal Indexing module 5514. The Internal Indexing module 5514 utilizes a combination of diverse database types, including, but not limited, to vector databases, graph databases, document databases, time-series databases, full-text search engines, in-memory databases, object databases, spatial databases, SQL databases, NoSQL databases, and column databases. This approach ensures efficient indexing and retrieval of information, improving the NoRAG system's performance across various data types and query patterns.

The NoRAG system further comprises Specialized Domain Adapters modules 5516: These plug-in modules 5516 contain specialized knowledge for specific domains. They can be dynamically loaded and unloaded based on the query context, allowing the NoRAG system to provide expert-level responses in various fields without overburdening the core LLM.

The NoRAG system further comprises a Self-Verification system 5518. The Self-Verification system 5518 checks facts and reduces hallucinations in the LLM's 5536 outputs 5534. It employs internal consistency checks and compares generated content against the system's knowledge base to ensure accuracy and reliability in the responses.

The NoRAG system further comprises a Source Attribution module 5520: The Source Attribution module 5520 tracks and cites internal knowledge sources used in generating responses. It enhances the transparency and credibility of the NoRAG system's outputs by providing citations for the information used.

The NoRAG system further comprises a Personalization Engine 5522. The Personalization Engine 5522 adapts responses 5542 based on user preferences and interaction history. It maintains user profiles and adjusts the system's outputs to match individual user needs, enhancing the relevance and usefulness of the responses. This module may optionally inject advertisements in responses based on the user's subscription tier or preferences or queries sent to the user 5538 by the LLM 5536 to identify the user's attitudes, intentions, and predict behavior and future actions.

The NoRAG system further comprises a Bias Detection & Mitigation module 5524. The Bias Detection & Mitigation module 5524 identifies potential biases in the NoRAG system's responses and works to balance them. It employs advanced algorithms to recognize various types of bias and adjusts the output to provide more neutral and fair responses.

The NoRAG system further comprises a Prompt, Derived Prompts, and Context Caching module 5526: This module 5526 caches user queries, derived prompts, and the relevant context used (including previously used contexts) that may be used to generate responses. By storing this contextual information for in-memory processing, the NoRAG system can improve response times for similar queries and maintain consistency in its outputs over time.

The NoRAG system further comprises a Continuous Learning Orchestrator 5528: The Continuous Learning Orchestrator 5528 manages the ongoing learning process of the model. It identifies knowledge gaps, prioritizes learning objectives, and coordinates the integration of new information across all modules, ensuring that the NoRAG system remains up-to-date and continues to improve over time.

The NoRAG system further comprises a Security and Privacy Guardian module 5530: The Security and Privacy Guardian module 5530 ensures data privacy and security in knowledge storage and retrieval. Privacy and security guardrails are implemented to filter sensitive data in the query and responses (such as personally identifiable information (PII)).

When a user 5538 submits a query 5540, the NoRAG system processes the query and generates a relevant context 5532 which is passed to one or more LLMs or h-LLMs 5536. NoRAG utilizes an ensemble of LLMs or h-LLMs 5536, each specialized for different tasks. These may include models optimized for question-answering, code generation, image interpretation, audio transcription, and video analysis, among others. The processed response 5542 is then returned to the user.

The NoRAG plug-in and/or integrated LLM system may provide several advantages over traditional RAG approaches:
1. Reduced Complexity: By integrating functionalities directly into the LLM architecture, the NoRAG system eliminates the need for external retrieval systems, simplifying implementation and maintenance. The NoRAG system works like a plugin system enhancing the capabilities of an LLM.
2. Improved Performance: The tight integration of agents, domain adapters, knowledge and processing modules allows for faster response times and more coherent outputs.
3. Enhanced Customization: The modular architecture of the NoRAG system allows for easy addition or modification of specialized knowledge domains without requiring changes to the core LLM.
4. Improved Privacy and Security: By internalizing data storage and retrieval, the NoRAG system provides improved control over sensitive information and reduces potential vulnerabilities associated with external data sources.
5. Seamless Updates: The Continuous Learning Orchestrator module 5528 enables the NoRAG system to incorporate new information more efficiently than traditional RAG systems, which often require separate update processes for external knowledge bases.
6. Use in Network of LLM Agents: The NoRAG plug-in module can be used as a series or parallel network when connected to LLMs that operate as a network of LLM agents performing specialized tasks in a coordinated sequence (managed by AI brokers or LLMs, for example). Each specialized LLM agent may use a different NoRAG plugin, and NoRAG plugins may be mapped to different LLMs, depending on the type of task being done. A library of NoRAG modules may be developed in a generic manner and also with a target LLM family as an objective, and NoRAG modules for billing, advertisement generation, fault-tolerance, and security may also be added on in a plug-in manner.

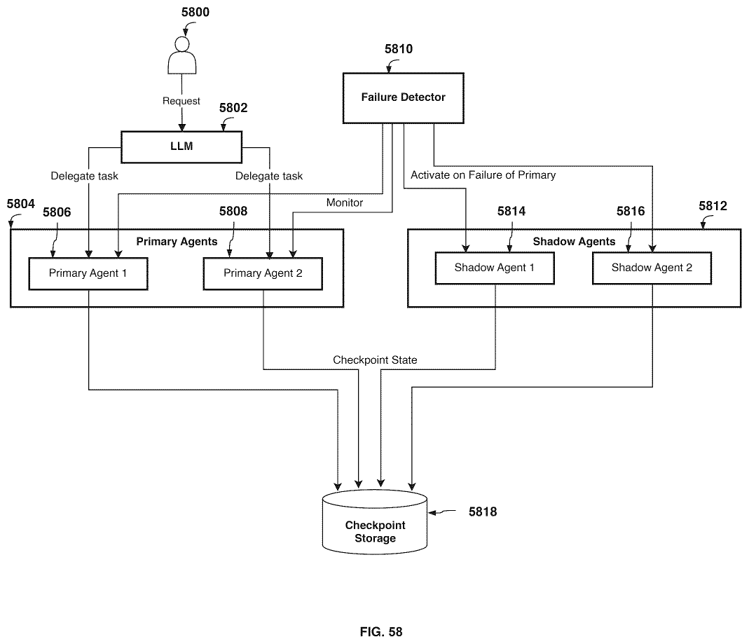

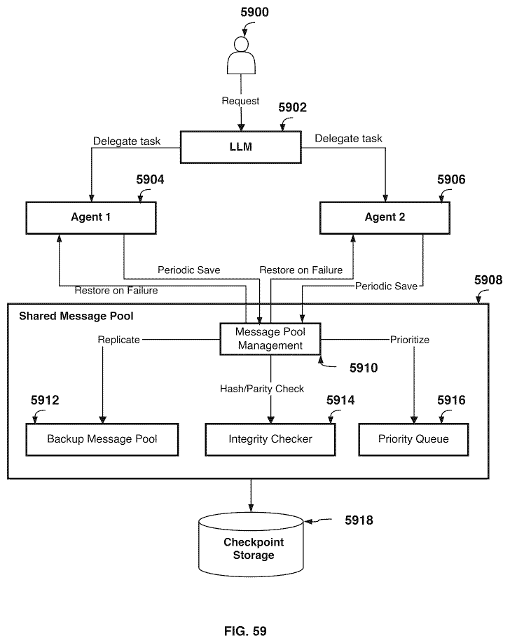

Referring now to FIG. 58, an illustration of the use of Shadow Agents for fault tolerance is described in more detail. The system comprises a Large Language Model (LLM) 5802 which receives requests from a User 5800 and delegates tasks to Primary Agents 5804 (5806, 5808). For each Primary Agent 5806, 5808, a corresponding Shadow Agent 5814, 5816 is created to mirror the state of the Primary Agent (5806, 5808). A Failure Detector 5810 continuously monitors the Primary Agents. In the event of a Primary Agent 5804 failure, the Failure Detector 5810 activates the corresponding Shadow Agent 5812. The activated Shadow Agent 5812 then takes over the role of the failed Primary Agent 5804, ensuring continuity of system operation. Primary Agents 5804 periodically checkpoint their state to a Checkpoint Storage 5818. This checkpointing ensures that Shadow Agents 5812 can fetch the up-to-date representation of the Primary Agents' 5804 states from the checkpoint storage 5818, allowing for seamless transition in case of failure. The system thus provides redundancy through Shadow Agents 5812, continuous monitoring via the Failure Detector 5810, state preservation through regular checkpointing to Checkpoint Store 5818, and seamless transition capabilities, all contributing to a robust fault-tolerant architecture.

Referring now to FIG. 59, an illustration of the Checkpointing, State Saving, and Message Pool Management for fault tolerance in agents is described in more detail. The User 5900 sends requests to a large language model 5902, which delegates tasks to agents 5904, 5906. The agents 5904, 5906 interact with a shared message pool 5908. Each Agent Process periodically saves its state to the message pool 5908. Checkpoint Storage 5918 serves as a central repository for agent states and can restore an agent's state in case of failure. The Shared Message Pool 5908 serves as the communication medium between the agents 5904, 5906. It incorporates several management features that may be managed by a message pool management module 5910 to ensure fault tolerance and efficient operation such as:
1. Replication to a Backup Message Pool 5912 for redundancy;
2. Integrity checking using a dedicated Integrity Checker 5914, which employs hash or parity bit mechanisms; and
3. A Priority Queue 5916 for message prioritization, ensuring critical or time-sensitive messages are handled promptly.

Agents read from and write to the Shared Message Pool 5908. In the event of agent failure, the system can restore the agent's state from the Checkpoint Storage 5918 via the Shared Message Pool 5908, ensuring minimal disruption to overall system operation. This architecture provides robust fault tolerance through state preservation, redundant and integrity-checked communication, and efficient message handling.

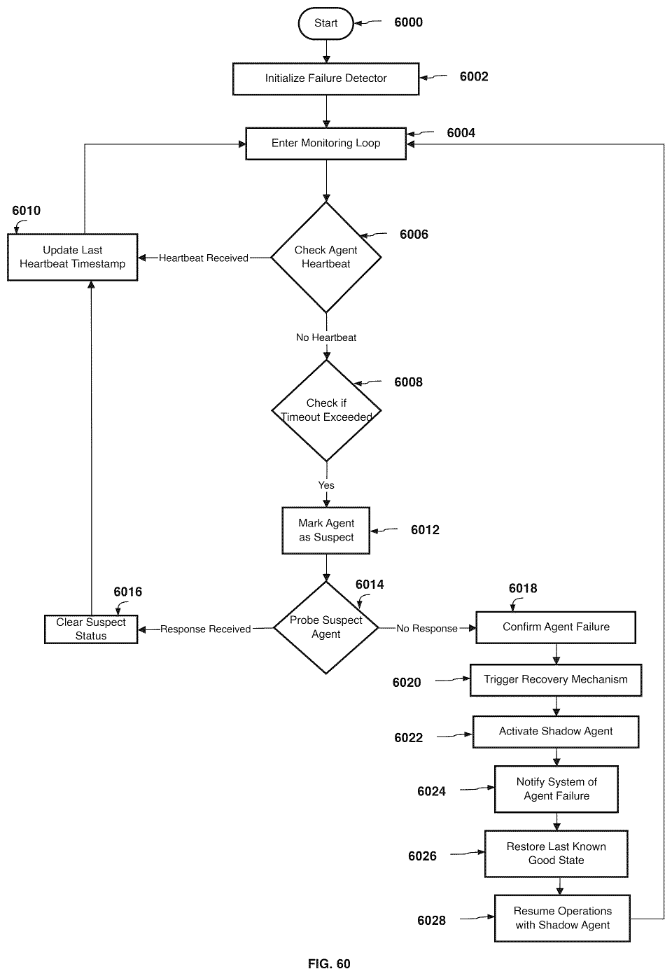

Referring now to FIG. 60, an illustration of a flow chart of a Failure Detection Algorithm for fault tolerance in agents is described in more detail. The algorithm begins 6000 with the initialization of the Failure Detector 6002. It then enters a continuous monitoring loop 6004, where it regularly checks for heartbeats from each agent 6006. If a heartbeat is received, the last heartbeat timestamp for that agent is updated 6010, and the loop continues. If no heartbeat is received, the system checks if a predefined timeout threshold has been exceeded 6008. If the timeout exceeds, the agent is marked as a suspect 6012. The system then probes the suspect agent directly 6014. If a response is received from the probe, the suspect status is cleared from the agent 6016, and the system returns to the monitoring loop. If no response is received from the probe, the agent failure is confirmed 6018. This triggers a series of recovery actions:
1. The recovery mechanism is activated 6020;
2. A shadow agent is activated to take over the failed agent's responsibilities 6022;
3. The system is notified of the agent failure 6024;
4. The last known good state of the failed agent is restored 6026; and
5. Operations resume with the newly activated shadow agent 6028.

Following these recovery actions, the system returns to the monitoring loop 6004, now including the newly activated shadow agent in its monitoring activities. This algorithm provides a robust approach to maintaining system reliability in a multi-agent environment. It allows for quick detection of failures, seamless transition to backup agents, and ensures continuous operation of the system, thus providing a high degree of fault tolerance.

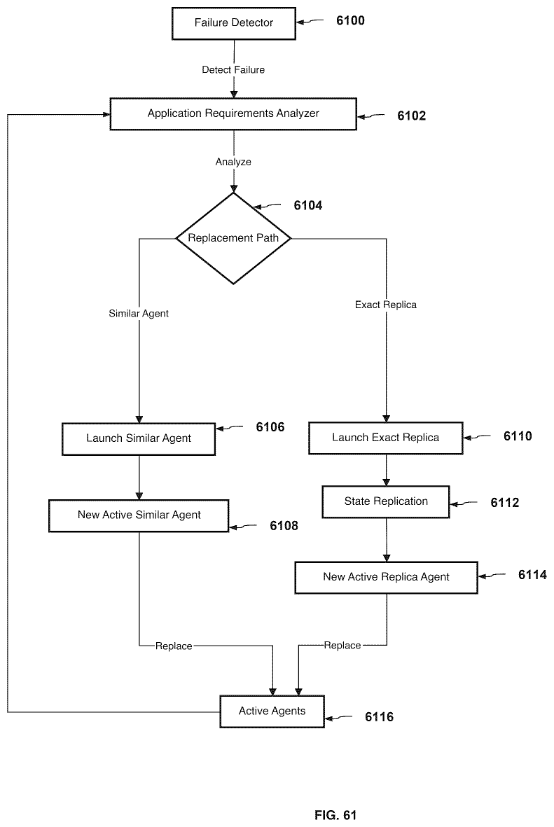

Referring now to FIG. 61, an illustration of the Flexible Agent Replacement mechanism for fault tolerance in a multi-agent system is described in more detail. A Failure Detector 6100 continuously monitors the Active Agents 6116 for any signs of failure or degradation. Upon detection of a failure in an Active Agent 6116, the system initiates the Flexible Agent Replacement process 6104. This process involves two possible paths:
1. Similar/LesserDegree of Similarity Agent Replacement 6106: In this path, the system launches a new agent from the Replacement Agent pool that performs similar functions and/or has a relatively lesser degree of similarity to the failed agent, but is not necessarily an exact replica. This new agent 6108 takes over the general responsibilities of the failed agent.
2. Exact Replica/GreaterDegree of Similarity Agent Replication 6110: For applications requiring strict state preservation or comparatively greater similarity between the agent and the replicated agent, this path involves launching a new agent that is an exact replica or a replication with a relatively greater degree of similarity of the failed agent. This is achieved through the use of a State Replication mechanism 6112, which ensures the new agent 6114 has the same state and knowledge as the failed agent at the time of its last checkpoint.

The choice between these two paths is determined by an Application Requirements Analyzer 6102, which assesses the specific needs of the current application or task. This Flexible Agent Replacement mechanism allows the system to maintain operational continuity while adapting to different application requirements, thus providing a versatile approach to fault tolerance. Regardless of which path is taken, the agent generated thereby is added to the active agents 6116. The Application Requirements Analyzer 6102 continues monitoring the active agents for any subsequent failures.

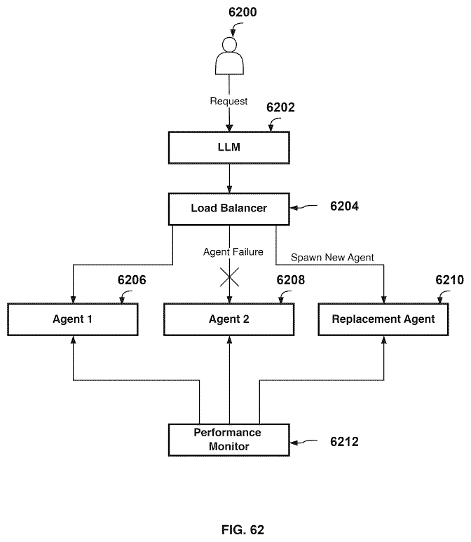

Referring now to FIG. 62, an illustration of a soft failure handling mechanism in a fault-tolerant agent system is described in more detail. The system comprises multiple Agent Processes (6206, 6208) managed by a Load Balancer 6204. A Performance Monitor 6212 continuously tracks the performance metrics of each agent, including response times, task completion rates, and resource utilization. When the Performance Monitor 6212 detects a soft failure condition, such as missed deadlines or performance degradation due to overload, it triggers the soft failure handling mechanism. This mechanism involves several steps:
1. Load Redistribution: The Load Balancer 6204 reassigns tasks from the overloaded agent 6208 to other available agents 6206, helping to alleviate the immediate performance issues;
2. Resource Allocation: Additional computational resources are allocated to the affected agent if available, potentially resolving resource-related performance issues;
3. Agent Scaling: If the overload persists, new agents are spawned 6210 from an Agent Template to share the workload. These new agents 6210 are added to the active agent pool and begin processing tasks; and
4. Gradual Recovery: As the system stabilizes, the Performance Monitor 6212 continues to track metrics, gradually returning to normal operation as performance improves.

This soft failure handling mechanism allows the system to address performance issues and overload scenarios without complete agent failure, maintaining system stability and ensuring continuous operation.

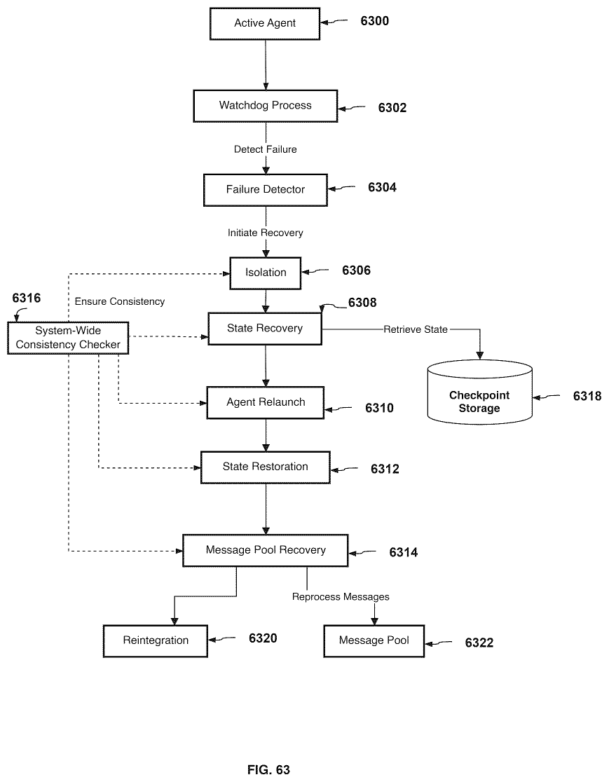

Referring now to FIG. 63, an illustration of a hard failure handling mechanism in a fault-tolerant agent system is described in more detail. The system comprises one or more Active Agents (6300), each with an associated Watchdog Process (6302). A Failure Detector 6304 oversees the entire system. In some embodiments, a Message Pool 6322 facilitates communication between agents. In other embodiments, an API service mesh that allows inter-agent communication may be employed.

When a hard failure occurs, such as an agent process termination or complete loss of communication, the following steps are initiated:
1. Failure Detection 6304: The Watchdog Process 6302 associated with the failed agent detects the failure and alerts the central Failure Detector 6304;
2. Isolation 6306: The failed agent is immediately isolated from the system to prevent cascading failures or corruption of the Message Pool 6322;
3. State Recovery 6308: The last known good state of the failed agent is retrieved from a Checkpoint Storage 6318;
4. Agent Relaunch 6310: A new agent process is launched, either as an exact replica of the failed agent or as a similar agent with comparable capabilities, depending on system requirements;
5. State Restoration 6312: The recovered state is applied to the newly launched agent, bringing it up to date with the system's current state;
6. Message Pool Recovery 6314: Any pending messages in the Message Pool associated with the failed agent are reprocessed or redirected to the new agent as appropriate. Alternatively, an API gateway and/or API service mesh may be provided for exchange of messages between the agents and/or a message storage database (See solo.io/topics/service-mesh/service-mesh-vs-api-gateway/to see how these terms may be described, the content of which is incorporated in its entirely by reference except to the extent disclosure therein is inconsistent with disclosure herein).
and
7. System Reintegration 6320: The new agent is reintegrated into the active system, resuming the tasks of the failed agent.

Throughout this process, a System-Wide Consistency Checker 6316 ensures that the overall system state remains consistent and that no critical information or tasks are lost during the transition. This Hard failure handling mechanism enables the system to recover from severe failures, maintaining data integrity and operational continuity even in the face of complete agent failures.

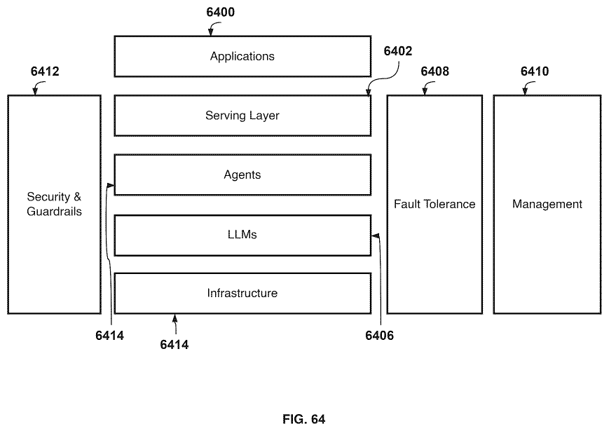

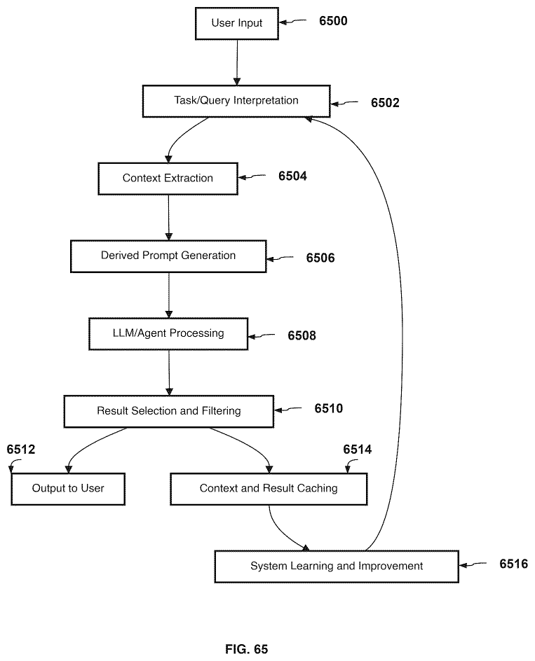

Referring now to FIG. 64, an illustration of generative AI Agent Stack (AGES) is described in more detail. AGES is designed to provide a generative AI stack for fault-tolerant agents. AGES comprises the following layers:
1. Application Layer 6400: This is the topmost layer where the end-user applications and interfaces reside. It is where the fault-tolerant agents are integrated into specific use cases or products.
2. Serving Layer 6402: This layer is responsible for deploying and serving the agents and models. It includes API endpoints for agent interactions, scaling mechanisms to handle varying loads, request routing and load distribution.
3. Agent Layer 6404: This layer contains the individual agents, including primary agents and shadow agents. It manages agent interactions, task delegation, and coordination between agents.
4. LLM Layer 6406: This layer comprises the Large Language Models that power the agents. It includes model inference, fine-tuning capabilities, and potentially multiple LLM options for different agent roles.
5. Fault Tolerance Layer 6408: This layer implements the fault tolerance mechanisms. It includes mechanisms like shadow agent management, checkpointing and state saving, failure detection algorithms, and message pool replication and management.
6. Management Layer 6410: This layer oversees the entire system. It handles agent lifecycle management (spawning, termination), load balancing and resource allocation, system monitoring and logging, and configuration management.
7. Security & Guardrails Layer 6412: This layer ensures the security and integrity of the entire system. It includes authentication and authorization mechanisms, encryption for data in transit and at rest, secure message passing between agents, and integrity checks for message pools and checkpoints. Guardrails and filters are included to ensure the generated results are safe, relevant, and align with predefined criteria.
8. Infrastructure Layer 6414: This is the foundation layer that provides the computational resources and storage. It includes cloud or on-premises servers, GPUs/TPUs for model inference, distributed storage systems for message pools and checkpoints, networking infrastructure, and blockchain network(s).

AGES incorporates architectural patterns and technologies similar in some ways, and different in other significant ways, to those used in Microservices, Containers, Service Meshes, Functions-as-a-Service (FaaS), and Blockchain to enhance the scalability, flexibility, trust, auditability, resilience, and manageability of agents and agentic applications, described as follows:
1. Microservices: Microservices architecture is applied across multiple layers (Agent, LLM, Fault Tolerance, Management, and Serving). Each agent, LLM instance, or specific functionality (like failure detection or load balancing) is implemented as a separate microservice using APIs. This allows for better scalability, easier updates, and more flexible deployment options.
2. Containers: Containers (like Docker) are used to package and deploy the specialized h-LLMs/agents. This ensures consistency across development and production environments, simplifies deployment, and enables easy scaling of individual components.
3. Service Mesh: A service mesh (like Istio or Linkerd) is implemented to manage communication (utilizing asynchronous or synchronous or gRPC-like mechanisms) between agents and specialized h-LLMs. It handles service discovery, load balancing, encryption, and provides additional observability and traffic management features.
4. Functions-as-a-Service (FaaS): FaaS are utilized for specific, event-driven tasks within the Agent, LLM, and Fault Tolerance layers. For example, spawning new agents, running inference on LLMs, or executing fault tolerance checks are implemented as serverless functions.
5. Orchestration: Orchestration tools and frameworks are used to manage the containers, service mesh, and FaaS components. It includes tools like Kubernetes for container orchestration, which handles scaling, load balancing, and self-healing of the containerized microservices that house these specialized agents.
6. Blockchain: Blockchain technology is leveraged to enhance AGES by providing a secure, transparent, and decentralized infrastructure for agent interactions and system management. A Blockchain network (as part of the infrastructure layer) enables decentralized identity management, smart contracts for agent governance, immutable audit trails, and tokenization of compute resources. This integration improves security through cryptographic mechanisms, enhances fault tolerance with distributed checkpointing, and enables transparent resource allocation and reputation systems for agents.
7. Agent-as-Code: AGES leverages a novel Agent-as-Code (AaC) model enabling automated deployment, scaling, and lifecycle management of agents. The AaC model introduces a declarative approach to defining and managing AI agents within the AGES framework. The AaC model allows developers to specify agent characteristics, behaviors, and interactions using a domain-specific language or configuration files. These definitions encompass the agent's cognitive architecture, learning parameters, API endpoints, and inter-agent communication protocols. By versioning these agent definitions in code repositories, teams can track changes, collaborate effectively, and ensure reproducibility across environments. This methodology facilitates rapid prototyping, easier testing, and more efficient updates to agent systems, while maintaining consistency and reducing manual configuration errors.

The term “agent” as used throughout this specification should be interpreted broadly to encompass a wide range of specialized h-LLMs applications, including use of AI brokers, and implementations and functionalities that can generate and/or use the “derived tasks” and “relevant context” of our inventive methods and systems. An agent may refer to but is not limited to: specialized autonomous or semi-autonomous software entities, AI-driven assistants, task-specific modules, multi-agent systems, language models with specialized capabilities, code interpreters, workflow automation tools, chatbots, virtual developers, research assistants, data analyzers, code generators, testing tools, or any combination thereof. Agents may operate independently or as part of a larger system, may be domain-specific and may utilize various specialized LLM technologies. The specific implementation, architecture, or capabilities of an agent or AI broker should not be construed as limiting the scope of the present invention. Agents may evolve, adapt, or be repurposed over time, and may incorporate new technologies or methodologies as they emerge. The term “agent” also extends to systems that manage, coordinate, or facilitate the operation of multiple sub-agents or agent components.

Referring now to FIG. 65, an illustration of Language Adaptive AI Processing (LEAP) model is described in more detail. LEAP is a new computing model that represents a significant departure from traditional computing paradigms such as ETL (Extract, Transform, Load), and instruction-set architectures like MIPS or RISC.

A method of a LEAP model comprises the following steps:
1. User Input 6500: Unlike traditional systems where inputs need to be precisely formatted, LEAP allows for natural language inputs. Users can directly express their needs, tasks, or queries without adhering to strict syntax or command structures.
2. Task and Query Interpretation 6502: The system interprets the user's input, understanding the intent and desired outcome. This step involves natural language understanding and requires context awareness.
3. Context Extraction and Generation 6504: At this step the system gathers relevant information needed to complete the task. It involves tasks such as retrieving information from databases or the internet, analyzing the user's history or preferences, and generating additional context or sub-tasks as needed.
4. Derived Prompt and/or Task Generation 6506: Based on the extracted context, the system may generate more specific or detailed prompts. These derived prompts are designed to elicit the most relevant and accurate responses from the LLM or agents who may in turn generate additional derived tasks or prompts for additional processing, including calling external tools, such as search tools or accessing external content.
5. LLM/Agent Processing 6508: The core computation happens here, where LLMs or specialized AI agents process the prompts, and/or generate derived tasks, and generate results. This step can involve multiple iterations or agent collaborations.
6. Result Selection and Filtering 6510: The system applies guardrails and filters to ensure the generated results are safe, relevant, and align with predefined criteria. This step might involve fact-checking, bias detection, or content moderation. The results can then be output to the user 6512.
7. Context and Result Caching 6514: The system caches both the context and results for future reference.
8. System Learning and Improvement 6516: The cached context and results improve efficiency for similar future queries and allows the system to learn and improve over time.

The benefits of LEAP as compared to traditional computation models includes:
1. Flexibility: Unlike rigid instruction-set architectures (ISA) like MIPS or RISC, LEAP adapts to user needs dynamically, by leveraging application or task specific agents.
2. Natural Interaction: It moves away from command-line interfaces or structured programming to natural language interactions.
3. Contextual Understanding: Unlike the load/store/execute model, LEAP incorporates
4. Continuous Learning: The feedback loop enables ongoing improvement, contrasting with static traditional models.
5. Task-Centric: While ETL focuses on data movement and transformation, LEAP is centered around completing user-defined tasks.
6. Abstraction: LEAP abstracts away low-level computational details, focusing on high-level problem-solving.
7. Improved Performance: The techniques used in the LEAP model lead to improvements in speed, accuracy, capability and automation.

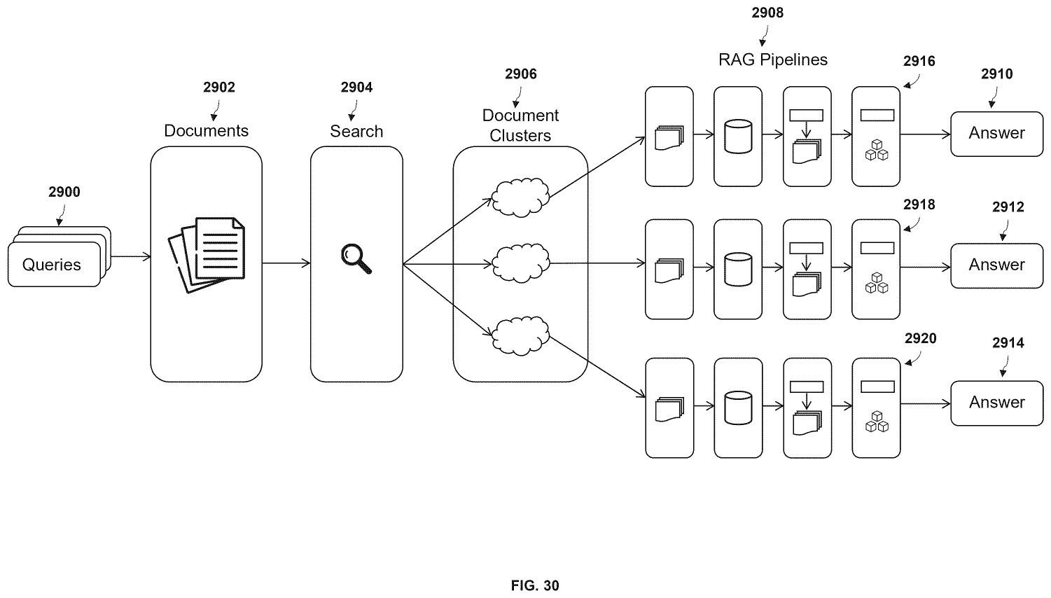

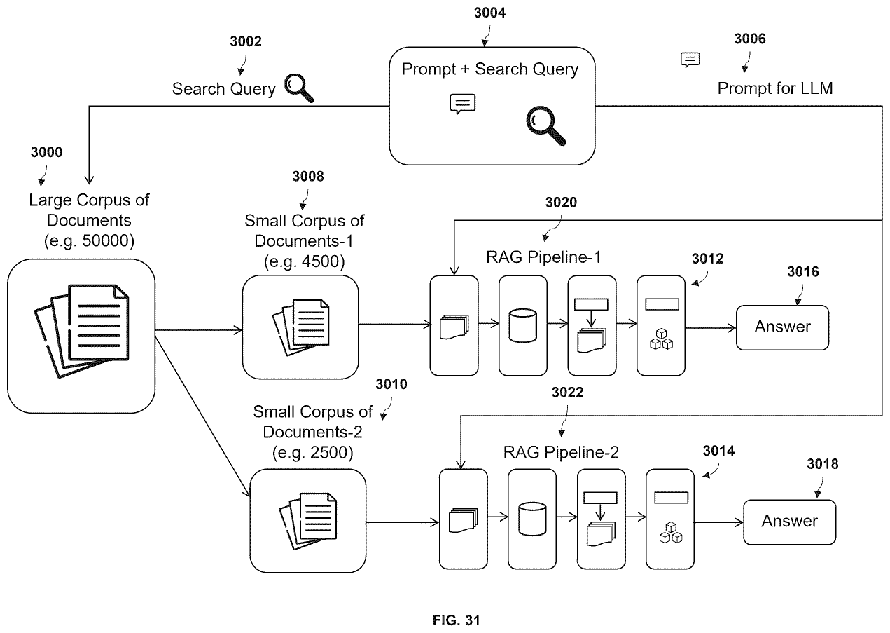

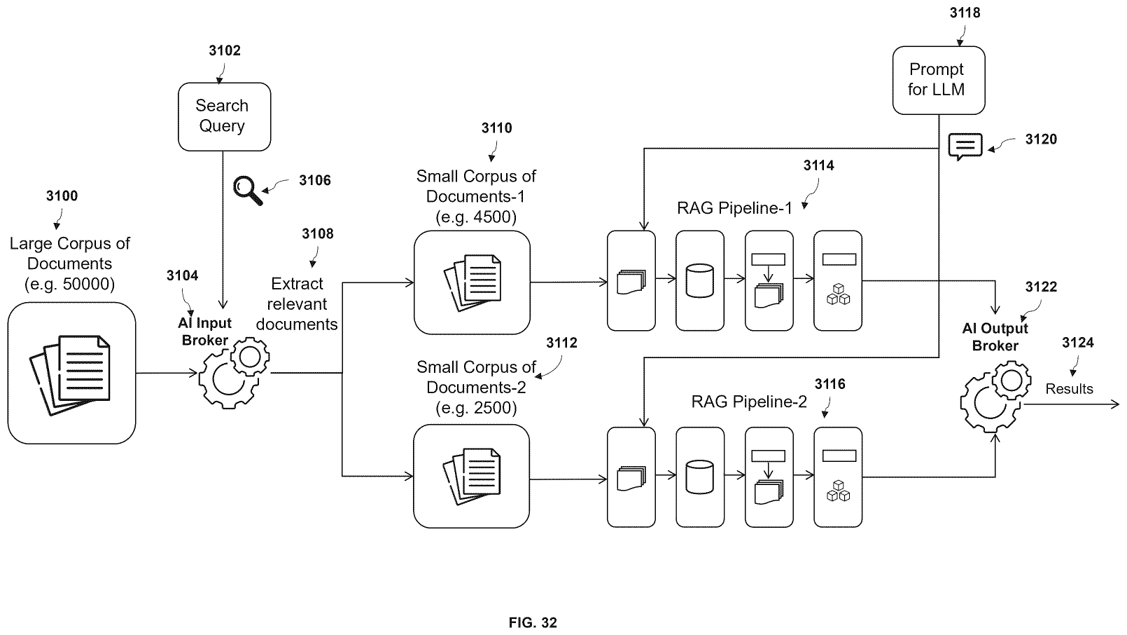

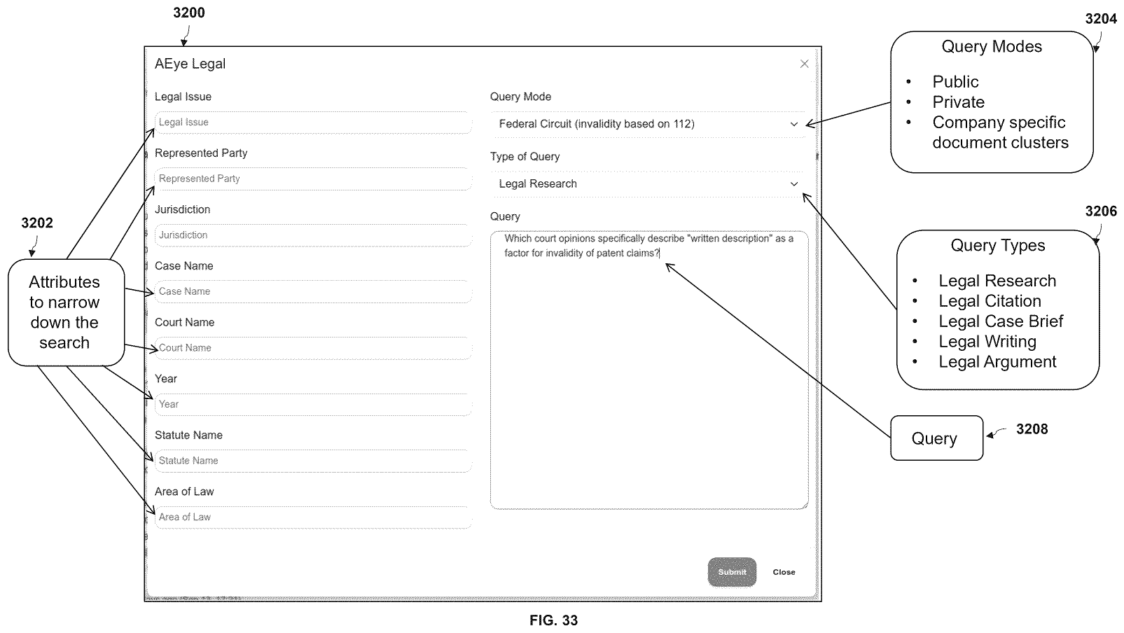

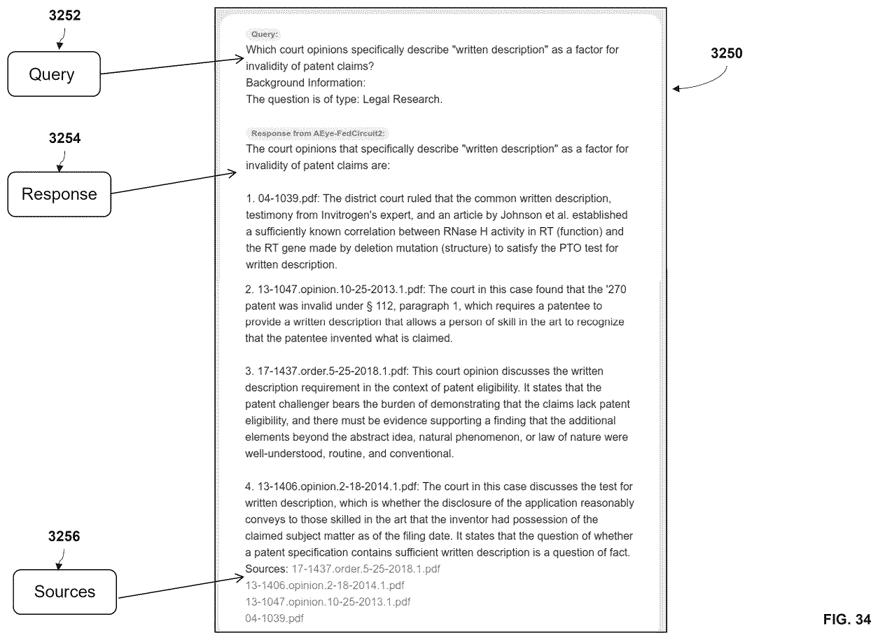

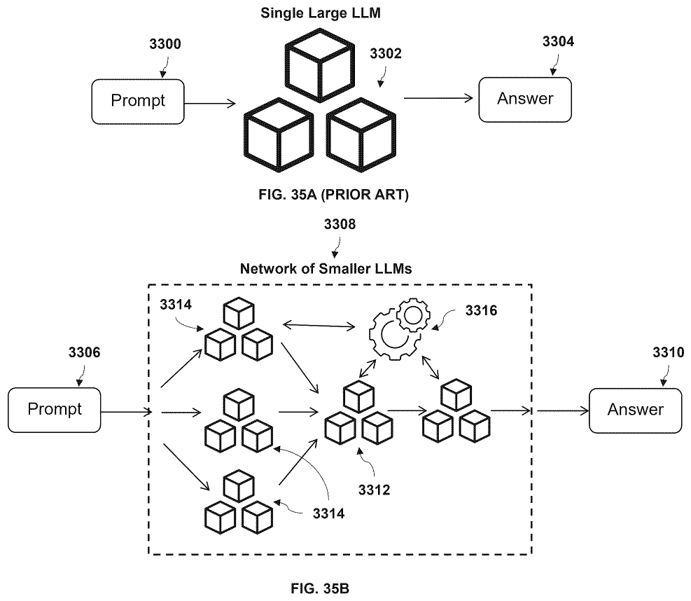

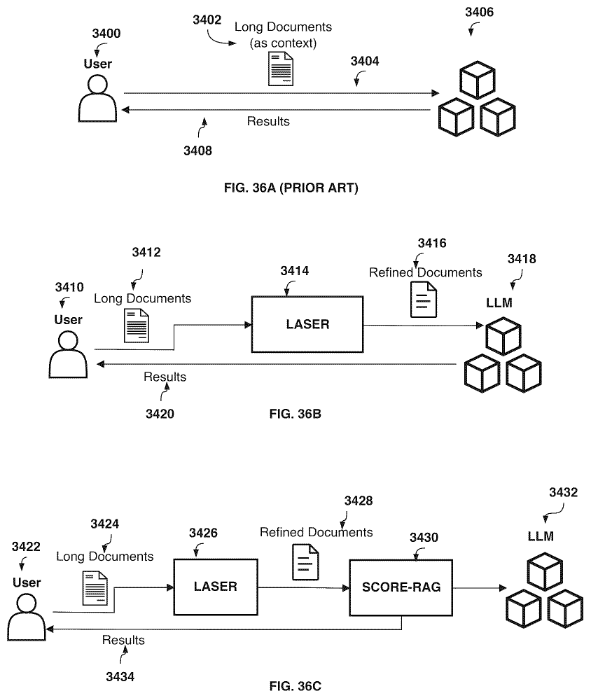

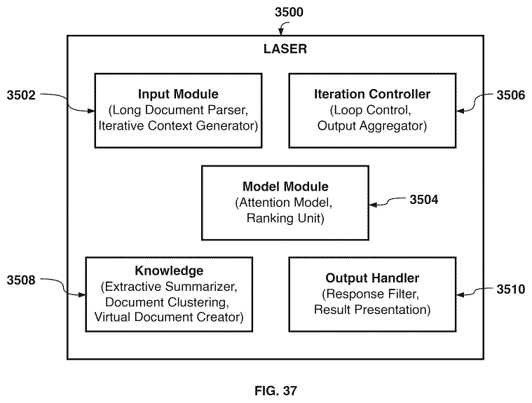

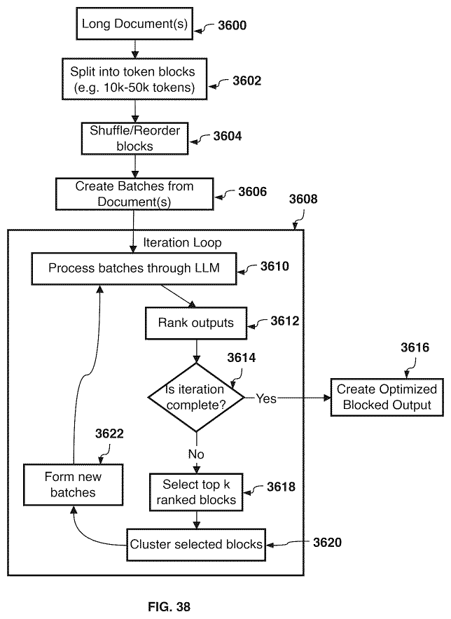

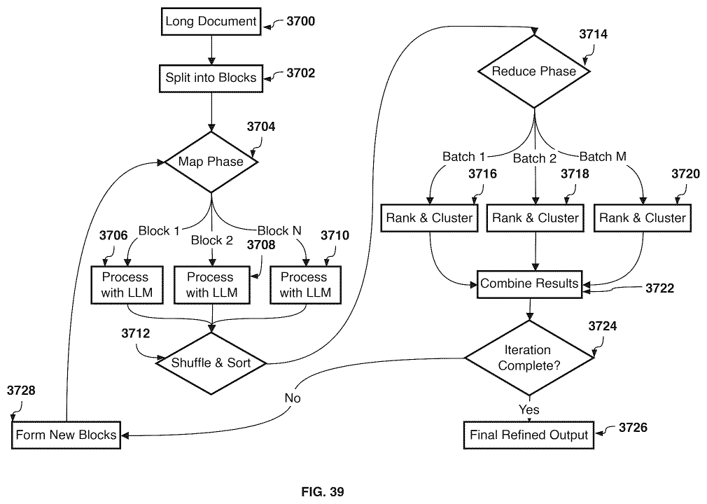

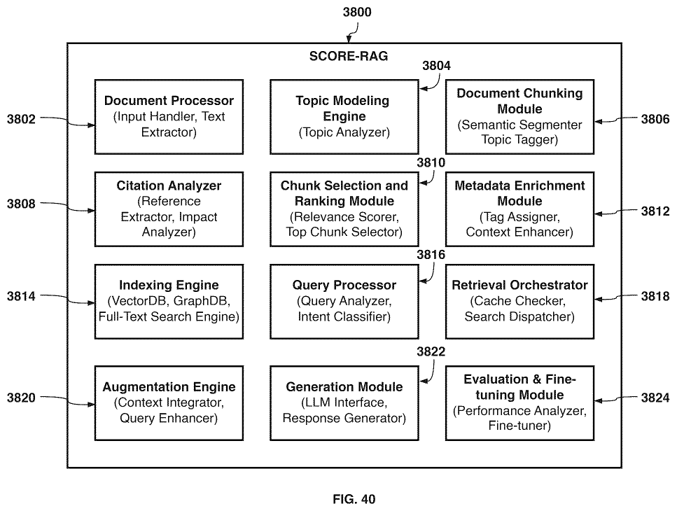

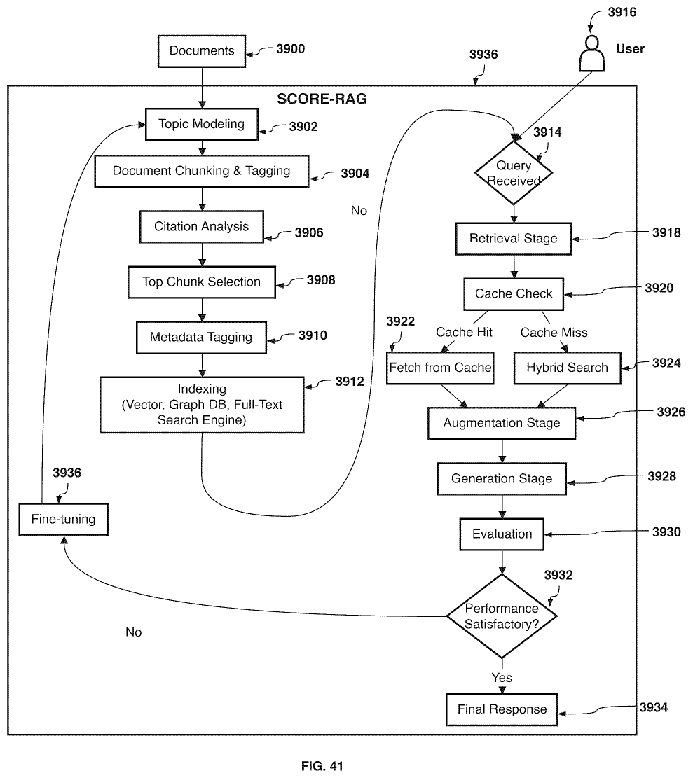

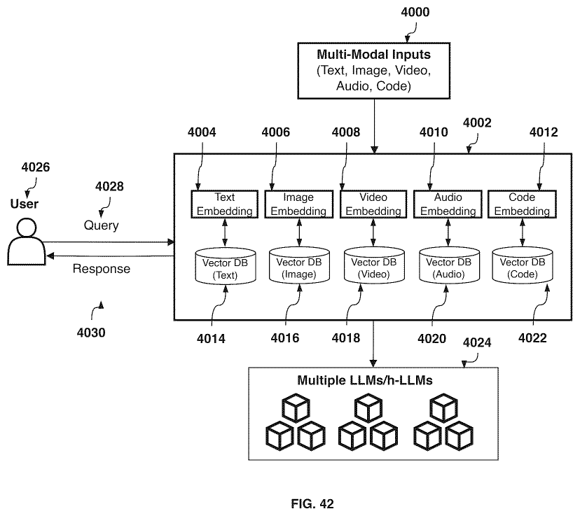

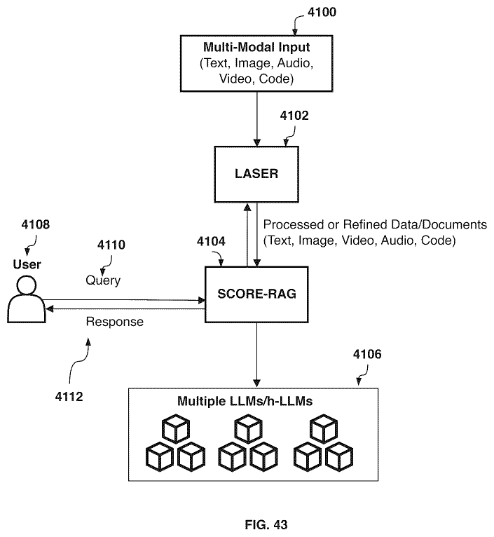

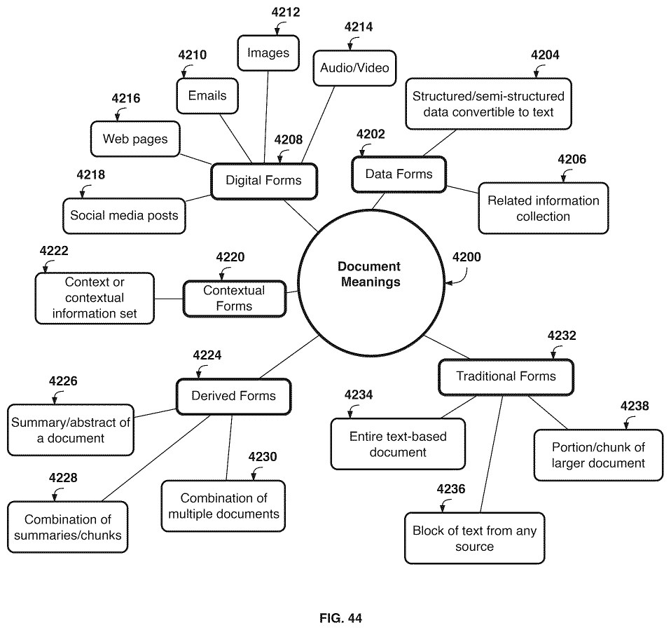

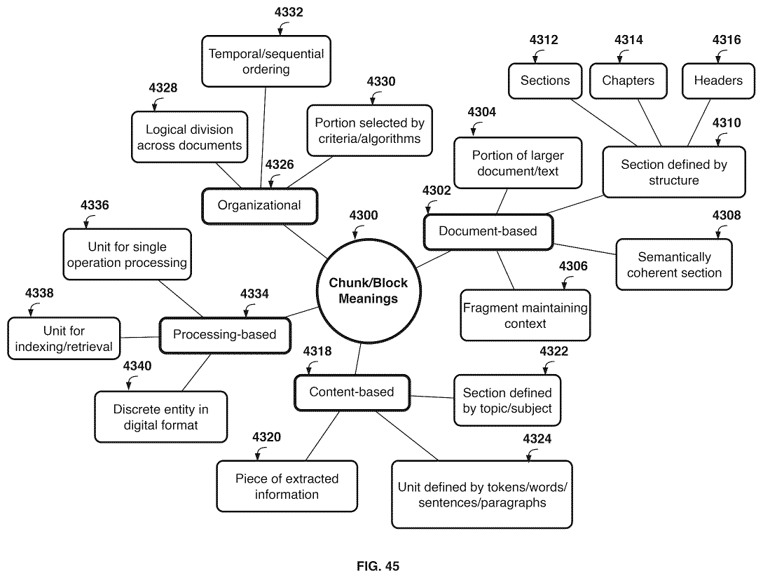

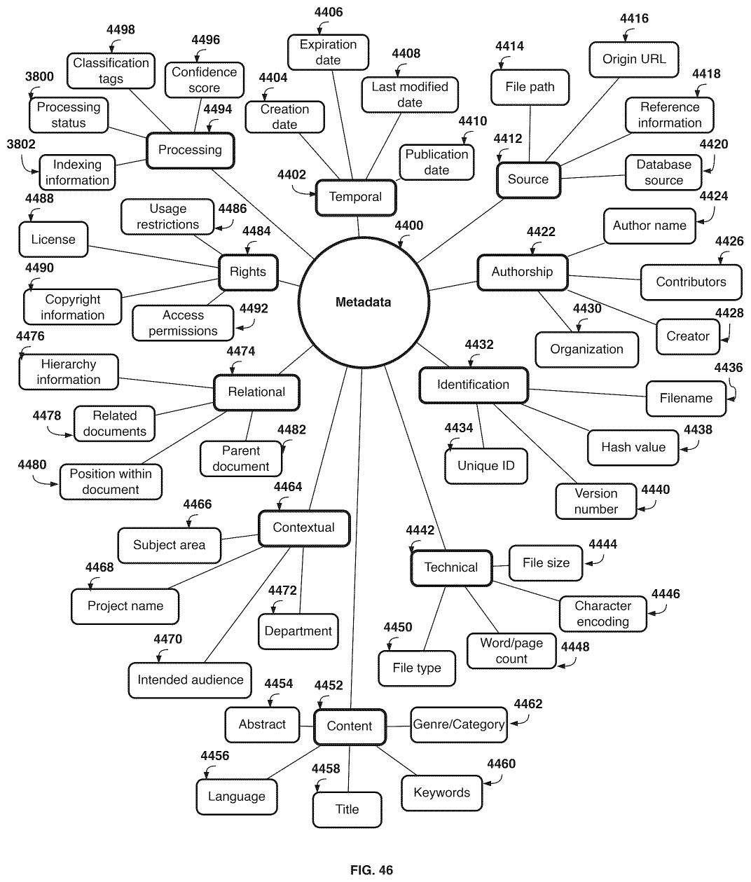

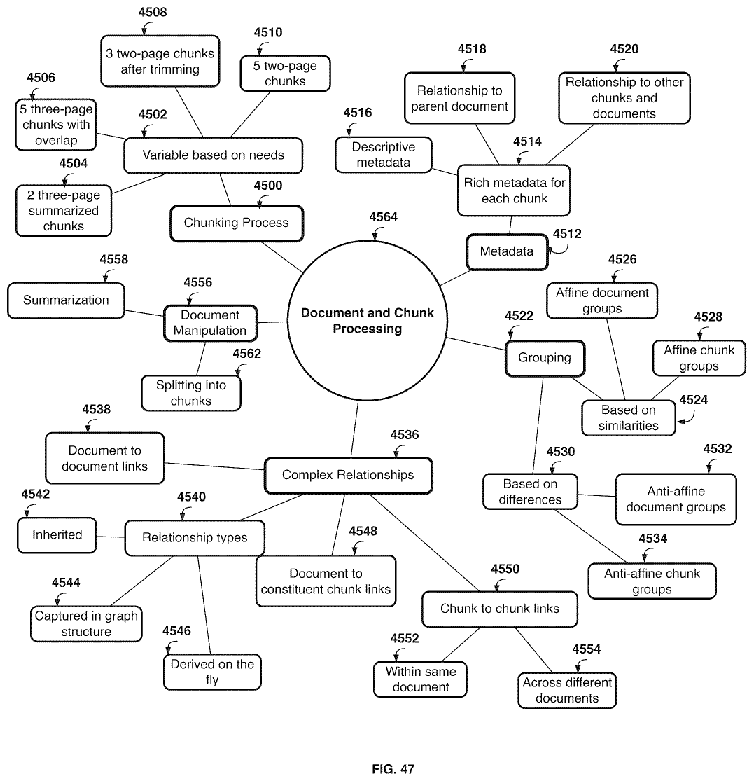

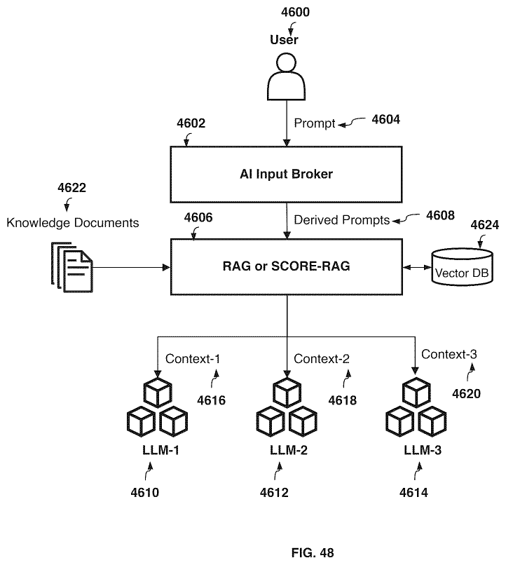

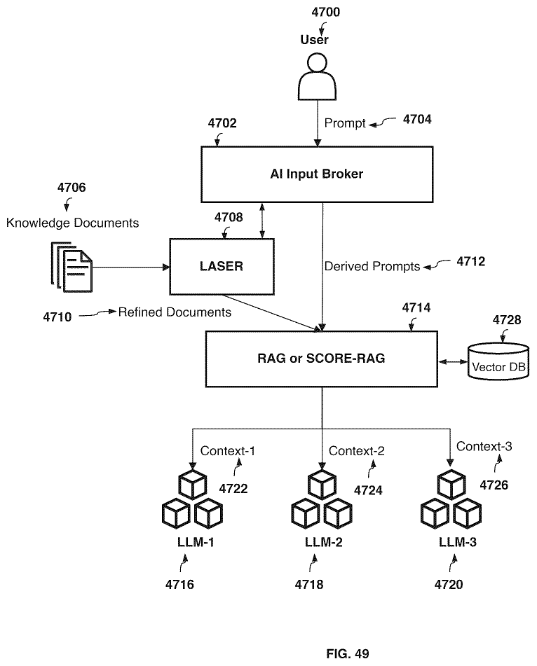

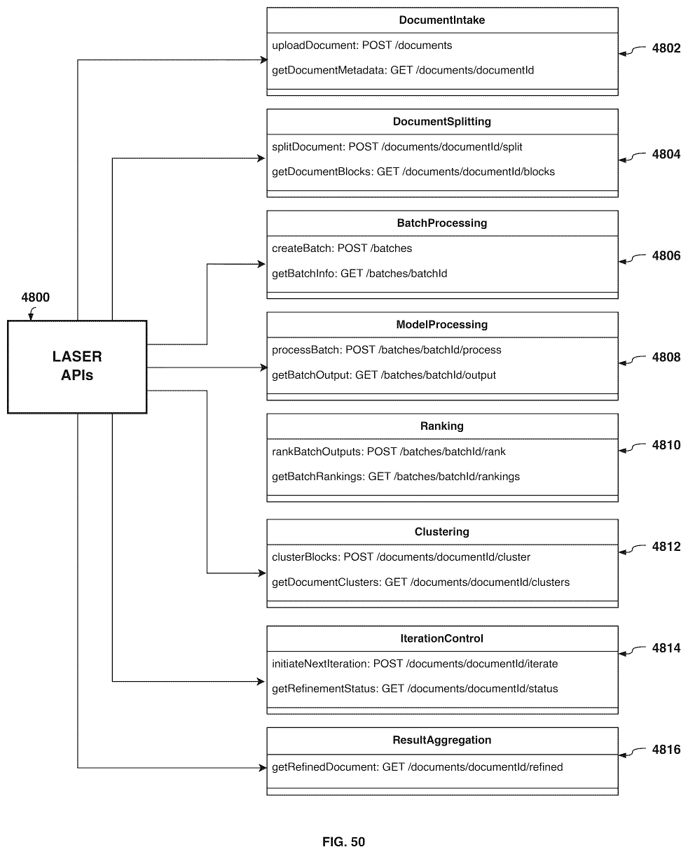

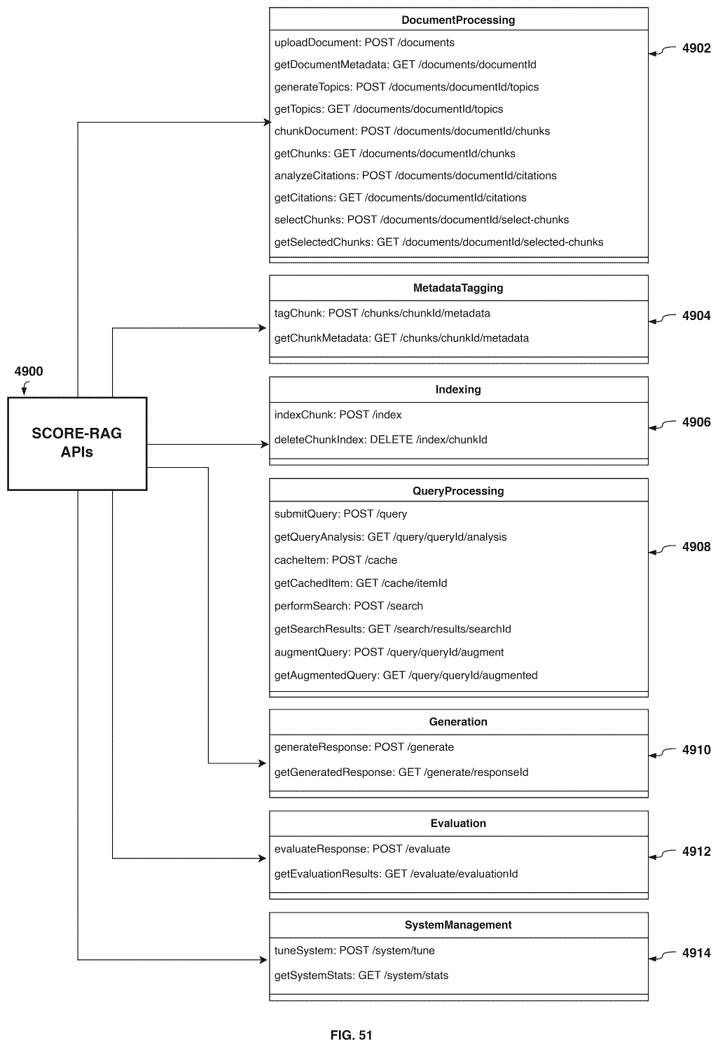

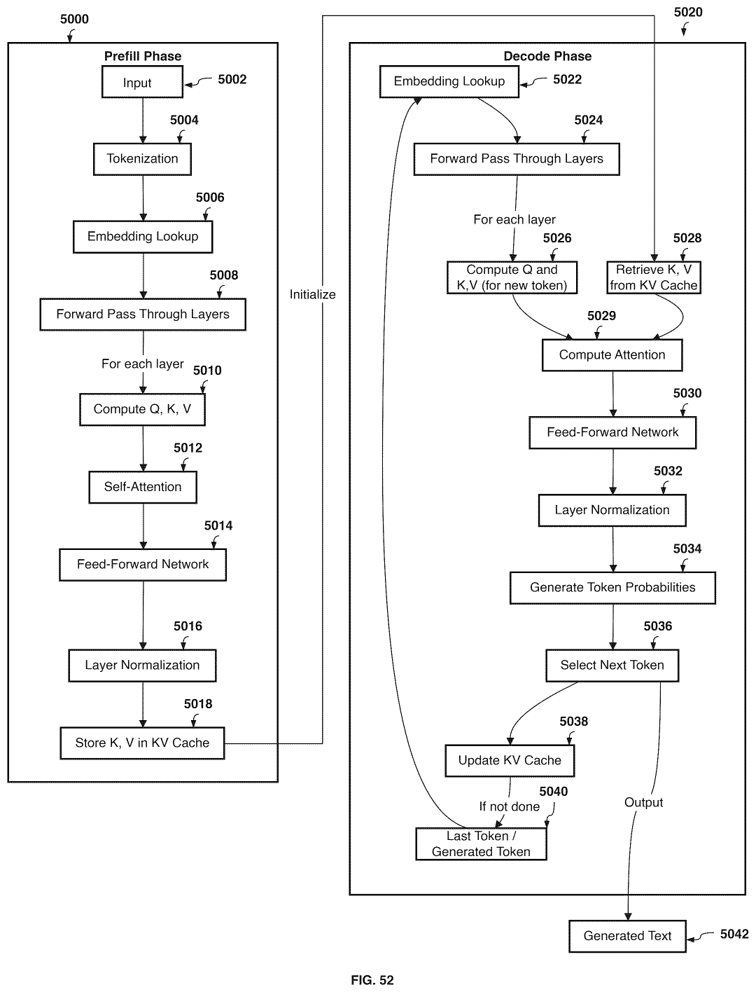

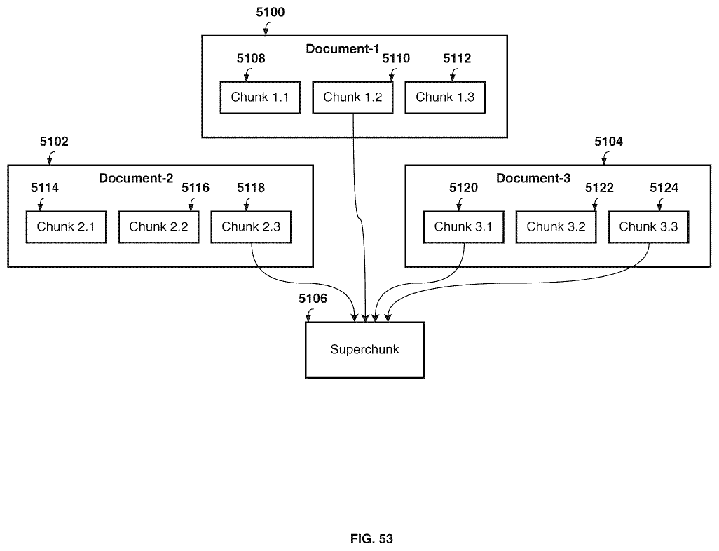

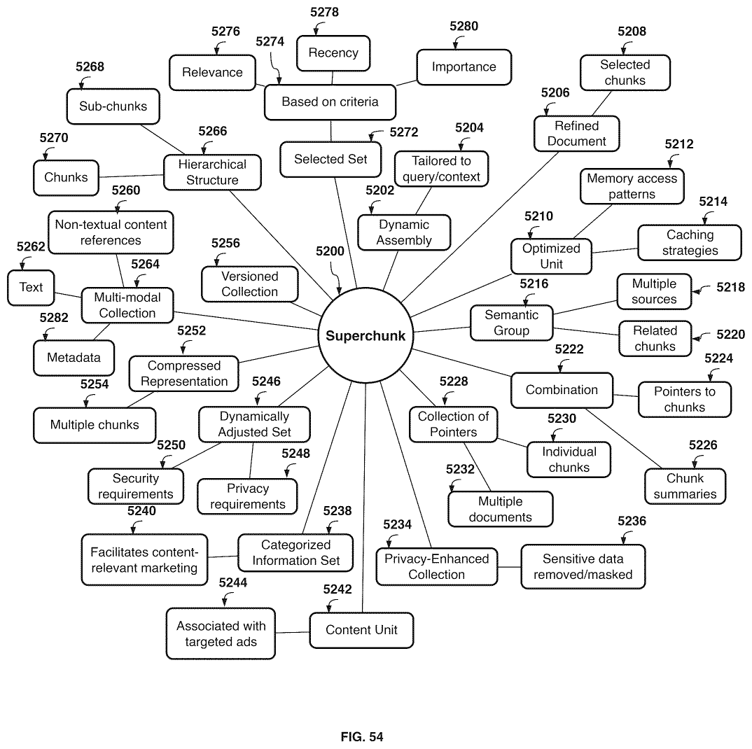

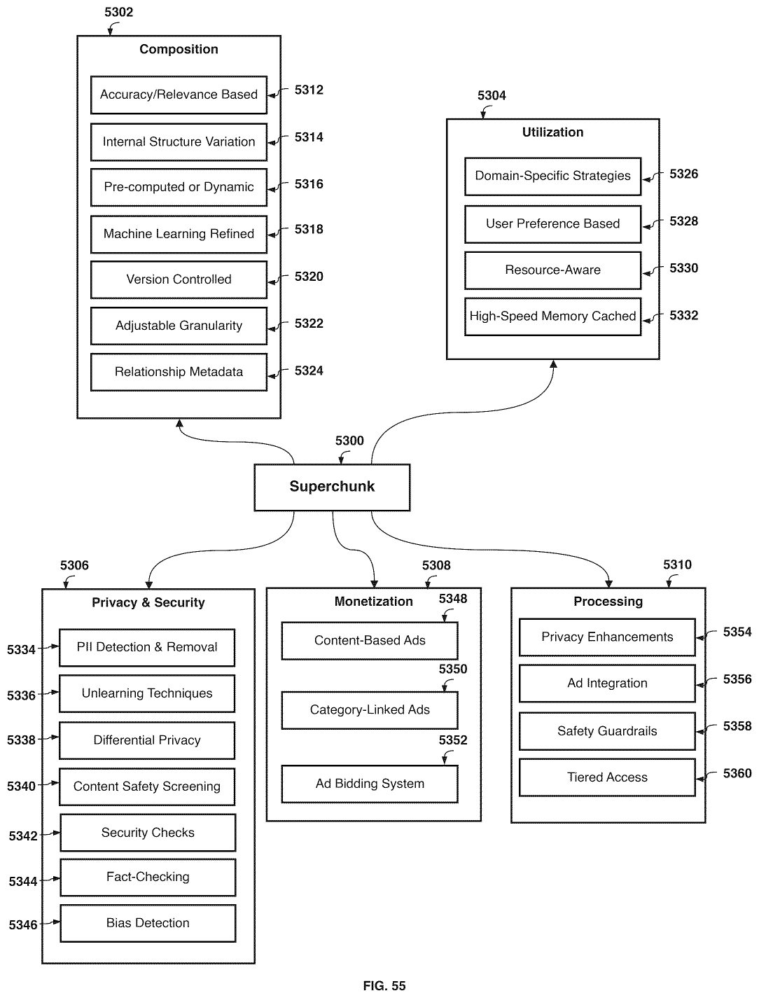

The Language Adaptive AI Processing (LEAP) model described herein encompasses various implementations and configurations. The steps outlined in FIG. 30 may be executed in different orders, combined, or further subdivided based on specific applications or implementations. The acquisition, generation, or utilization of data, context, tools, or instructions may occur at any point within the LEAP processing pipeline, including but not limited to the initial stages, during agent task assignment, or as part of iterative processing loops. Context, as referenced in this specification, should be interpreted broadly to include, but not be limited to, data from databases, real-time data feeds, tools for data retrieval or manipulation, instructions for task execution, or any other information or resources that contribute to task comprehension and execution. The flexible nature of LEAP allows for dynamic adaptation of its processes based on the requirements of each unique task or query, and the specific implementation should not be limited to a fixed sequence of operations.

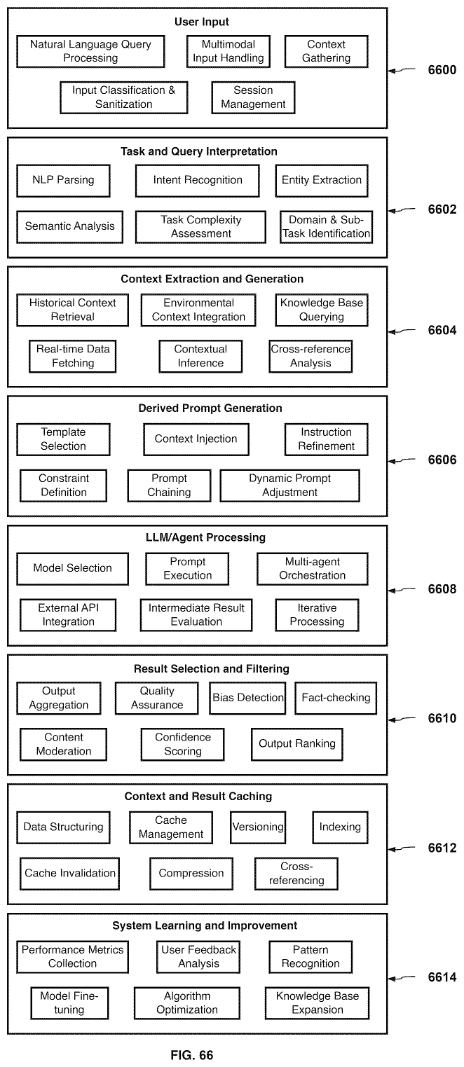

Referring now to FIG. 66, an illustration of the tasks/processes involved at each step of the LEAP model, is described in more detail. The list of tasks/processed for each step of the LEAP model includes:
1. User Input 6600:
   a) Natural Language Query Processing: Accept and parse user input in natural language form;
   b) Multimodal Input Handling: Process various input types (text, voice, images, video);
   c) Context Gathering: Collect relevant contextual information from user history, environment, or explicit user input;
   d) Input Classification & Sanitization: Categorize the type of input or task for appropriate routing. Clean and standardize input to prevent errors or security issues; and
   e) Session Management: Verify user identity and permissions if required. Maintain user session data for continuity in multi-session interactions.
2. Task and Query Interpretation 6602:
   a) NLP Parsing: Break down the input into analyzable components (tokens, phrases, sentences);
   b) Intent Recognition: Identify the user's primary goal or intent behind the query or task;
   c) Entity Extraction: Identify and categorize key entities, concepts, and parameters in the input;
   d) Semantic Analysis: Understand the meaning, relationships, and implications in the input;
   e) Task Complexity Assessment: Evaluate the complexity and scope of the requested task; and
   f) Domain & Subtask Identification: Determine the relevant domain(s) for the task or query; break down complex queries into component subtasks if necessary;
3. Context Extraction and Generation 6604:
   a) Historical Context Retrieval: Access and incorporate relevant past interactions or tasks;
   b) Environmental Context Integration: Incorporate time, location, device type, user profile, and other information;
   c) Knowledge Base Querying: Access relevant information from internal or external knowledge bases;
   d) Real-time Data Fetching: Retrieve up-to-date information from APIs or databases as needed;
   e) Contextual Inference: Generate additional context based on available information; integrations with external tools, APIs, data providers and brokers allows enhancing the context information; and
   f) Cross-reference Analysis: Identify connections between the current task and related information;
4. Derived Prompt Generation 6606:
   a) Template Selection: Choose or create appropriate base prompts for the task;
   b) Context Injection: Integrate relevant context into the prompt structure;
   c) Instruction Refinement: Optimize instructions for clarity, specificity, and effectiveness;
   d) Constraint Definition: Set boundaries and limitations for the output in the prompt;
   e) Prompt Chaining: Create sequences of prompts for multi-step tasks; and
   f) Dynamic Prompt Adjustment: Modify prompts based on intermediate results or feedback;
5. LLM/Agent Processing 6608:
   a) Model Selection: Choose appropriate LLM(s), agent(s), and/or broker(s) for the task(s) or derived task(s);
   b) Prompt Execution: Submit derived prompts to the selected LLM(s), agent(s), and/or broker(s);
   c) Multi-agent Orchestration: Coordinate multiple AI agents for complex tasks;
   d) External API Integration: Interface with external services or tools as needed;
   e) Compute Resource Allocation: Manage and optimize computational resources;
   f) Intermediate Result Evaluation: Assess outputs at various stages of processing; and
   g) Iterative Processing: Conduct multiple rounds of processing if required;
6. Result Selection and Filtering 6610:
   a) Output Aggregation: Compile and organize results from various processing steps;
   b) Quality Assurance: Check output for accuracy, relevance, coherence, and safety;
   c) Bias Detection: Identify and mitigate potential biases in the output;
   d) Fact-checking: Verify factual claims against reliable sources;
   e) Content Moderation: Filter out inappropriate or harmful content;
   f) Confidence Scoring: Assign confidence levels to different parts of the output; and
   g) Output Ranking: Prioritize multiple results based on relevance and quality;
7. Context and Result Caching 6612:
   a) Data Structuring: Organize context and results in efficient data structures;
   b) Cache Management: Implement and maintain caching mechanisms for quick retrieval;
   c) Versioning: Track different versions of context and results over time;
   d) Indexing: Create indexes for fast searching and retrieval of cached data;
   e) Cache Invalidation: Determine when cached data should be updated or removed;
   f) Compression: Optimize storage of cached data to save space; and
   g) Cross-referencing: Link related cached items for comprehensive retrieval;
8. System Learning and Improvement 6614:
   a) Performance Metrics Collection: Gather data on system performance and user satisfaction;
   b) User Feedback Analysis: Process and learn from explicit and implicit user feedback;
   c) Pattern Recognition: Identify recurring patterns in tasks, contexts, and results;
   d) Model Fine-tuning: Adjust language models based on accumulated data and feedback;
   e) Algorithm Optimization: Improve task interpretation and context extraction algorithms; and
   f) Knowledge Base Expansion: Update and expand internal knowledge bases with new information.

Additional tasks, such as advertisement generation based on elicitation of attitudes, behavior, contextual history of purchases or queries, and derivation of intentions of the user by the LLMs can be used to provide a context for monetization of these AI agents.

The tasks, processes, and steps described in herein for the Language Adaptive AI Processing (LEAP) model are provided as exemplary and non-limiting illustrations. It should be understood that these examples are not exhaustive, and additional tasks or processes may be implemented at each step of the LEAP model. The specific tasks performed, their ordering, and their implementation may vary depending on the particular embodiment, application, or use case of the LEAP model.

Furthermore, the ordering of the steps and tasks presented in this specification is not fixed and may be altered, combined, subdivided, or rearranged in different embodiments or variations of the LEAP model. Some steps or tasks may be performed concurrently, iteratively, or in a different sequence than presented here. Certain steps or tasks may be omitted in some implementations, while additional steps or tasks not explicitly mentioned may be incorporated in others. The flexibility of the LEAP model allows for dynamic adaptation to various contexts, requirements, and technological advancements. As such, the scope of this present invention is not limited to the specific examples, orderings, or implementations described, but encompasses all variations and modifications that fall within the domain of the LEAP model. Additional details regarding these features may be found in U.S. patent application Ser. No. 18/812,707 which is incorporated by reference hereinabove.

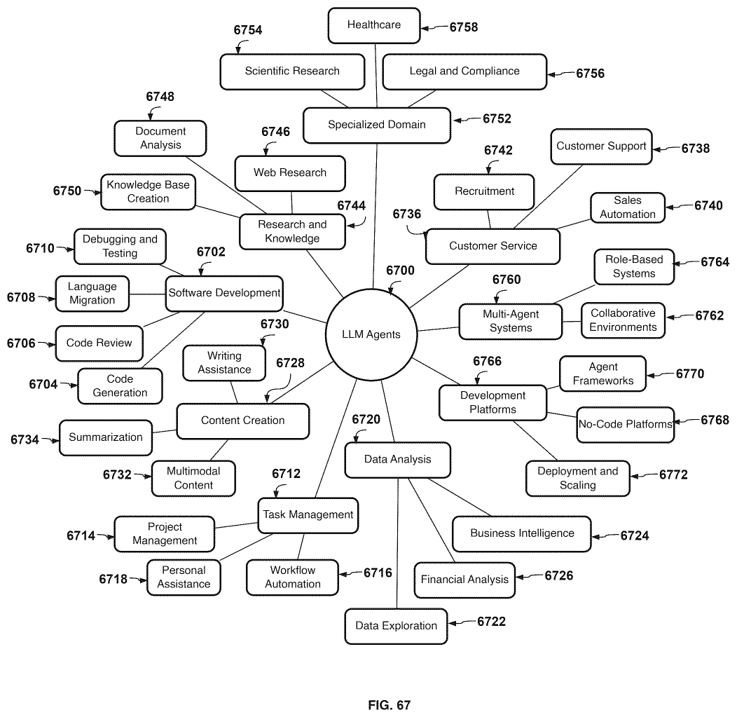

Referring now to FIG. 67, an illustration of types of LLM and AI Agents, and Agent Frameworks is described in more detail. LLM Agents are AI-powered systems that can perform a wide range of tasks autonomously or semi-autonomously. These agents leverage the capabilities of LLMs to understand and generate human-like text, enabling them to interact with users, process information, and complete various actions. The following categories describe different types of LLM Agents:
1. Software Development Agents 6702: These agents assist in various aspects of software development:
   a) Code Generation 6704: Agents that can generate entire codebases or specific functions based on natural language prompts;
   b) Code Review and Improvement 6706: Agents capable of reviewing code, suggesting improvements, and even creating pull requests;
   c) Language and Framework Migration 6708: Agents that can assist in migrating codebases between different programming languages or frameworks; and
   d) Debugging and Testing 6710: Agents designed to identify and fix bugs, as well as generate and run tests;
2. Task Management and Workflow Automation Agents 6712: These agents help organize and execute tasks:
   a) Project Management 6714: Agents that can manage and prioritize tasks within a project context;
   b) Workflow Automation 6716: Agents capable of automating complex workflows and business processes; and
   c) Personal Assistance 6718: Agents that can help with daily tasks, note-taking, and personal organization.
3. Data Analysis and Business Intelligence Agents 6720: These agents specialize in processing and analyzing data:
   a) Data Exploration 6722: Agents that can explore and analyze datasets, generate insights, and visualize results;
   b) Business Intelligence 6724: Agents capable of providing business insights and performing market analysis; and
   c) Financial Analysis 6726: Agents that can assist with financial modeling and analysis;
4. Content Creation and Management Agents 6728: These agents help create, edit, and manage various types of content:
   a) Writing Assistance 6730: Agents that can generate written content for various purposes, such as marketing or documentation;
   b) Multimodal Content Creation 6732: Agents capable of creating or manipulating images, audio, or video alongside text; and
   c) Content Summarization and Organization 6734: Agents that can summarize content and create quizzes or other derivative materials;
5. Customer Service and Sales Agents 6736: These agents interact with customers or assist with sales processes:
   a) Customer Support 6738: Agents that can handle customer inquiries, provide product information, and troubleshoot issues;
   b) Sales Automation 6740: Agents capable of assisting with lead generation, follow-ups, and sales processes; and
   c) Recruitment 6742: Agents that can assist with various aspects of the recruiting process;
6. Research and Knowledge Management Agents 6744: These agents help gather, organize, and synthesize information:
   a) Web Research 6746: Agents capable of searching the internet for information on specific topics;
   b) Document Analysis 6748: Agents that can analyze and extract information from large document collections; and
   c) Knowledge Base Creation 6750: Agents that can help create and maintain knowledge bases or wikis for organizations;
7. Specialized Domain Agents 6752: These agents focus on specific industries or domains;
   a) Scientific Research 6754: Agents that specialize in domain-specific tasks and research, such as chemistry or biology;
   b) Legal and Compliance 6756: Agents that can assist with legal research, contract analysis, and compliance checks; and
   c) Healthcare 6758: Agents capable of helping with medical research, patient data analysis, and treatment recommendations;
8. Multi-Agent Systems 6760: These are frameworks or platforms that allow multiple agents to work together:
   a) Collaborative Environments 6762: Systems that enable multiple agents to interact and solve problems collectively; and
   b) Role-Based Systems 6764: Frameworks that allow for the creation of teams of agents with specific roles and responsibilities;
9. Development and Deployment Platforms 6766: These are tools and platforms for creating, managing, and deploying LLM Agents:
   a) No-Code Platforms 6768: Systems that allow users to create and deploy agents without programming knowledge;
   b) Agent Frameworks 6770: Tools that provide developers with frameworks for building custom agents; and
   c) Deployment and Scaling 6772: Platforms that help deploy and scale agent applications in production environments.

The above categorization and description of LLM and Generative AI Agents is provided for illustrative purposes only and is not intended to be exhaustive or limiting in nature. The present invention encompasses these described types of agents as well as other types of agents not explicitly mentioned herein. The categorization is exemplary, and it is understood that agents may fall into multiple categories, combine features from different categories, or represent entirely new categories not described below. The scope of the present invention includes any and all types of LLM and Generative AI Agents that utilize AI models to perform tasks autonomously or semi-autonomously.

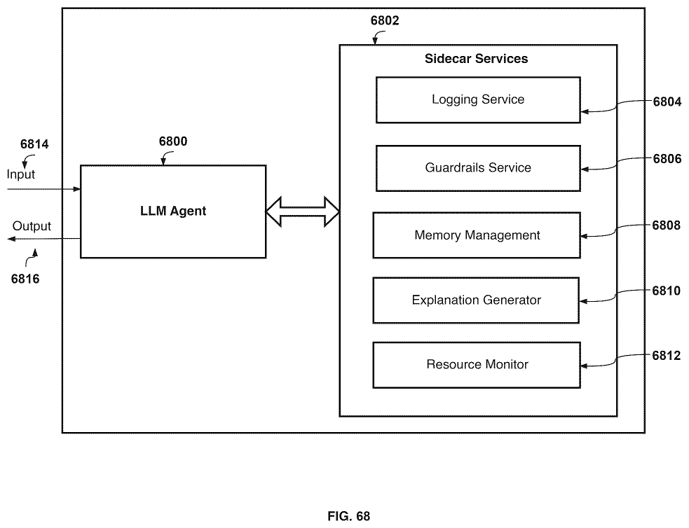

Referring now to FIG. 68, an illustration of a sidecar pattern for agents according to an embodiment of the invention is described in more detail. The sidecar pattern provides a method for attaching auxiliary services to a main LLM agent without modifying its core logic. The main LLM agent 6800 is surrounded by multiple sidecar services 6802, including but not limited to a logging service 6804, a guardrails service 6806, a memory management service 6808, an explanation generator service 6810, and a resource monitor service 6812. The logging service 6804 tracks at least some and/or of interactions, decisions, and internal states of the agent, providing a comprehensive audit trail of the agent's operations. The guardrails service 6806 enforces ethical constraints and safety measures on the agent's actions, ensuring that the agent operates within predefined boundaries. The memory management service 6808 handles short-term and long-term memory storage and retrieval for the agent, enabling more consistent and context-aware responses over extended interactions. The explanation generator service 6810 provides human-readable explanations for the agent's decisions, enhancing transparency and interpretability of the agent's actions. The resource monitor 6812 tracks and optimizes resource usage, including API calls and compute resources, ensuring efficient operation of the agent. External input 6814 flows into the LLM agent, and external output 6816 flows out, with all sidecar services 6802 potentially influencing or monitoring this flow. The sidecar services 6802 may operate in its own container within a pod that it shares with an agent or broker's container.

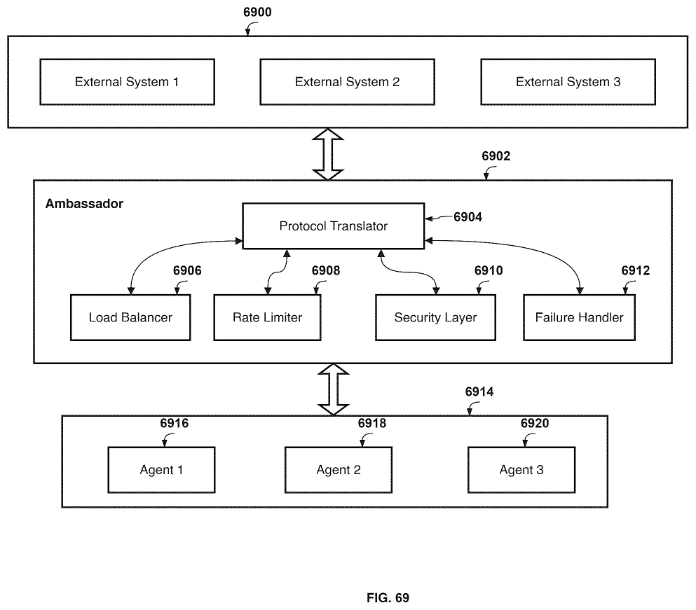

Referring now to FIG. 69, an illustration of an ambassador pattern for agent communication according to an embodiment of the invention is described in more detail. The ambassador pattern provides a method for managing communication between agents and external systems. An ambassador component 6902 acts as an intermediary between external systems 6900 and an agent cluster 6914. The ambassador pattern comprises a protocol translator 6904, which handles the conversion of various communication protocols between external systems and agents. Connected to the protocol translator 6904 are four services: a load balancer 6906, a rate limiter 6908, a security layer 6910, and a failure handler 6912. The load balancer 6906 distributes incoming requests across multiple agents in the cluster, ensuring efficient utilization of resources. The rate limiter 6908 prevents overwhelming of individual agents or external services by controlling the rate of requests. The security layer 6910 implements authentication and authorization mechanisms, ensuring secure communication between external systems and agents. The failure handler 6912 implements retry logic and fallback mechanisms for failed agent responses, enhancing the overall reliability of the system.

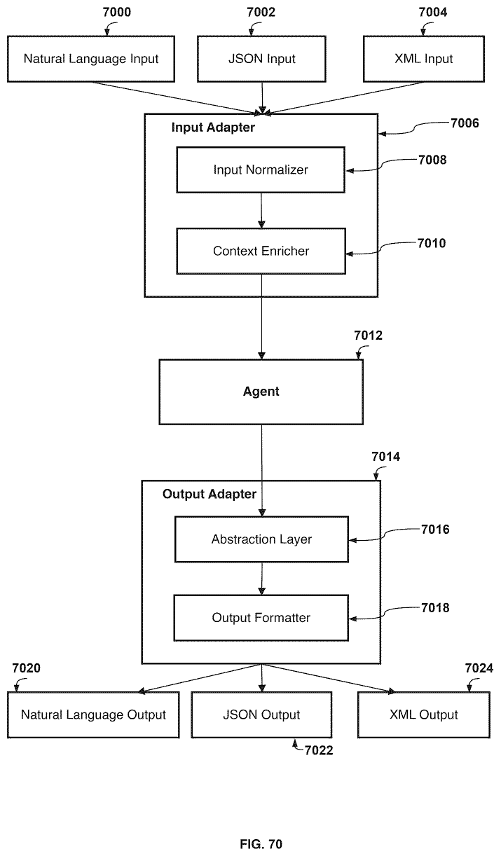

Referring now to FIG. 70, an illustration of an adapter pattern for input/output transformation according to an embodiment of the invention is described in more detail. The adapter pattern provides a method for standardizing inputs to and outputs from an LLM Agent. The adapter pattern comprises an input adapter 7006, an output adapter 7014, and an agent 7012. The input adapter 7006 comprises, and in some embodiments consists of, an input normalizer 7008 and a context enricher 7010. The input normalizer 7008 standardizes various input formats 7000, 7002, 7004 (e.g., natural language, JavaScript Object Notation (JSON), and/or extensible markup language (XML)) into a consistent structure for the agent. The context enricher 7010 augments the normalized input with additional context before passing it to the agent. The output adapter 7014 comprises, and in some embodiments consists of, an abstraction layer 7016 and an output formatter 7018. The abstraction layer 7016 simplifies complex agent outputs and the output formatter 7018 transforms the abstracted output into required formats for external consumption, for example natural language output 7020, JSON output 7022, and/or XML output 7024. This arrangement facilitates the agent 7012 operating on a standardized input format and produce a standardized output, regardless of the varying requirements of different external systems.

The sidecar, ambassador, and adapter patterns described above offer several advantages for LLM agents and agentic applications:
1. Modularity: Each pattern allows for the addition or modification of functionality without altering the core agent logic.
2. Scalability: The patterns facilitate easy scaling of agent systems to handle increased load or complexity.
3. Maintainability: By separating concerns, these patterns make it easier to update, debug, and maintain different aspects of the agent system independently.
4. Flexibility: The patterns allow for easy adaptation to different use cases and integration with various external systems.
5. Reliability: Through features like load balancing and failure handling, these patterns enhance the overall reliability of agent systems.

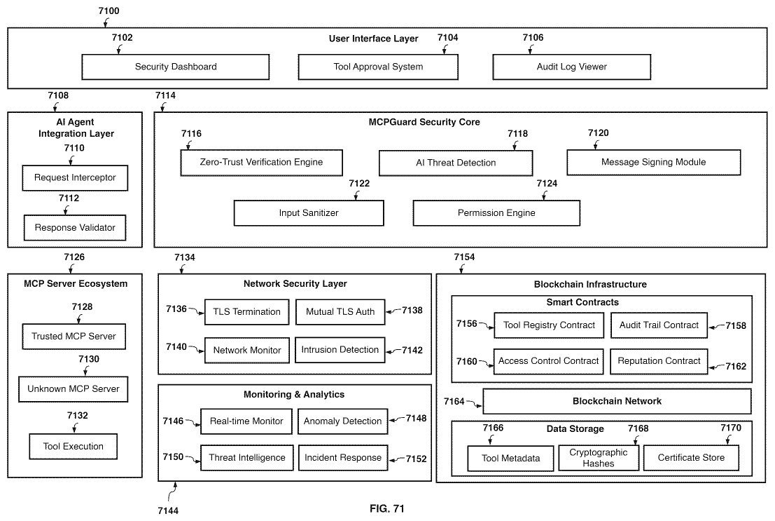

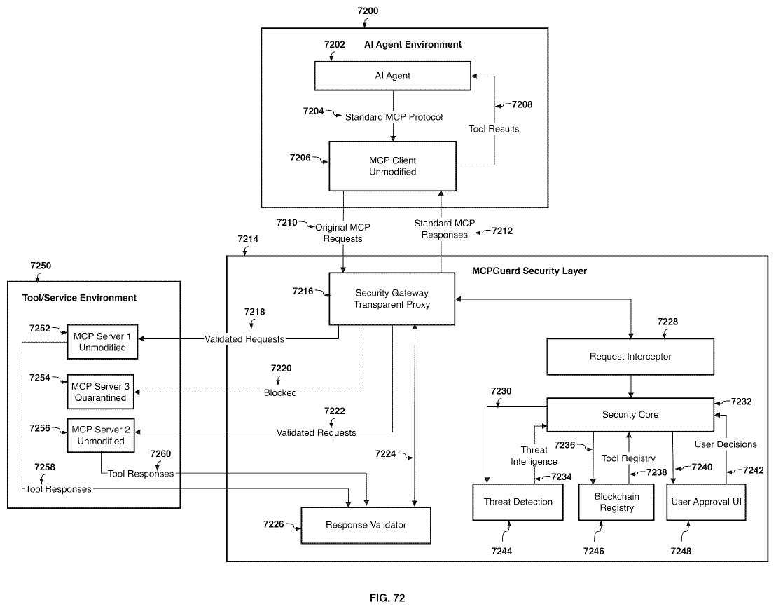

Referring now to FIG. 71, an illustration of an architecture for inter-process communication (IPC), is described in more detail. The architecture comprises a plurality of interconnected layers configured to provide comprehensive security for IPCs between AI agents and external tool servers. Such communications may comply with one or more communication standards or protocols as are known in the art, including, but not limited to, Model Context Protocol™ (MCP), Unified Intent Mediator (UIM) Protocol, OpenAI™ Work with Apps, and the like. While the following embodiments may refer specifically to MCP, it is contemplated and included within the scope of the invention that any IPC standard or protocol as is known in the art may be employed by other embodiments of the invention.

A first layer is a User Interface Layer 7100 including one or more of, and in some embodiments consisting of, three components: a Security Dashboard module 7102 configured to provide real-time visualization of security metrics and threat intelligence; a Tool Approval System 7104 configured to enable human-in-the-loop authorization for tool registration and sensitive operations; and an Audit Log Viewer module 7106 configured to provide access to immutable audit trails and compliance reporting.

A second layer is an AI Agent Integration Layer 7108 including one or more of, and in some embodiments consisting of, a Request Interceptor module 7110 configured to capture and analyze outgoing requests from AI agents, and a Response Validator module 7112 configured to validate and sanitize responses from MCP servers before delivery to AI agents.

A third layer is a Security Core Layer 7114 including one or more of, and in some embodiments consisting of, several functional modules: a Zero-Trust Verification Engine 7116 configured to implement continuous verification of all entities and communications; an AI Threat Detection module 7118 configured to employ one or more machine learning algorithms for identifying sophisticated attack patterns; a Message Signing module 7120 configured to ensure cryptographic integrity and authenticity of all communications; an Input Sanitizer module 7122 configured to detect and neutralize malicious input including Unicode-based attacks; and a Permission Engine 7124 configured to implement granular, context-aware access control mechanisms.

A fourth layer is a Blockchain Infrastructure Layer 7154 including one or more of, and in some embodiments consisting of, a plurality of smart contracts including: a Tool Registry Contract 7156 configured to maintain an immutable registry of approved tools with cryptographic verification; an Access Control Contract 7160 configured to implement decentralized permission management; an Audit Trail Contract 7158 configured to store tamper-proof security event logs; and a Reputation Contract 7162 configured to maintain reputation scores for ecosystem entities.

The Blockchain Infrastructure Layer 7154 may further comprise a Blockchain Network 7164 providing the underlying distributed ledger technology and data storage components including storage for Tool Metadata 7166, Cryptographic Hashes 7168, and Certificate Store 7170 configured to maintain security-related information and cryptographic materials. It is contemplated and included within the scope of the invention that the entire Blockchain Network 7164 will not be comprises by a single device, such as a sever, that instantiates the various other layers described and shown in FIG. 71, but that a node or wallet operable to interact with the Blockchain Network 7164 may be operated or instantiated on such a server or device that is interoperable with the server, and other similar arrangements.

A fifth layer is a Network Security Layer 7134 that may include one or more of, and in some embodiments consist of, a TLS Termination module 7136 and a Mutual TLS Authentication module 7138 configured to secure communications, and a Network Monitor module 7140 and an Intrusion Detection module 7142 configured to detect network-based threats.

A sixth layer is a Monitoring and Analytics Layer 7144 including one or more of, and in some embodiments consisting of, a Real-time Monitor module 7146, an Anomaly Detection module 7148, a Threat Intelligence module 7150, and an Incident Response module, 7152, the modules of the Monitoring and Analytics Layer 71044 collectively being configured to provide continuous security monitoring and automated threat response capabilities.

A seventh layer is an external MCP Server Ecosystem 7126 comprising, and in some embodiments consisting of: a Trusted MCP Server 7128 representing verified and approved tool providers; an Unknown MCP Server 7130 representing unverified servers subject to enhanced scrutiny; and a Tool Execution environment 7132 providing isolated runtime environments for approved operations.

The architecture illustrated in FIG. 71 is exemplary in nature and should not be construed as requiring implementation of all architectural layers in every embodiment or deployment configuration. Actual MCPGuard products, implementations, or deployments may utilize any combination, subset, or reconfiguration of the described architectural layers based on specific security requirements, operational constraints, regulatory compliance needs, or technical environments. Some architectural layers may be optional, consolidated, or omitted entirely in certain implementations without departing from the scope of the present invention. For example, certain implementations may combine the User Interface Layer 7100 and AI Agent Integration Layer 7108 into a single presentation and control layer, integrate the Security Core Layer 7114 with the Network Security Layer 7134 for streamlined threat processing, or deploy the Blockchain Infrastructure Layer 7154 as an optional component for organizations requiring immutable audit capabilities but not mandating distributed ledger technology.

The modular design of the architecture of FIG. 71 enables flexible deployment configurations wherein individual layers may be implemented as standalone services, integrated components, or distributed across multiple system boundaries. Organizations may choose to implement only the Security Core Layer 7114 and Monitoring and Analytics Layer 7144 for basic threat detection and response capabilities, while omitting the Blockchain Infrastructure Layer 7154 if regulatory requirements do not mandate immutable audit trails. Alternatively, certain implementations may focus primarily on the AI Agent Integration Layer 7108 and Network Security Layer 7134 for organizations requiring transparent proxy functionality without comprehensive user interface components. Edge computing deployments may prioritize the Security Core Layer 7114 and Network Security Layer 7134 while implementing simplified versions of the User Interface Layer 7100 and Monitoring and Analytics Layer 7144 to accommodate resource constraints.

Referring now to FIG. 72, an illustration of an IPC proxy architecture is described in more detail. The architecture demonstrates a transparent security layer implementation that requires no modifications to existing MCP components.

An AI Agent Environment 7200 comprises, and in some embodiment may consist of, an AI Agent 7202 configured to generate tool requests and an MCP Client 7206 configured to communicate using standard MCP protocol. The MCP Client 7206 remains unmodified and continues normal MCP operations.

An MCPGuard Security Layer 7214 comprises, and in some embodiments consists of, a Security Gateway module 7216 functioning as a Transparent Proxy, intercepting all communications between the AI Agent Environment 7200 and Tool/Service Environment 7250. The Security Gateway module 7216 includes at least one of, and in some embodiments consists of: a Request Interceptor module 7228 configured to capture and validate outgoing requests; a Response Validator module 7226 configured to verify incoming responses; a Security Core module 7232 configured to implement the primary security logic; a Threat Detection module 7244 configured to identify malicious patterns; a Blockchain Registry 7246 providing immutable tool verification; and a User Approval UI module 7248 enabling human oversight of security decisions. User Decisions 7242 from the User Approval UI module 7248 may influence the security processing, while Tool Registry 7238 and Threat Intelligence 7234 data inform security decisions.

A Tool/Service Environment 7250 comprises, and in some embodiments consists of: first and second MCP Servers 7252, 7256 representing trusted, unmodified MCP servers that receive validated requests; and a third MCP Server 7254 representing a quarantined server that is blocked from receiving any requests.

Communication between the AI Agent Environment 7200, the MCPGuard Security Layer 7214, and the Tool/Service Environment 7250 may include any of the following steps: Original MCP requests 7210 may be transmitted from the MCP Client 7206 using a standard MCP protocol 7204; he original MCP requests 7210 may be intercepted by the Security Gateway module 7216 and validated by the request interceptor module 7228 intercepting the original MCP requests 7210 and running a security analysis by the security core module 7232, including one or more of sending a request 7230 to the threat detection module 7244 and receiving a threat intelligence assessment 7234, sending a request 7236 to the blockchain registry 7246 and receiving a tool registry response 7238 based on the tool/service associated with the request, and sending a request 7240 to the user approval UI module 7248 and receiving a user decision 7242 either approving or denying the request; Validated Requests 7218, 7220, being original MCP requests that are validated by the MCP Security Layer 7214, may be transmitted to approved servers comprised by the Tool/Service Environment, such as the first and second MCP servers 7252, 7256; Tool Responses 7258, 7260 generated by the first and second MCP servers 7252, 7256 responsive to the validated requests 7218, 7222 may be received at the MCPGuard Security Layer by the Response Validator module 7226; the Response Validator module then performs validation processing on the tool responses 7258, 7260, resulting in standard MCP responses that may be transmitted to the Security Gateway module 7216; and transmission of the standard MCP responses 7212 back to the MCP Client 7206, with Tool Results 7208 being delivered to the AI Agent 7202.

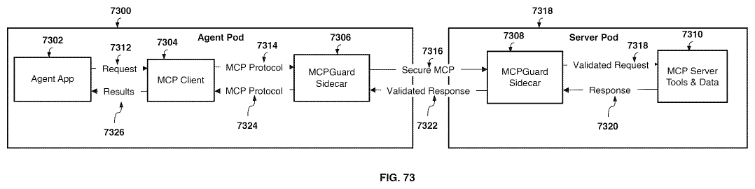

Referring now to FIG. 73, an illustration of an IPC sidecar architecture is described in more detail. The architecture implements a containerized deployment pattern suitable for Kubernetes environments, providing bidirectional security without application modifications.

An Agent Pod 7300 of the architecture may comprise, and in some embodiments consist of: an Agent App 7302 representing an AI assistant application; an MCP Client 7304 configured to handle standard MCP protocol communications and remaining unmodified; and an MCPGuard sidecar module 7306 configured as a security proxy for outgoing requests.

A Server Pod 7318 of the architecture may comprise, and in some embodiments consist of: an MCPGuard sidecar module 7308 configured as a security proxy for incoming requests; and an MCP Server 7310 configured to provide tools and data services and remaining unmodified after instantiation and implementation of the Agent Pod 7300.

Communication between the Agent Pod 7300 and the Server Pod 7318 may be implemented in a multi-step process, including the following steps: the Agent App 7302 sending 7312 a request to the MCP Client 7304; the MCP Client 7304 transmitting 7314 an MCP Protocol message to the MCPGuard sidecar module 7306; the MCPGuard sSidecar module 7306 transmitting 7316 a Secure MCP message to the MCPGuard sidecar module 7308; the MCPGuard sidecar module 7308 forwarding 7318 a validated request to the MCP Server 7310; the MCP Server 7310 processing and returning 7320 a response to the MCPGuard Sidecar 7308; the MCPGuard Sidecar 7308 transmitting 7322 a validated response to the MCPGuard Sidecar 7306; the MCPGuard Sidecar 7306 returning 7324 an MCP protocol response to the MCP Client 7304; and the MCP Client 7304 delivering 7326 results to the Agent App 7302.

The architecture of FIG. 73 enables implementation without requiring any changes to the related AI applications while implementing transparent security through the sidecar components, enabling bidirectional protection with security validation occurring in both request and response directions.

The deployment options for MCPGuard systems as described in FIGS. 72 and 73 include but are not limited to cloud-native deployments utilizing public cloud providers, private cloud infrastructure, hybrid multi-cloud architectures, on-premises data center installations, edge computing deployments, or distributed fog computing implementations. Containerized deployments may utilize Docker containers, containerd runtimes, or other container technologies, orchestrated through Kubernetes, Docker Swarm, Apache Mesos, or proprietary orchestration platforms. Sidecar architectures may be implemented using Istio service mesh, Linkerd, Consul Connect, AWS App Mesh, or custom proxy implementations. Microservices architectures may employ RESTful APIs, GraphQL interfaces, gRPC communications, message queuing systems, event-driven architectures, or other inter-service communication patterns. The specific choice of deployment technology, container runtime, orchestration platform, or communication protocol should not be construed as limiting the scope of the present invention, as IPC systems are designed to be technology-agnostic and adaptable to various infrastructure environments.

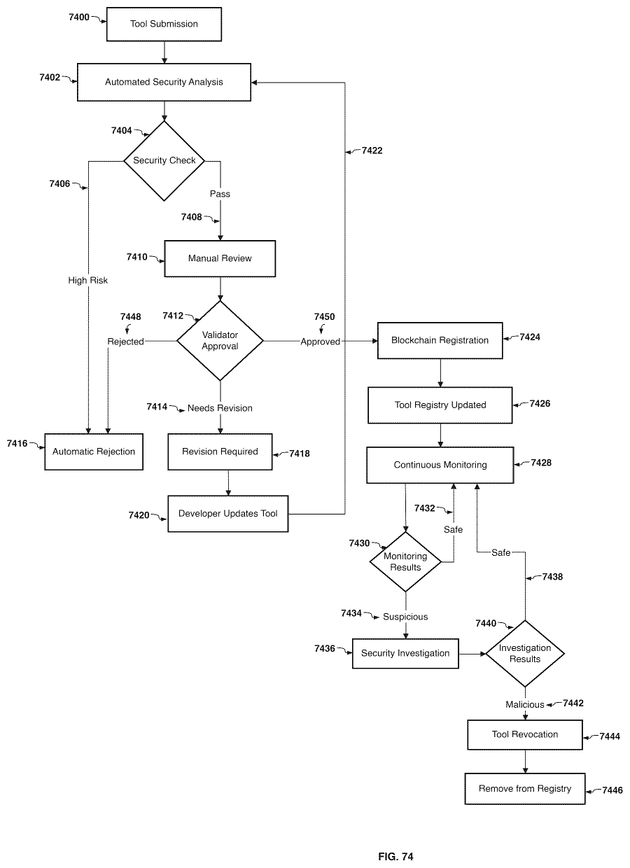

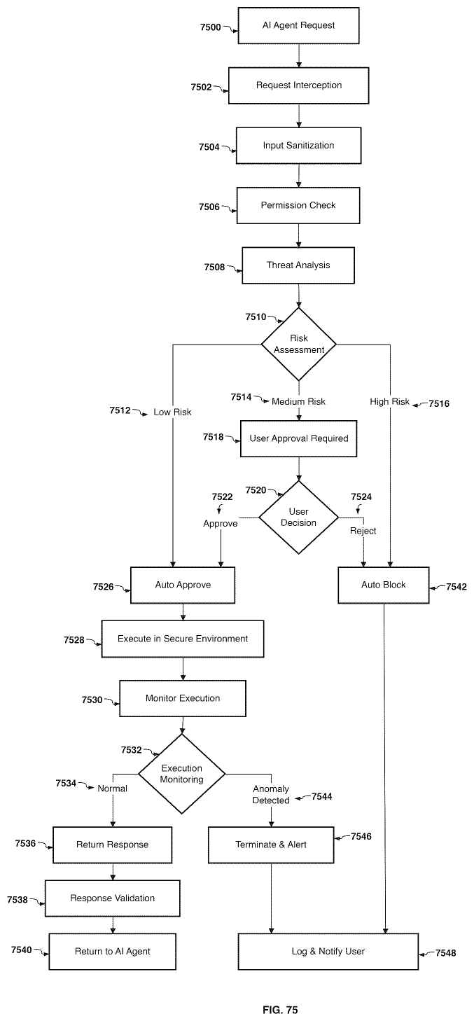

Referring now to FIG. 74, a flowchart illustrating a method of MCPGuard tool registration and verification flow according to an embodiment of the invention is described in more detail. The flowchart depicts a comprehensive multi-stage verification process for validating and registering tools within the MCPGuard ecosystem.

The process initiates with Tool Submission 7400, wherein a developer submits a tool for inclusion in the MCPGuard registry. The submitted tool undergoes Automated Security Analysis 7402, which comprises machine learning-based threat detection algorithms configured to identify malicious patterns, hidden instructions, and potential security vulnerabilities within the tool description and implementation.

Following the automated security analysis, a Security Check decision point 7404 evaluates the results of the automated security analysis. If the submitted tool fails the security analysis indicating high risk at step 7406, the process proceeds to Automatic Rejection 7416, wherein the submitted tool is immediately rejected without further processing, and the developer is notified of the rejection with specific security concerns identified.

If the submitted tool passes the initial security check at step 7408, the process advances to Manual Review 7410, wherein human security experts conduct detailed examination of the tool's functionality, description, and potential security implications. The manual review process includes verification of tool authenticity, assessment of permission requirements, and evaluation of potential impact on system security.

The Manual Review 7410 leads to a Validator Approval decision point 7412 with three possible outcomes. If the submitted tool is deemed secure and/or appropriate, the process proceeds to Approved 7450. If significant security concerns are identified that cannot be remediated, the process proceeds 7448 to the automatic rejection 7416 of the submitted tool. If the submitted tool shows the potential for being determined to be secure and/or appropriate but requires modifications to meet security standards, the process proceeds to Needs Revision 7414.

When Needs Revision 7414 is selected, the process continues to Revision Required 7418, wherein specific feedback is provided to the use that submitted the submitted tool, for example, a developer, regarding necessary changes. The user then updates the tool at step 7420, making the required modifications to address security concerns. Following updates, the process returns to Automated Security Analysis 7402 for re-evaluation.

Upon the submitted tool being receiving an Approved 7450 determination, the process advances to Blockchain Registration 7424, wherein the approved tool is permanently recorded in the immutable blockchain registry with cryptographic hashes and validator signatures. Subsequently, a tool registry update 7426 occurs, making the approved tool available for use within the MCPGuard ecosystem.

Following registration, continuous monitoring 7428 commences, providing ongoing surveillance of tool behavior and usage patterns. The monitoring system evaluates monitoring results 7430 to determine if any suspicious activity is detected.

If monitoring indicates normal behavior, the process continues with ongoing continuous monitoring 7428. However, if suspicious patterns are identified, the process proceeds to a security investigation 7436, wherein detailed analysis is conducted to determine the nature and severity of the detected anomaly.

The security investigation 7436 produces investigation results 7440 with two possible outcomes. If the investigation determines the tool remains safe 7438, monitoring continues normally. If the investigation reveals the tool has become malicious 7442, the process proceeds to tool revocation 7444, wherein the malicious tool is immediately disabled and removal from registry 7446 occurs, permanently eliminating the malicious tool from the ecosystem.

Referring now to FIG. 75, a flow chart illustrating a method of MCPGuard request processing and authorization low according to an embodiment of the invention is described in more detail. The flowchart depicts the real-time security validation process applied to every AI agent request within the MCPGuard system.

The process initiates when an AI agent request 7500 is generated by an AI agent attempting to utilize an MCP tool. The request is immediately captured by request interception 7502, which is performed by a transparent proxy mechanism configured to intercept all outgoing communications without requiring modifications to the AI agent or MCP client.

The intercepted request proceeds to input sanitization 7504, wherein comprehensive validation is performed including one or more of: detection and neutralization of invisible Unicode characters; identification of command injection attempts; validation of parameter formats and types; and removal of potentially malicious content while preserving legitimate functionality.

Following sanitization, a permission check 7506 is executed, comprising one or more of: verifying that the requesting entity possesses appropriate authorization to access the requested tool; validation of user permissions against the current access control policy; and assessment of temporal and contextual permission constraints.

The process then advances to threat analysis 7508, wherein one or more AI-powered detection algorithms analyze the request for: hidden malicious instructions; social engineering attempts; unusual usage patterns indicating potential compromise; and/or correlation with known attack signatures from the threat intelligence database.

Based on the results of sanitization, permission checking, and threat analysis, a risk assessment 7510 is performed, which comprises a comprehensive evaluation considering multiple factors, including, but not limited to: historical behavior patterns of the requesting entity; sensitivity of the requested operation; potential impact of successful execution; current threat intelligence indicators; and contextual factors such as time, location, and user behavior patterns.

The risk assessment 7510 produces three possible risk classifications. For low risk 7512 operations, the process proceeds to automatic approval 7526, wherein the request is automatically authorized and forwarded for execution without human intervention, enabling efficient processing of routine, safe operations.

For medium risk 7514 operations, the process proceeds to user approval required 7518, wherein a human operator must review and authorize the request through a tool approval system interface. The user is presented with comprehensive information including tool description, requested parameters, risk assessment results, and potential security implications.

The user approval required 7518 step yields a user decision 7520 point with two outcomes. If the user approves the request 7522, the request proceeds to execution. If the user rejects the request 7524, the process advances to logging and notifying the user 7548, wherein the rejection is recorded in an audit trail and the user is informed of the decision.

For high risk 7516 operations, the process proceeds directly to an automatic block 7542, wherein the request is automatically denied without human intervention, and continues to logging and notifying the user 7548 for audit trail maintenance and user notification.

Approved requests proceed to execution in a secure environment 7528, wherein the tool operation is performed within an isolated execution environment comprising hardware security enclaves, containerized micro-VMs, or other isolation mechanisms to prevent potential compromise of the host system.

During execution, a monitor execution step 7530 provides real-time surveillance of tool behavior, monitoring for: unusual file system access patterns; unexpected network communications; resource usage anomalies; and deviations from expected tool behavior based on the tool description.

The monitoring process evaluates execution monitoring results at step 7532 with two possible outcomes. If normal execution is detected at step 7534, the process proceeds to response validation 7538, wherein the executed tool's response is verified for integrity and absence of malicious content before return to the AI agent 7540.

If an anomaly is detected 7544 during execution, the process immediately proceeds to a terminate and alert step 7546, wherein: the tool execution is immediately halted; all processes associated with the execution are terminated; and the incident is logged in the immutable audit trail before proceeding to logging and notifying the user7548.

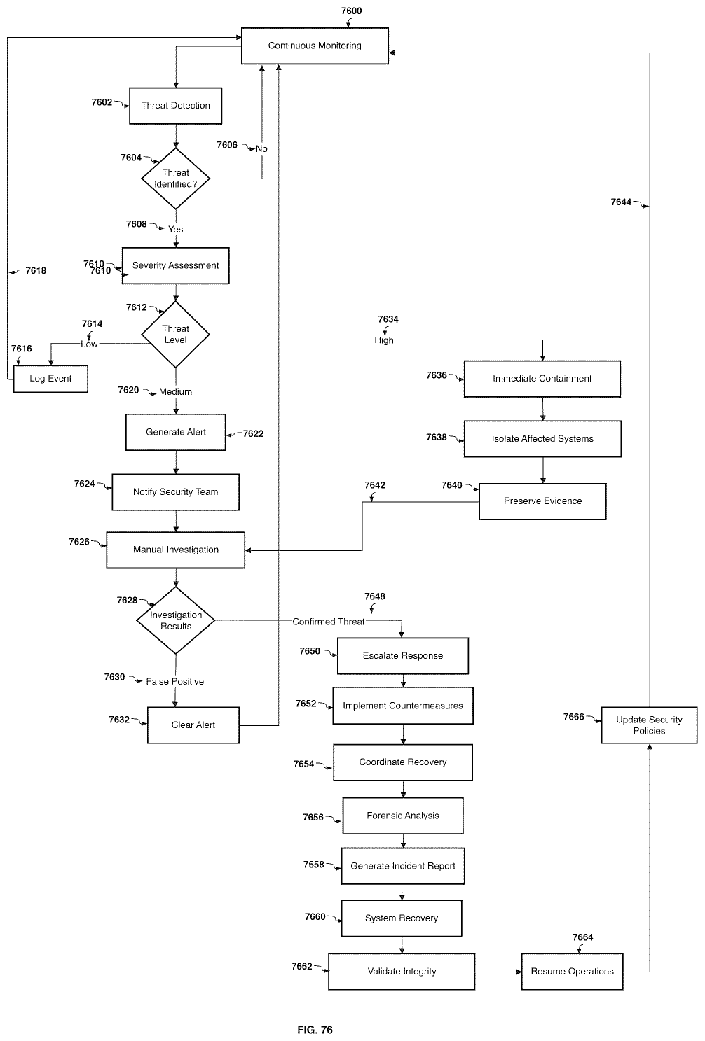

Referring now to FIG. 76, a flow chart illustrating a method of an MCPGuard incident detection and response flow according to an embodiment of the invention is described in more detail. The flowchart depicts the comprehensive threat detection and automated response system that provides continuous security monitoring and coordinated incident response capabilities.

The process operates through continuous monitoring 7600, which comprises ongoing surveillance of all system components including one or more of: network traffic analysis; behavioral pattern assessment; system resource utilization monitoring; audit log analysis; and integration with external threat intelligence feeds to maintain awareness of emerging threats.

The continuous monitoring system performs a threat detection 7602, employing multiple detection mechanisms including one or more of, but not limited to: signature-based detection for known attack patterns; anomaly detection using machine learning algorithms; behavioral analysis for identifying unusual entity behavior; correlation analysis for detecting complex multi-stage attacks; and real-time analysis of security events across all system components.

Following the threat detection analysis, a threat identified decision point 7604 determines whether suspicious activity has been detected. If no threats are identified at step 7606, the system continues with continuous monitoring 7600 to maintain ongoing surveillance.

When a threat is identified at step 7608, the system proceeds to a severity assessment 7610, which comprises comprehensive evaluation of the threat including one or more of, but not limited to: potential impact assessment based on affected systems and data; attack sophistication analysis; threat actor attribution when possible; affected user and system scope determination; and classification according to organizational risk tolerance and incident response procedures.

The severity assessment 7610 produces a threat level classification 7612 with three possible outcomes corresponding to escalating response procedures.

For ow severity threats7614, the system proceeds to a log event 7616, wherein the incident is recorded in the immutable blockchain-based audit trail with complete contextual information, timestamp, affected entities, and initial assessment results. Following logging, the system returns to continue monitoring 7618 to maintain surveillance while preserving evidence of the low-level threat for pattern analysis and trend identification.

For medium severity threats 7620, the system proceeds to generate an alert 7622, which comprises creation of detailed alert notifications including threat description, affected systems, recommended actions, and urgency indicators.

Following alert generation, the process continues to notifying a security team 7624, ensuring that qualified personnel are immediately informed of the threat and provided with comprehensive information necessary for response coordination. The process then proceeds to manual investigation 7626, wherein human security analysts conduct detailed examination of the threat including one or more of, but not limited to: forensic analysis of affected systems; evidence collection and preservation; threat actor methodology assessment; and determination of appropriate response measures.

The manual investigation 7626 produces investigation results 7628 with two possible outcomes. If the investigation indicate a false positive 7630, indicating the detected activity was benign, the process proceeds to clearing the alert 7632, wherein the alert status is updated, the investigation results are documented, and normal monitoring operations resume.

For confirmed threats 7648, an escalate response step 7650 leads to implementing countermeasures 7652, which comprises one or more of: deployment of additional security controls; implementation of threat-specific detection rules; and blocking of identified indicators of compromise. The process then advances to Coordinate Recovery 7654, wherein comprehensive recovery operations are orchestrated.

Following recovery coordination, a forensic analysis 7656 is performed, comprising: detailed examination of attack methodology; timeline reconstruction; impact assessment; root cause analysis; and identification of security control failures that enabled the attack.

The forensic analysis results in generating an incident report 7658, comprising producing comprehensive documentation including one or more of, but not limited to: an executive summary of the incident; a detailed technical analysis; an impact assessment; lessons learned; and recommendations for preventing similar incidents.

Subsequently, a system recovery process 7660 is executed, comprising: restoration of normal operations; re-enablement of affected services; validation of system integrity; and confirmation that all threat indicators have been eliminated.

The process continues with an integrity validation process 7662, wherein comprehensive verification is performed to ensure system configurations match approved baselines, no unauthorized modifications remain, all security controls are functioning properly, and monitoring systems are detecting normally.

Following integrity validation, a resume operations step 7664 occurs, wherein normal business operations are restored, users are notified of service restoration, monitoring returns to standard levels, and incident response teams are debriefed.

Finally, the process concludes with updating security policies 7666, comprising: revision of security procedures based on lessons learned; implementation of additional preventive controls; updating of incident response procedures; and integration of new threat indicators into detection systems.

For high severity threats 7634 representing immediate and significant risk, the system proceeds directly to immediate containment 7636, which comprises: automatic isolation of affected systems to prevent threat propagation; blocking of malicious network communications; suspension of compromised user accounts.

Following immediate containment, the process continues to isolating affected systems 7638, implementing comprehensive isolation measures including one or more of, but not limited to: network segmentation to prevent lateral movement; system quarantine procedures; suspension of affected services; and coordination with infrastructure teams to minimize operational impact while maintaining security.

Next, an evidence preservation process 7640 is executed, comprising: forensic imaging of affected systems; collection of network traffic logs; preservation of audit trails and system logs; and documentation of incident timeline.

Following evidence preservation, the process proceeds through the same manual investigation 7626 and investigation results 7628 evaluation as medium severity threats, with the same false positive 7630 and confirmed threat 7648 outcomes.

The security flows and processes described in FIGS. 74, 75, and 76 may be executed in different sequences, parallelized across multiple processing threads, distributed across multiple system components, or adapted based on specific threat landscapes or organizational requirements. The tool registration and verification flow depicted in FIG. 74 may incorporate additional validation steps, alternative approval mechanisms, different blockchain consensus algorithms, or enhanced monitoring capabilities depending on the specific implementation or regulatory environment. The request processing and authorization flow illustrated in FIG. 75 may implement different risk assessment algorithms, alternative user approval interfaces, varied execution isolation mechanisms, or customized monitoring and alerting procedures. The incident detection and response flow shown in FIG. 76 may utilize different threat detection methodologies, alternative severity classification schemes, varied containment strategies, or customized recovery procedures based on organizational incident response policies or regulatory compliance requirements.

The term “MCPGuard” as used throughout this specification should be interpreted broadly to encompass a wide range of security framework implementations, architectures, and deployment configurations that can provide comprehensive protection for Model Context Protocol communications. MCPGuard may refer to but is not limited to: distributed security systems, centralized security gateways, hybrid cloud-on-premises deployments, containerized microservices architectures, sidecar proxy implementations, transparent security overlays, hardware-secured execution environments, blockchain-based verification systems, AI-powered threat detection platforms, or any combination thereof. MCPGuard implementations may operate as standalone security appliances, integrated security layers within existing infrastructure, cloud-native security services, or embedded security components within AI agent platforms. The specific implementation, deployment model, or architectural configuration of MCPGuard should not be construed as limiting the scope of the present invention. MCPGuard systems may evolve, adapt, or be reconfigured over time to accommodate new threats, technologies, or deployment requirements, and may incorporate emerging security methodologies, cryptographic techniques, or threat detection capabilities as they become available.

Throughout the application, reference may be made to various computer hardware, including servers, GPUs, storage, cloud storage, and the like. It is contemplated and included within the scope of the invention that the systems described above and its various components may be software executed on computer devices, including servers, personal computers, smartphone devices, and the like, each comprising a processor configured to execute commands received from software (such as microprocessors, field-programmable gate arrays, integrated circuits, and the like), a non-transitory computer-readable storage medium positioned in electrical communication with the processor and operable to store software and other digital information thereupon in one or both of transitory and non-transitory status (such as hard disk drives, solid state drives, flash drives, compact flash drives, SD drives, memory, and the like), and a network communication device operable to communicate across computer networks as are known in the art, including, but not limited to, wide area networks such as the Internet and mobile data networks, local area networks such as Ethernet and Wi-Fi networks, and personal area networks such as Bluetooth networks. Accordingly, it is contemplated and included within the scope of the invention that the computer hardware performing the above-described functions includes hardware necessary for such performance as is known in the art.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus, the scope of the invention should be determined by the appended claims and their legal equivalents, and not by the examples given.

The claims in the instant application are different than those of the parent application or other related applications. Applicant therefore rescinds any disclaimer of claim scope made in the parent application or any predecessor application in relation to the instant application. Any such previous disclaimer and the cited references that it was made to avoid, may need to be revisited. Further, any disclaimer made in the instant application should not be read into or against the parent application.

What is claimed is:

1. A computer-implemented method for securing inter-process communications (IPCs) between a plurality of generative AI agents associated with Large Language Models (LLMs) and one or more external tool servers, comprising:
intercepting one or more intercepted IPCs from an AI agent of the plurality of generative AI agents to an external tool server, each intercepted IPC of the one or more intercepted IPCs comprising a requested operation;
performing a security analysis on the one or more intercepted IPCs for security threats;
performing a permission validation for one or more permissions for the requested operation of each intercepted IPC of the one or more intercepted IPCs; and
one of approving or blocking the requested operation of each intercepted IPC of the one or more intercepted IPCs based on the security analysis and the permission validation.

2. The method of claim 1 wherein performing the security analysis on the one or more intercepted IPCs for security threats comprises at least one:
identifying one or more tool poisoning attacks using machine learning algorithms trained on IPC-specific attack patterns;
detecting one or more instances of malicious content; and
performing a risk assessment based on one or more contextual factors associated with the intercepted IPC of the one or more intercepted IPCs including at least one of historical behavior and threat intelligence.

3. The method of claim 1 wherein intercepting the one or more intercepted IPCs comprises deploying a security gateway configured to intercept IPCs without requiring modifications to the AI agent of the plurality of generative AI agents transmitting the intercepted IPC or an external tool server of the one or more external tool servers intended to receive the intercepted IPC.

4. The method of claim 3 wherein the security gateway is configured to be deployed without requiring any modifications to existing applications associated with the one or more generating AI agents or applications associated with the one or more external tool servers.

5. The method of claim 1 wherein one of approving or blocking requests comprises:
evaluating each intercepted IPC of the one or more intercepted IPCs to determine if the requested operation comprised by the intercepted IPC is a low-risk operation, a medium-risk operation, or a high-risk operation;
automatically approving low-risk operations;
transmitting a request for user approval for medium-risk operations; and
automatically blocking high-risk operations.

6. The method of claim 1 wherein each approved intercepted IPC is comprised by one or more approved requests, the method further comprising:
executing the one or more approved requests within an isolated security environment; and
monitoring the execution of the one or more approved requests for anomalous behavior.

7. The method of claim 1 further comprising:
checking each intercepted IPC of the one or more intercepted IPCs for cryptographic message signing;
continuously verifying entity identities associated with each of the generative AI agent of the one or more generative AI agents and the external tool server of the one or more external tool servers associated with an intercepted IPC throughout a plurality of IPCs therebetween; and
maintaining a plurality of dynamic trust scores for each generative AI agent of the one or more generative AI agents and each external tool server of the one or more external tool servers associated with the intercepted IPC based on one or more behavior patterns identifiable from the plurality of IPCs.

8. The method of claim 7 further comprising:
storing a registry of the one or more external tool servers and the plurality of dynamic trust scores in an immutable blockchain registry;
using one or more smart contracts to manage access control decisions; and
maintaining one or more tamper-proof audit trails of all security events.

9. The method of claim 1 wherein intercepting IPCs comprises:
deploying at least one of a first security sidecar for a first security sidecar associated with a generative AI agent application;
deploying at least one of a second security sidecar associated with an external tool server application; and
implementing bidirectional security validation through secure communication between the first and second security sidecars.

10. The method of claim 9 wherein implementing bidirectional security validation comprises:
intercepting outgoing requests comprised by the intercepted IPCs at the first security sidecar;
generating validated outgoing requests by performing a first security validation on the outgoing requests;
transmitting validated outgoing requests from the first security sidecar to the second security sidecar;
generating supplementally validated outgoing requests by performing supplemental validation at the second security sidecar;
forwarding the supplementally validated outgoing requests to an external tool server of the one or more external tool servers;
intercepting tool responses comprised by the intercepted IPCs at the second security sidecar; and
generating validated tool responses by validating a response integrity of the tool responses; and
delivering the validated tool responses to a generative AI agent of the one or more generative AI agents.

11. The method of claim 9 wherein at least one the first and second security sidecars is a proxy for a security sidecar.

12. The method of claim 1 further comprising:
continuously monitoring all MCP communications for threat patterns;
detecting security incidents using at least one of signature-based detection and behavioral analysis; and
automatically implementing containment measures for high-severity threats.

13. The method of claim 1 wherein the security analysis, permission validation, and approving or blocking requested operations are performed in real-time.

14. The method of claim 1 wherein the IPC is a standardized framework for inter-process communication.

15. The method of claim 14 wherein the IPC complies with at least one of Model Context Protocol, Unified Intent Mediator Protocol, and OpenAI Work with Apps Protocol.

16. A system for securing inter-process communications (IPCs) between a plurality of generative AI agents associated with Large Language Models (LLMs) and one or more external tool servers, comprising:
means for intercepting one or more intercepted IPCs from an AI agent of the plurality of generative AI agents to an external tool server, each intercepted IPC of the one or more intercepted IPCs comprising a requested operation;
means for performing a security analysis on the one or more intercepted IPCs for security threats;
means for performing a permission validation for one or more permissions for the requested operation of each intercepted IPC of the one or more intercepted IPCs; and
means for one of approving or blocking the requested operation of each intercepted IPC of the one or more intercepted IPCs based on the security analysis and the permission validation.

17. The system of claim 16 wherein the means for performing the security analysis on the one or more intercepted IPCs for security threats is further operable to:
identify one or more tool poisoning attacks using machine learning algorithms trained on IPC-specific attack patterns;
detect one or more instances of malicious content; and
perform a risk assessment based on one or more contextual factors associated with the intercepted IPC of the one or more intercepted IPCs including at least one of historical behavior and threat intelligence.

18. The system of claim 16 wherein the means for intercepting the one or more intercepted IPCs is further operable to deploying a security gateway configured to intercept IPCs without requiring modifications to the AI agent of the plurality of generative AI agents transmitting the intercepted IPC or an external tool server of the one or more external tool servers intended to receive the intercepted IPC.

19. The system of claim 16 wherein the means for one of approving or blocking requests is further operable to:
evaluating each intercepted IPC of the one or more intercepted IPCs to determine if the requested operation comprised by the intercepted IPC is a low-risk operation, a medium-risk operation, or a high-risk operation;
automatically approving low-risk operations;
transmitting a request for user approval for medium-risk operations; and
automatically blocking high-risk operations.

20. The system of claim 16 wherein each approved intercepted IPC is comprised by one or more approved requests, the system further comprising:
means for executing the one or more approved requests within an isolated security environment; and
means for monitoring the execution of the one or more approved requests for anomalous behavior.

21. The system of claim 16 further comprising:
means for checking each intercepted IPC of the one or more intercepted IPCs for cryptographic message signing;
means for continuously verifying entity identities associated with each of the generative AI agent of the one or more generative AI agents and the external tool server of the one or more external tool servers associated with an intercepted IPC throughout a plurality of IPCs therebetween; and
means for maintaining a plurality of dynamic trust scores for each generative AI agent of the one or more generative AI agents and each external tool server of the one or more external tool servers associated with the intercepted IPC based on one or more behavior patterns identifiable from the plurality of IPCs.

22. The system of claim 21 further comprising:
means for storing a registry of the one or more external tool servers and the plurality of dynamic trust scores in an immutable blockchain registry;
means for using one or more smart contracts to manage access control decisions; and
means for maintaining one or more tamper-proof audit trails of all security events.

23. The system of claim 16 wherein the means for intercepting IPCs is further operable to:
deploy at least one of a first security sidecar for a first security sidecar associated with a generative AI agent application;
deploy at least one of a second security sidecar associated with an external tool server application; and
implement bidirectional security validation through secure communication between the first and second security sidecars.

24. The system of claim 23 wherein the means for implementing bidirectional security validation is further operable to:
intercept outgoing requests comprised by the intercepted IPCs at the first security sidecar;
generate validated outgoing requests by performing a first security validation on the outgoing requests;
transmit validated outgoing requests from the first security sidecar to the second security sidecar;
generate supplementally validated outgoing requests by performing supplemental validation at the second security sidecar;
forward the supplementally validated outgoing requests to an external tool server of the one or more external tool servers;
intercept tool responses comprised by the intercepted IPCs at the second security sidecar; and
generate validated tool responses by validating a response integrity of the tool responses; and
deliver the validated tool responses to a generative AI agent of the one or more generative AI agents.
